(19) United States
(12) Patent Application Publication
(10) Pub. No.: US 2025/0306178 A1
(43) Pub. Date: Oct. 2, 2025

(54) LIDAR DEVICE USED TO GENERATE HIGH-RESOLUTION LIDAR DATA

(71) Applicant: SOS LAB Co., Ltd., Gwangju (KR)

(72) Inventors: Junho CHOI, Gwangju (KR); Jihoon PARK, Gwangju (KR); Sangwoo PARK, Seoul (KR); Yong Yi LEE, Gwangju (KR)

(73) Assignee: SOS LAB Co., Ltd., Gwangju (KR)

(21) Appl. No.: 19/236,852

(22) Filed: Jun. 12, 2025

Related U.S. Application Data
(63) Continuation of application No. PCT/KR2023/017291, filed on Nov. 1, 2023.

(30) Foreign Application Priority Data
Dec. 15, 2022 (KR) 10-2022-0176347
Mar. 23, 2023 (KR) 10-2023-0037819

(51) Int. Cl. G01S 7/481; G01B 11/22; G01J 1/42; G01J 1/44; G01S 17/89

(52) U.S. Cl. CPC G01S 7/4815; G01B 11/22; G01J 1/4204; G01J 1/44; G01S 7/4816; G01S 17/89; G01J 2001/4466

(57) ABSTRACT

A light detection and ranging (LiDAR) device according to the present invention comprises: a transmission module including a laser output array and a transmission optic, wherein the laser output array includes a first laser output unit and a second laser output unit, and the second laser output unit is located right next to the first laser output unit; and a reception module including a laser detecting array and a reception optic, wherein the laser detecting array includes a first laser detecting unit and a second laser detecting unit. The transmission module and the reception module are aligned so that the first laser output unit and the first laser detecting unit are optically coupled. The distance between the first laser detecting unit and the second laser detecting unit is determined such that the second laser detecting unit is optically connected to the second laser output unit. The laser detecting array may further include a first ambient detecting unit disposed between the first laser detecting unit and the second laser detecting unit.

### CROSS-REFERENCE TO RELATED APPLICATIONS

This application is a continuation of International Application No. PCT/KR2023/017291 filed on Nov. 1, 2023, which claims priority to Korean Patent Application No. 10-2022-0176347 filed on Dec. 15, 2022 and Korean Patent Application No. 10-2023-0037819 filed on Mar. 23, 2023, the entire contents of which are herein incorporated by reference.

### TECHNICAL FIELD

The present disclosure relates to a method of generating LiDAR data and a LiDAR device using the same and, more particularly, to a method of generating enhanced LiDAR data having high resolution and a LiDAR device using the same.

### BACKGROUND ART

Recently, Light Detection and Ranging (LiDAR) has been attracting attention with growing interest in autonomous and unmanned vehicles. LiDAR is a device that obtains distance information about the surroundings using a laser, and is being applied not only to vehicles but also to various fields such as drones and aircraft due to its advantages of high precision, high resolution, and the capability to perceive objects in three dimensions.

Meanwhile, a solid-state LiDAR Device is a device that can obtain distance information of the three-dimensional surrounding space without any mechanically moving components, and a laser emitting array can be used to implement the solid-state LiDAR Device.

However, the resolution of a solid-state LiDAR device may be determined by the arrangement of a laser detecting array for detecting lasers, and thus may have relatively lower resolution compared to cameras.

Accordingly, a method of obtaining LiDAR data with high resolution may be needed.

### SUMMARY

### Technical Problem

An objective of the present disclosure is to provide a method of generating enhanced LiDAR data having relatively high resolution.

Objectives of the present disclosure are not limited to those described above and objectives not stated above will be clearly understood to those skilled in the art from the specification and the accompanying drawings.

### Technical Solution

According to an embodiment of the present disclosure, there may be provided a method of generating enhanced LiDAR data using a LiDAR device including a laser detecting array, in which the laser detecting array includes a plurality of laser detecting units, and each of the plurality of laser detecting units includes a plurality of sub-detecting units. The method includes: obtaining first LiDAR data including point data corresponding to the plurality of laser detecting units, respectively, on the basis of detection signals obtained from the plurality of sub-detecting units included in the plurality of laser detecting units; obtaining second LiDAR data including sub-point data corresponding to the plurality of sub-detecting units, respectively, on the basis of detection signals obtained from the plurality of sub-detecting units included in the plurality of laser detecting units; and generating enhanced LiDAR data by using the first LiDAR data and the second LiDAR data.

According to an another embodiment of the present disclosure, there may be provided A LiDAR (Light Detection And Ranging) device, comprising: a transmission module comprising a laser emitting array and a transmission optic, wherein the laser emitting array comprises a first laser emitting unit and a second laser emitting unit, wherein the second emitting unit is positioned adjacent to the first laser emitting unit; and a reception module comprising a laser detecting array and a reception optic, wherein the laser detecting array comprises a first laser detecting unit and a second laser detecting unit; wherein the transmission module and the reception module are configured to be aligned such that the first laser emitting unit is optically coupled to the first laser detecting unit, wherein a distance between the first laser detecting unit and the second laser detecting unit is determined such that the second laser detecting unit is optically coupled to the second laser emitting unit, wherein the laser detecting array further comprises a first ambient detecting unit disposed between the first laser detecting unit and the second laser detecting unit.

According to another embodiment of the present disclosure, there is provided a method of generating a high-resolution depth image using a LiDAR device including a laser detecting array, in which the laser detecting array includes a plurality of laser detecting units, and each of the plurality of laser detecting units includes a plurality of sub-detecting units. The method includes: obtaining a low-resolution depth image, in which the low-resolution depth image includes a first number of pixels, and each of the pixels of the low-resolution depth image includes a position coordinate value and a depth value; obtaining a high-resolution image, in which the high-resolution image includes a second number of pixels greater than the first number, and each of the pixels of the high-resolution image includes a position coordinate value and a pixel value; obtaining a high-resolution depth image on the basis of the low-resolution depth image and the high-resolution image, in which the high-resolution depth image includes a third number of pixels greater than the first number, and each of the pixels included in the high-resolution depth image includes a position coordinate value and a pixel value. In this configuration, the depth value of each of the pixels of the low-resolution depth image is obtained on the basis of a detection signal generated from at least one sub-detecting unit included in each of the plurality of laser detecting units, and the pixel value of each of the pixels of the high-resolution image is obtained on the basis of a signal generated from each of a plurality of sub-detecting units.

Objectives of the present disclosure are not limited to those described above and objectives not stated above will be clearly understood to those skilled in the art from the specification and the accompanying drawings.

### Advantageous Effects

According to an embodiment of the present disclosure, a method of generating enhanced LiDAR data having relatively high resolution can be provided.

Effects of the present disclosure are not limited to those described above and effects not stated above will be clearly understood to those skilled in the art from the specification and the accompanying drawings.

### DESCRIPTION OF DRAWINGS

FIG. 1 is a diagram illustrating a LiDAR device according to an embodiment.

FIGS. 2A to 2D are a diagram showing various embodiments of a LiDAR device.

FIG. 3 is a diagram illustrating the operation of a LiDAR device according to an embodiment and LiDAR data.

FIG. 4 is a diagram illustrating LiDAR data according to an embodiment.

FIG. 5 is a diagram illustrating LiDAR data according to an embodiment.

FIG. 6 is a diagram illustrating pieces of information included in property data according to an embodiment.

FIG. 7 is a diagram illustrating a LiDAR device according to an embodiment.

FIG. 8 is a diagram for illustrating a laser emitting array and a laser detecting array included in a LiDAR device according to an embodiment.

FIG. 9 and FIG. 10 are diagrams illustrating a LiDAR device according to an embodiment.

FIG. 11 and FIG. 12 are diagrams illustrating a laser emitting module and a laser detecting module according to an embodiment.

FIG. 13 and FIG. 14 are diagrams illustrating an emitting lens module and a detecting lens module according to an embodiment.

FIG. 15 is a diagram illustrating a laser emitting unit according to an embodiment.

FIG. 16 is a diagram illustrating a laser emitting array according to an embodiment.

FIG. 17 and FIG. 18 are diagrams illustrating a laser emitting array according to an embodiment.

FIG. 19 is a diagram illustrating LiDAR data according to an embodiment.

FIG. 20 is a diagram illustrating a method of obtaining detection values and LiDAR data according to an embodiment.

FIG. 21 is a diagram illustrating a method of obtaining detection values and LiDAR data according to an embodiment.

FIG. 22 is a diagram illustrating the operation interval of a LiDAR device according to an embodiment.

FIGS. 23A and 23B are an exemplary diagram of LiDAR data according to an embodiment.

FIG. 24 is a diagram illustrating the operation of a LiDAR device for generating an enhanced light capture map according to an embodiment.

FIG. 25 is a diagram illustrating the operation of a laser emitting array according to an embodiment.

FIGS. 26A and 26B are an exemplary diagram of LiDAR data according to an embodiment.

FIG. 27 is a diagram illustrating a laser emitting array and a laser detecting array included in a LiDAR device according to an embodiment.

FIG. 28 is a diagram illustrating a laser emitting array and a laser detecting array included in a LiDAR device according to an embodiment.

FIG. 29 is a diagram illustrating a laser detecting unit and detection values according to an embodiment.

FIG. 30 is a diagram illustrating a laser detecting unit and detection values according to an embodiment.

FIG. 31 is a diagram illustrating a method of generating enhanced LiDAR data according to an embodiment.

FIG. 32 to FIG. 35 are diagrams illustrating a method of generating enhanced LiDAR data according to an embodiment.

FIG. 36A is a diagram illustrating point cloud data according to an embodiment and FIG. 36B is a diagram illustrating enhanced point cloud data according to an embodiment.

FIG. 37 is a diagram illustrating a method of generating LiDAR data according to an embodiment.

FIG. 38 is a diagram illustrating a method of generating LiDAR data according to an embodiment.

### DETAILED DESCRIPTION

Embodiments described herein are provided to clearly explain the spirit of the present disclosure to those skilled in the art, so the present disclosure is not limited to the embodiments described herein and the scope of the present disclosure should be construed as including changed or modified examples not departing from the spirit of the present disclosure.

Terminologies used herein were selected from general terminologies that are used at present as generally as possible in consideration of their functions herein, but may be changed, depending on the intention of those skilled in the art, precedents, advent of new technologies, or the like. However, when such specific terminologies are defined and used as certain meanings, the meanings of the terminologies will be specifically described. Accordingly, the terminologies used herein should be construed on the basis of the substantial meanings of the terminologies and the entire specification, not simply the names of the terminologies.

The accompanying drawings of the present disclosure are provided for easy description of the present disclosure and the shapes shown in the drawings may be exaggerated to help understand the present disclosure, if necessary, so the present disclosure is not limited to the drawings of the present disclosure.

Elements or layers described in the specification that are referred to as being “on” or “above” another element or layer may include cases where there is an intermediate layer or element between them, not just immediately above the other element or layer.

Throughout the specification, the same reference numerals may generally refer to the same elements.

Numbers (e.g., first, second, etc.) used in the description of the present disclosure may be understood as identification symbols to discriminate one component from another component.

The suffixes “module” and “unit” used for components in the description of this specification are used or interchangeably mixed for ease of drafting the specification, and may not have distinct meanings or roles themselves.

When it is determined that detailed description of well-known configurations or functions related to the present disclosure may make the spirit of the present disclosure unclear, they are not described in detail, if necessary.

According to an embodiment of the present disclosure, there may be provided a method of generating enhanced LiDAR data using a LiDAR device including a laser detecting array, in which the laser detecting array includes a plurality of laser detecting units, and each of the plurality of laser detecting units includes a plurality of sub-detecting units. The method includes: obtaining first LiDAR data including point data corresponding to the plurality of laser detecting units, respectively, on the basis of detection signals obtained from the plurality of sub-detecting units included in the plurality of laser detecting units; obtaining second LiDAR data including sub-point data corresponding to the plurality of sub-detecting units, respectively, on the basis of detection signals obtained from the plurality of sub-detecting units included in the plurality of laser detecting units; and generating enhanced LiDAR data by using the first LiDAR data and the second LiDAR data.

Herein, each of the point data corresponding to the plurality of laser detecting units, respectively, may include a pixel coordinate and a distance value corresponding to each of the plurality of laser detecting units.

Herein, each of the sub-point data corresponding to the plurality of sub-detecting units, respectively, may include a sub-pixel coordinate and a light capture value corresponding to each of the plurality of sub detecting units.

Herein, the first LiDAR data may include at least one of a depth map, an intensity map, and a point cloud, and the second LiDAR data may include light capture map data.

Herein, the distance value included in each of the plurality of point data is obtained on the basis of detection signals obtained from the plurality of sub-detecting units included in the corresponding laser detecting unit, and the light capture value included in each of the plurality of sub-point data may be obtained on the basis of a detection signal obtained from the corresponding sub-detecting unit.

Herein, a first distance value included in the first LiDAR data may be obtained on the basis of detection signals obtained from the plurality of sub-detecting units included in a first laser detecting unit; a first light capture value included in the second LiDAR data may be obtained on the basis of a detection signal obtained from a first sub-detecting unit included in the first laser detecting unit; a second light capture value included in the second LiDAR data may be obtained on the basis of a detection signal obtained from a second sub-detecting unit included in the first laser detecting unit; and a third light capture value included in the second LiDAR data may be obtained on the basis of a detection signal obtained from a third sub-detecting unit included in a second laser detecting unit.

Herein, the number of point data included in the first LiDAR data may be smaller than the number of sub-point data included in the second LiDAR data.

Herein, the number of pixel coordinates included in the first LiDAR data may be smaller than the number of sub-pixel coordinates included in the second LiDAR data.

Herein, the resolution of the second LiDAR data may be higher than the resolution of the first LiDAR data.

Herein, the enhanced LiDAR data may include a plurality of enhanced point data.

Herein, at least some of the plurality of enhanced point data may be generated on the basis of the point data included in the first LiDAR data and the sub-point data included in the second LiDAR data.

Herein, first enhanced point data included in the plurality of enhanced point data may be generated on the basis of at least first point data included in the first LiDAR data, first sub-point data included in the second LiDAR data, and second sub-point data included in the second LiDAR data.

Herein, the first point data may be point data corresponding to the first laser detecting unit, the first sub-point data may be sub-point data corresponding to the first sub-detecting unit included in the first laser detecting unit, and the second sub-point data may be sub-point data corresponding to the second sub-detecting unit included in the second laser detecting unit.

Herein, the first laser detecting unit and the second laser detecting unit may be disposed adjacent to each other.

Herein, at least one sub-detecting unit may be disposed between the first sub-detecting unit and the second sub-detecting unit.

Herein, the number of enhanced point data included in the enhanced LiDAR data may be equal to the number of sub-point data included in the second LiDAR data.

Herein, the number of the enhanced point data included in the enhanced LiDAR data may be an integer multiple of the number of point data included in the first LiDAR data.

Herein, the enhanced LiDAR data may include at least one piece of data of a depth map, an intensity map, and a point cloud.

According to an another embodiment of the present disclosure, there may be provided A LiDAR (Light Detection And Ranging) device, comprising: a transmission module comprising a laser emitting array and a transmission optic, wherein the laser emitting array comprises a first laser emitting unit and a second laser emitting unit, wherein the second emitting unit is positioned adjacent to the first laser emitting unit; and a reception module comprising a laser detecting array and a reception optic, wherein the laser detecting array comprises a first laser detecting unit and a second laser detecting unit; wherein the transmission module and the reception module are configured to be aligned such that the first laser emitting unit is optically coupled to the first laser detecting unit, wherein a distance between the first laser detecting unit and the second laser detecting unit is determined such that the second laser detecting unit is optically coupled to the second laser emitting unit, wherein the laser detecting array further comprises a first ambient detecting unit disposed between the first laser detecting unit and the second laser detecting unit.

Herein, a distance between a center of the first laser emitting unit and a center of the second laser emitting unit is equal to a distance between a center of the first laser detecting unit and a center of the second laser detecting unit.

Herein, an optical characteristic of the transmission optic and an optical characteristic of the reception optic are identical to each other.

Herein, a distance between a center of the first laser detecting unit and a center of the first ambient detecting unit is less than a distance between a center of the first laser emitting unit and a center of the second laser emitting unit.

Herein, the LiDAR device further comprises a processor configured to determine a depth value for at least one pixel coordinate, wherein the processor is configured to: determine a first depth value for a first pixel coordinate at least based on a detection signal generated from the first laser detecting unit, when a first laser emitted from the first laser emitting unit is reflected by an object and detected by the first laser detecting unit, and determine a second depth value for a second pixel coordinate at least based on a detection signal generated from the second laser detecting unit, when a second laser emitted from the second laser emitting unit is reflected by an object and detected by the second laser detecting unit.

Herein, the processor is configured to determine the first depth value for the first pixel coordinate at least based on detection signals generated from the first laser detecting unit and the first ambient detecting unit, when the first laser emitted from the first laser emitting unit is reflected by an object and detected by the first laser detecting unit.

Herein, the LiDAR device further comprises a processor configured to determine a light capture value of at least one pixel coordinate, wherein the processor is configured to determine a first light capture value for a first pixel coordinate based on a detection signal generated from the first ambient detecting unit during a first unit time.

Herein, the processor is configured to: determine a second light capture value for a second pixel coordinate based on a detection signal generated from the first laser detecting unit during the first unit time, and determine a third light capture value for a third pixel coordinate based on a detection signal generated from the second laser detecting unit during the first unit time.

Herein, the first and second laser detecting units and the first ambient detecting unit are implemented using the same detecting element.

Herein, the first and second laser detecting units and the first ambient detecting unit are implemented as SPADs (Single Photon Avalanche Diodes).

Herein, a number of detecting elements included in the laser detecting array is greater than a number of laser emitting elements included in the laser emitting array.

Herein, the LiDAR device further comprises a processor configured to generate at least one LiDAR data, wherein the processor is configured to generate a depth map data comprising a depth value for each of a plurality of pixels, and a light capture map data comprising a light capture value for each of a plurality of pixels.

Herein, a number of pixels included in the light capture map data is greater than a number of pixels included in the depth map data.

According to another embodiment of the present disclosure, there may be provided a method of generating a high-resolution depth image using a LiDAR device including a laser detecting array, in which the laser detecting array includes a plurality of laser detecting units, and each of the plurality of laser detecting units includes a plurality of sub-detecting units. The method includes: obtaining a low-resolution depth image, in which the low-resolution depth image includes a first number of pixels, and each of the pixels of the low-resolution depth image includes a position coordinate value and a depth value; obtaining a high-resolution image, in which the high-resolution image includes a second number of pixels greater than the first number, and each of the pixels of the high-resolution image includes a position coordinate value and a pixel value; obtaining a high-resolution depth image on the basis of the low-resolution depth image and the high-resolution image, in which the high-resolution depth image includes a third number of pixels greater than the first number, and each of the pixels included in the high-resolution depth image includes a position coordinate value and a pixel value. In this configuration, the depth value of each of the pixels of the low-resolution depth image is obtained on the basis of a detection signal generated from at least one sub-detecting unit included in each of the plurality of laser detecting units, and the pixel value of each of the pixels of the high-resolution image is obtained on the basis of a signal generated from each of a plurality of sub-detecting units.

Herein, the depth value of each of the pixels of the low-resolution depth image may be obtained on the basis of detection signals generated from a plurality of sub-detecting units included in each of the plurality of laser detecting units.

Herein, a first depth value for a first pixel included in the low-resolution depth image may be obtained on the basis of detection signals generated from at least first to third sub-detecting units included in a first laser detecting unit.

Herein, the first depth value may be obtained on the basis of first histogram data generated by accumulating, over a plurality of cycles, the number of signals generated per first unit time on the basis of detection signals generated from at least the first to third sub-detecting units.

Herein, a first pixel value for the first pixel included in the high-resolution image may be obtained on the basis of a detection signal generated from a first sub-detecting unit included in the first laser detecting unit; a second pixel value for a second pixel may be obtained on the basis of a detection signal generated from a second sub-detecting unit included in the first laser detecting unit; and a third pixel value for a third pixel may be obtained on the basis of a detection signal generated from a third sub-detecting unit included in the first laser detecting unit.

Herein, the first pixel value may be obtained on the basis of a first counting value obtained by accumulating the number of signals generated during a second unit time on the basis of a detection signal generated from the first sub-detecting unit; the second pixel value may be obtained on the basis of a second counting value obtained by accumulating the number of signals generated during a second unit time on the basis of a detection signal generated from the second sub-detecting unit; and the third pixel value may be obtained on the basis of a second counting value obtained by accumulating the number of signals generated during a second unit time on the basis of a detection signal generated from the third sub-detecting unit.

Herein, the third number may be equal to the second number.

Herein n, the third number may be a multiple of the first number.

Herein, the depth value of each of the pixels of the high-resolution depth image may be obtained on the basis of the depth value of the low-resolution depth image and the pixel value of the high-resolution image.

Herein, a first depth value for the first pixel included in the high-resolution depth image may be obtained on the basis of a second depth value for a second pixel included in the low-resolution depth image, the third pixel value for the third pixel included in the high-resolution image, and a fourth pixel value for a fourth pixel included in the high-resolution image.

Herein, the second pixel included in the low-resolution depth image may be a pixel corresponding to the first laser detecting unit, the third pixel included in the high-resolution image may be a pixel corresponding to the first sub-detecting unit included in the first laser detecting unit, and the fourth pixel included in the high-resolution image may be a pixel corresponding to a second sub-detecting unit that is included in a second laser detecting unit adjacent to the first laser detecting unit and is adjacent to the first sub-detecting unit.

Hereafter, a LiDAR device according to the present disclosure is described.

However, the LiDAR device described in the specification may be understood as a concept including various devices that measure distance using a laser, and may be understood as a concept that includes, for example, Light Detection And Ranging (LiDAR), a Time-of-Flight sensor (TOF) sensor, etc., but is not limited thereto.

A LIDAR device is a device for detecting the distance between an object and the LiDAR device (hereinafter, the distance to an object refers to the distance between the object and the LiDAR device) and a relative location of the object with respect to the LiDAR device using a laser. For example, a LiDAR device can emit a laser, and when an emitted laser is reflected from an object, the LiDAR device can measure the distance between the object and the LiDAR device and the location of the object by receiving or sensing the reflected laser. In this case, the distance and location of the object can be expressed through a coordinate system. For example, the distance and location of an object can be expressed in a spherical coordinate system (r, θ, ϕ). However, they are not limited thereto, and can be expressed in coordinate systems such as Cartesian coordinates (X, Y, Z), cylindrical coordinates (r, θ, z), or the like.

Further, in this case, an object may refer to at least one object or at least a portion of the object.

Further, the LiDAR device according to an embodiment can use a laser emitted from the LiDAR device and reflected from the object to measure the distance to the object.

For example, the LiDAR device according to an embodiment can use the Time Of Flight (TOF) of a laser until the laser is sensed after emission to measure the distance to the object.

For a more specific example, the LiDAR device according to an embodiment can measure the distance to an object using the difference between a time value based on the emission time of the emitted laser and the time value based on the sensing time of the laser reflected from the object and then sensed.

In this case, the time value based on the emission time of the laser can be acquired on the basis of a controller included in the LiDAR device according to an embodiment.

For example, the time value based on the emission time of the laser can be acquired on the basis of the generation timing of a trigger signal generated by the controller included in the LiDAR device according to an embodiment, but is not limited thereto.

Further, the time value based on the emission time of the laser can be acquired on the basis of a laser emitting unit included in the LiDAR device according to an embodiment.

For example, the time value based on the emission time of the laser can be acquired by sensing operation of the laser emitting unit included in the LiDAR device according to an embodiment, but is not limited thereto.

In this case, sensing of the operation of the laser emitting unit may refer to sensing of the flow of current in the laser emitting unit, variation in the electric field, etc., but is not limited thereto.

Further, the time value based on the emission time of the laser can be acquired on the basis of a detector unit included in the LiDAR device according to an embodiment.

For example, the time value based on the emission time of the laser can be acquired on the basis of a time value at which the detector unit included in the LiDAR device according to an embodiment senses a laser not reflected from the object, but is not limited thereto.

In this case, a reference optical path for the laser emitted from the laser output unit to be received by the detector unit may be provided, the present disclosure is not limited thereto. For example, among a plurality of laser beams generated by the laser emitting unit and emitted toward the field of view (FOV) at the same time point, some of them are transmitted to the detector unit instead of being emitted outside the LiDAR device, so the exact time point at which the lasers is emitted can be sensed by the detector unit.

Further, the time value based on the sensing time of the laser reflected from the object and then sensed can be acquired on the basis of the detector unit included in the LiDAR device according to an embodiment.

For example, the time value based on the sensing time of the laser reflected from the object and then sensed can be acquired on the basis of a time value at which the detector included in the LiDAR device according to an embodiment senses a laser reflected from the object, but is not limited thereto.

Further, the LiDAR device according to an embodiment may use methods such as the triangulation method, interferometry method, phase shift measurement, etc., in addition to the time of flight to measure the distance to an object, but is not limited thereto.

The LiDAR device according to an embodiment may be installed on a vehicle. For example, a LiDAR device may be installed on the roof, hood, headlamp, bumper, etc. of a vehicle.

Further, according to one embodiment, a plurality of LiDAR devices may be installed in a vehicle. For example, when two LiDAR devices are installed on the roof of the vehicle, one LiDAR device may be configured to observe a front side and the other may be configured to observe a rear side. However, the present invention is not limited thereto. In addition, for example, when two LiDAR devices are installed on the roof of the vehicle, one LiDAR device may be configured to observe a left side and the other may be configured to observe a right side. However, the present invention is not limited thereto.

Further, a LiDAR device according to one embodiment may be installed in a vehicle. For example, when the LiDAR device is installed inside the vehicle, it may be configured to recognize gestures of a driver during driving, but is not limited thereto. Also, for example, when the LiDAR device is installed inside or outside the vehicle, it may be configured to recognize a face of the driver, but is not limited thereto.

The LiDAR device according to an embodiment may be installed on an unmanned aerial vehicle. For example, the LiDAR device may be installed on a UAV System, a drone, a Remote Piloted Vehicle (RPV), an Unmanned Aerial Vehicle System (UAVS), an Unmanned Aircraft System (UAV), a Remote Piloted Air/Aerial Vehicle (RPAV), a Remote Piloted Aircraft System (RPAS), or the like.

Further, a plurality of LiDAR devices according to an embodiment may be installed on an unmanned aerial vehicle. For example, when two LiDAR devices are installed on an unmanned aerial vehicle, one LiDAR device may be for observing the front, and the other may be for observing the rear, but they are not limited thereto. Further, when two LiDAR devices are installed on an unmanned aerial vehicle, one LiDAR device may be for observing the left, and the other may be for observing the right, but they are not limited thereto.

The LiDAR device according to an embodiment may be installed on a robot. For example, LiDAR devices may be installed on personal robots, professional robots, public service robots, other industrial robots, manufacturing robots, or the like.

Further, according to one embodiment, a plurality of LiDAR devices may be installed in a robot. For example, when two LiDAR devices are installed in the robot, one LiDAR device may be configured to observe a front side and the other may be configured to observe a rear side. However, the present invention is not limited thereto. In addition, for example, when two LiDAR devices are installed in the robot, one LiDAR device may be configured to observe a left side and the other may be configured to observe a right side. However, the present invention is not limited thereto.

Further, a LiDAR device according to one embodiment may be installed in a robot. For example, when the LiDAR device is installed in the robot, it may be configured to recognize a human face, but is not limited thereto.

Further, a LiDAR device according to one embodiment may be installed for industrial security. For example, the LiDAR device may be installed in a smart factory for industrial security.

Further, according to one embodiment, a plurality of LiDAR devices may be installed in a smart factory for industrial security. For example, when two LiDAR devices are installed in the smart factory, one LiDAR device may be configured to observe a front side and the other may be configured to observe a rear side. However, the present invention is not limited thereto. In addition, for example, when two LiDAR devices are installed in the smart factory, one LiDAR device may be configured to observe a left side and the other may be configured to observe a right side. However, the present invention is not limited thereto.

Further, a LiDAR device according to one embodiment may be installed for industrial security. For example, when the LiDAR device is installed for industrial security, it may be configured to recognize a human face, but is not limited thereto.

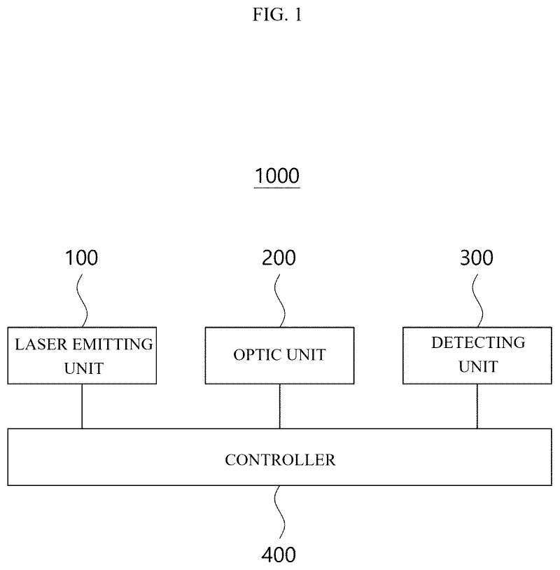

FIG. 1 is a diagram illustrating a LiDAR device according to an embodiment.

Referring to FIG. 1, a LiDAR device 1000 according to an embodiment may include a laser emitting unit 100.

In this configuration, the laser emitting unit 100 according to an embodiment can generate or emit a laser.

Further, the laser emitting unit 100 according to an embodiment may include one or more laser emission element.

For example, the laser emitting unit 100 according to an embodiment may include one laser emission element and may include a plurality of laser emission elements.

Further, the laser emitting unit 100 according to an embodiment may be configured as an array in which a plurality of laser emission elements is arranged in the form of an array, but is not limited thereto.

For example, the laser emitting unit 100 according to an embodiment may be implemented as a Vertical Cavity Surface Emitting Laser (VCSEL) array in which a plurality of VSCELs is arranged in the form of an array.

Further, the laser emitting unit 100 according to an embodiment may include laser emission elements such as a Laser Diode (LD), a solid-state laser, a high power laser, a Light Emitting Diode (LED), a Vertical Cavity Surface Emitting Laser (VCSEL), an External Cavity Diode Laser (ECDL), etc., but is not limited thereto.

Further, the wavelength of the laser emitted from the laser emitting unit 100 according to an embodiment may be within a specific wavelength range.

For example, the wavelength of the laser emitted from the laser emitting unit 100 according to an embodiment may be within the 905 nm band, the 940 nm band, or the 1550 nm band, but is not limited thereto.

In this case, the band of the wavelength may be a band within a predetermined range on the basis of a central wavelength.

For example, the 905 nm band may refer to a band within 10 nm difference from 905 nm, the 940 nm band may refer to a band within 10 nm difference from 940 nm, and the 1550 nm band may refer to a band within 10 nm difference from 1550 nm, but the present disclosure is not limited thereto.

Further, the wavelength of the laser emitted from the laser emitting unit 100 according to an embodiment may be within various wavelength ranges.

For example, the wavelength of a first laser emitted from a first laser emission element included in the laser emitting unit 100 according to an embodiment may be within the 905 nm band, and the wavelength of a second laser emitted from a second laser emission element included in the laser emitting unit 100 according to an embodiment may be within the 1550 nm band, but the present disclosure is not limited thereto.

Further, the wavelengths of the lasers emitted from the laser emitting unit 100 according to an embodiment may be within a specific wavelength range and may be different from each other.

For example, the wavelength of the first laser emitted from the first laser emission element included in the laser emitting unit 100 according to an embodiment may be within the 940 nm band and may be 939 nm, and the wavelength of the second laser emitted from the second laser emission element included in the laser emitting unit 100 according to an embodiment may be within the 940 nm band and may be 943 nm, but the present disclosure is not limited thereto.

Referring to FIG. 1 again, a LiDAR device 1000 according to an embodiment may include an optic unit 200.

In this configuration, the optic unit may be expressed in various ways such as a steering unit, a scanning unit, etc., for explaining the present disclosure, but is not limited thereto.

An optical unit 200 according to one embodiment may be configured to alter a flight path of a laser.

For example, the optical unit 200 according to one embodiment may be configured to alter the flight path of a laser emitted from a laser emitting unit 100, and, when the laser emitted from the laser emitting unit 100 is reflected by a target object, the optical unit may be configured to alter the flight path of the laser reflected from the target object. However, the present invention is not limited thereto.

Further, an optical unit 200 according to one embodiment may be configured to alter the flight path of a laser by reflecting the laser.

For example, the optical unit 200 according to one embodiment may be configured to alter the flight path by reflecting a laser emitted from a laser emitting unit 100, and, when the laser emitted from the laser emitting unit 100 is reflected by a target object, the optical unit may be configured to alter the flight path by reflecting the laser reflected from the target object. However, the present invention is not limited thereto.

In this case, the optical unit 200 according to one embodiment may include at least one optical means among various optical means for reflecting a laser.

For example, the optical unit 200 according to one embodiment may include at least one optical means among a mirror, a resonance scanner, a MEMS mirror, a VCM (Voice Coil Motor), a polygonal mirror, a rotating mirror, or a galvano mirror. However, the present invention is not limited thereto.

Further, the optical unit 200 according to one embodiment may be configured to alter the flight path of a laser by refracting the laser.

For example, the optical unit 200 according to one embodiment may be configured to alter the flight path by refracting a laser emitted from a laser emitting unit 100, and, when the laser emitted from the laser emitting unit 100 is reflected by a target object, the optical unit may be configured to alter the flight path by refracting the laser reflected from the target object. However, the present invention is not limited thereto.

In this case, the optical unit 200 according to one embodiment may include at least one optical means among various optical means for refracting a laser.

For example, the optical unit 200 according to one embodiment may include at least one optical means among a lens, a prism, a micro lens, a microfluidic lens, or a metasurface. However, the present invention is not limited thereto.

Further, the optical unit 200 according to one embodiment may be configured to alter the flight path of a laser by changing the phase of the laser.

For example, the optical unit 200 according to one embodiment may be configured to alter the flight path by changing the phase of a laser emitted from a laser emitting unit 100, and, when the laser emitted from the laser emitting unit 100 is reflected by a target object, the optical unit may be configured to alter the flight path by changing the phase of the laser reflected from the target object. However, the present invention is not limited thereto.

In this case, the optical unit 200 according to one embodiment may include at least one optical means among various optical means for changing the phase of a laser.

For example, the optical unit 200 according to one embodiment may include at least one optical means among an OPA (Optical Phased Array), a meta lens, or a metasurface. However, the present invention is not limited thereto.

Further, the optical unit 200 according to one embodiment may include two or more optical units.

For example, the optical unit 200 according to one embodiment may include a transmitting optic unit configured to direct a laser emitted from a laser emitting unit 100 toward a scan area of the LiDAR device, and a receiving optic unit configured to deliver a laser reflected from a target object to a detecting unit 300. However, the present invention is not limited thereto.

Also, for example, the optical unit 200 according to one embodiment may include a first optical unit configured to alter the flight path of a laser emitted from the laser emitting unit 100 toward a direction of a first group, and a second optical unit configured to alter the flight path of a laser emitted from the laser emitting unit 100 toward a direction of a second group. However, the present invention is not limited thereto.

In addition to the above-described examples, the optical unit 200 according to one embodiment may be provided as a combination of various configurations to expand a scan area of the LiDAR device using a laser emitted from the laser emitting unit 100 and to deliver a laser reflected from a target object to the detecting unit 300 according to one embodiment.

Referring again to FIG. 1, a LiDAR device 1000 according to one embodiment may include a detecting unit 300.

Here, the detecting unit may be variously referred to as a light receiving unit, a receiving unit, or a sensor unit for the purpose of describing the present invention, but is not limited thereto.

A detecting unit 300 according to one embodiment may be configured to detect a laser.

For example, the detecting unit 300 according to one embodiment may detect a laser reflected from a target object located within a scan area of the LiDAR device 1000 according to one embodiment.

Further, the detecting unit 300 according to one embodiment may be arranged to receive the laser and may be configured to generate an electrical signal based on the received laser.

For example, the detecting unit 300 according to one embodiment may be arranged to receive a laser reflected from a target object located within the scan area of the LiDAR device 1000 according to one embodiment, and may generate an electrical signal based on the received laser.

In this case, the detecting unit 300 according to one embodiment may be arranged to receive a laser reflected from a target object located within the scan area of the LiDAR device 1000 through at least one optical means. The at least one optical means may be included in the above-described optical unit and may include an optical filter, but is not limited thereto.

Further, the detecting unit 300 according to one embodiment may generate detection information of the laser based on the generated electrical signal.

For example, the detecting unit 300 according to one embodiment may generate detection information of the laser by comparing a predetermined threshold value with a rising edge, a falling edge, or a midpoint between the rising edge and the falling edge of the generated electrical signal. However, the present invention is not limited thereto.

Further, for example, the detecting unit 300 according to one embodiment may generate histogram data corresponding to the laser detection information based on the generated electrical signal. However, the present invention is not limited thereto.

Further, the detecting unit 300 according to one embodiment may determine a laser detection timing based on the generated detection information of the laser.

For example, the detecting unit 300 according to one embodiment may determine a laser detection timing based on the detection information of the laser generated from the rising edge of the generated electrical signal, based on the detection information of the laser generated from the falling edge of the generated electrical signal, or based on both the detection information of the laser generated from the rising edge and the falling edge of the generated electrical signal. However, the present invention is not limited thereto.

Also, for example, the detecting unit 300 according to one embodiment may determine a laser detection timing based on histogram data generated based on the generated electrical signal. However, the present invention is not limited thereto.

More specifically, for example, the detecting unit 300 according to one embodiment may determine a laser detection timing based on the peak of the generated histogram data, a judgment on the rising edge and the falling edge based on a predetermined value, and the like. However, the present invention is not limited thereto.

In this case, the histogram data may be generated based on the electrical signal generated from the detecting unit 300 according to one embodiment during at least one scan cycle.

Further, the detecting unit 300 according to one embodiment may include at least one detecting element among various detecting elements.

For example, the detecting unit 300 according to one embodiment may include at least one detecting element among a PN photodiode, a phototransistor, a PIN photodiode, an APD (Avalanche Photodiode), a SPAD (Single-Photon Avalanche Diode), a SiPM (Silicon Photomultiplier), a comparator, a CMOS (Complementary Metal-Oxide-Semiconductor), or a CCD (Charge-Coupled Device). However, the present invention is not limited thereto.

Further, the detecting unit 300 according to one embodiment may include one or more detecting elements.

For example, the detecting unit 300 according to one embodiment may include a single detecting element or may include a plurality of detecting elements.

Further, the detecting unit 300 according to one embodiment may be configured as an array in which a plurality of detecting elements are arranged in an array form. However, the present invention is not limited thereto.

For example, the detecting unit 300 according to one embodiment may be implemented as a SPAD array in which a plurality of SPADs (Single-Photon Avalanche Diodes) are arranged in an array form. However, the present invention is not limited thereto.

Referring again to FIG. 1, a LiDAR device 1000 according to one embodiment may include a controller 400.

Here, the controller may be variously referred to as a controller or the like for the purpose of describing the present invention, but is not limited thereto.

A controller 400 according to one embodiment may control the operation of the laser emitting unit 100, the optical unit 200, or the detecting unit 300.

Further, the controller 400 according to one embodiment may control the operation of the laser emitting unit 100.

For example, the controller 400 may control the output timing of the laser emitted from the laser emitting unit 100. The controller 400 may also control the power of the laser emitted from the laser emitting unit 100. Furthermore, the controller 400 may control the pulse width of the laser emitted from the laser emitting unit 100. The controller 400 may also control the emission period of the laser. In addition, when the laser emitting unit 100 includes a plurality of laser emitting elements, the controller 400 may control the laser emitting unit 100 such that only some of the laser emitting elements are operated.

Further, the controller 400 according to one embodiment may control the operation of the optical unit 200.

For example, the controller 400 may control the operation speed of the optical unit 200. Specifically, when the optical unit 200 includes a rotating mirror, the controller may control the rotation speed of the rotating mirror, and when the optical unit 200 includes a MEMS mirror, the controller may control the repetition cycle of the MEMS mirror. However, the present invention is not limited thereto.

Further, for example, the controller 400 may control the degree of operation of the optical unit 200. Specifically, when the optical unit 200 includes a MEMS mirror, the controller may control the operation angle of the MEMS mirror. However, the present invention is not limited thereto.

Further, the controller 400 according to one embodiment may control the operation of the detecting unit 300.

For example, the controller 400 may control the sensitivity of the detecting unit 300. Specifically, the controller 400 may adjust a predetermined threshold value to control the sensitivity of the detecting unit 300. However, the present invention is not limited thereto.

Also, for example, the controller 400 may control the operation of the detecting unit 300. Specifically, the controller 400 may control the on/off state of the detecting unit 300, and when the detecting unit includes a plurality of sensor elements, the controller 400 may control the operation of the detecting unit 300 such that only some of the sensor elements are operated.

Further, the controller 400 according to one embodiment may generate detection information of a laser based on the electrical signal generated from the detecting unit 300.

For example, the controller 400 according to one embodiment may generate detection information of a laser by comparing a predetermined threshold value with the rising edge, falling edge, or midpoint between the rising edge and falling edge of the electrical signal generated from the detecting unit 300. However, the present invention is not limited thereto.

Also, for example, the controller 400 according to one embodiment may generate histogram data corresponding to the detection information of a laser based on the electrical signal generated from the detecting unit 300. However, the present invention is not limited thereto.

Further, the controller 400 according to one embodiment may determine a laser detection timing based on the detection information of a laser generated from the detecting unit 300.

For example, the controller 400 according to one embodiment may determine the laser detection timing based on the detection information of a laser generated from the rising edge of the electrical signal generated from the detecting unit 300, based on the detection information of a laser generated from the falling edge of the signal, or based on both the rising and falling edges. However, the present invention is not limited thereto.

Also, for example, the controller 400 according to one embodiment may determine the laser detection timing based on histogram data generated from the electrical signal generated from the detecting unit 300. However, the present invention is not limited thereto.

More specifically, for example, the controller 400 according to one embodiment may determine the laser detection timing based on a peak of the histogram data generated from the detecting unit 300, and/or based on a judgment regarding the rising edge and falling edge relative to a predetermined value. However, the present invention is not limited thereto.

In this case, the histogram data may be generated based on the electrical signal generated from the detecting unit 300 according to one embodiment during at least one scan cycle.

Further, the controller 400 according to one embodiment may obtain distance information to a target object based on the determined laser detection timing.

For example, the controller 400 according to one embodiment may obtain the distance information to a target object based on the determined output timing and detection timing of the laser. However, the present invention is not limited thereto.

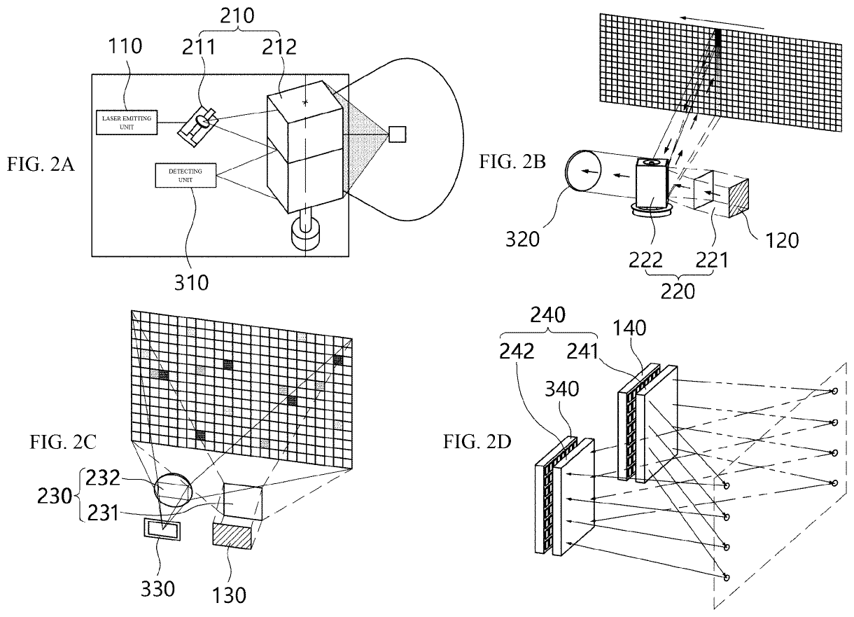

FIGS. 2A to 2D are a diagram showing various embodiments of a LiDAR device.

Referring to FIG. 2A, a LiDAR device according to one embodiment may include a laser emitting unit 110, an optic unit 210, and a detecting unit 310. The optic unit 210 may include a nodding mirror 211 that nods within a predetermined range and a polygonal mirror 212 that rotates about at least one axis. However, the present invention is not limited thereto.

Here, since the above descriptions may be applied to the laser emitting unit 110, the optic unit 210, and the detecting unit 310, redundant descriptions will be omitted. FIG. 2A is a simplified schematic diagram illustrating one embodiment among various embodiments of the LiDAR device, and the various embodiments of the LiDAR device are not limited to FIG. 2A.

Referring to FIG. 2B, a LiDAR device according to one embodiment may include a laser emitting unit 120, an optic unit 220, and a detecting unit 320. The optic unit 220 may include at least one lens 221 configured to collimate and steer a laser emitted from the laser emitting unit 120 and a polygonal mirror 222 that rotates about at least one axis. However, the present invention is not limited thereto.

Here, since the above descriptions may be applied to the laser emitting unit 120, the optic unit 220, and the detecting unit 320, redundant descriptions will be omitted. FIG. 2B is a simplified schematic diagram illustrating one embodiment among various embodiments of the LiDAR device, and the various embodiments of the LiDAR device are not limited to FIG. 2B.

Referring to FIG. 2C, a LiDAR device according to one embodiment may include a laser emitting unit 130, an optic unit 230, and a detecting unit 330. The optic unit 230 may include at least one lens 231 configured to collimate and steer a laser emitted from the laser emitting unit 130, and at least one lens 232 configured to deliver a laser reflected from a target object to the detecting unit 330. However, the present invention is not limited thereto.

Here, since the above descriptions may be applied to the laser emitting unit 130, the optic unit 230, and the detecting unit 330, redundant descriptions will be omitted. FIG. 2C is a simplified schematic diagram illustrating one embodiment among various embodiments of the LiDAR device, and the various embodiments of the LiDAR device are not limited to FIG. 2C.

Referring to FIG. 2D, a LiDAR device according to one embodiment may include a laser emitting unit 140, an optic unit 240, and a detecting unit 340. The optic unit 240 may include at least one lens 241 configured to collimate and steer a laser emitted from the laser emitting unit 140, and at least one lens 242 configured to deliver a laser reflected from a target object to the detecting unit 340. However, the present invention is not limited thereto.

Here, since the above descriptions may be applied to the laser emitting unit 140, the optic unit 240, and the detecting unit 340, redundant descriptions will be omitted. FIG. 2D is a simplified schematic diagram illustrating one embodiment among various embodiments of the LiDAR device, and the various embodiments of the LiDAR device are not limited to FIG. 2D.

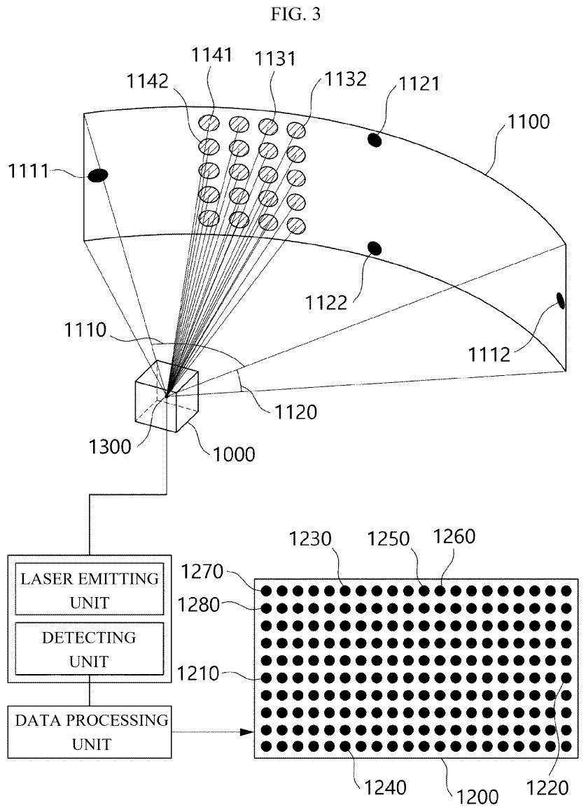

FIG. 3 is a diagram illustrating the operation of a LiDAR device according to an embodiment and LiDAR data.

Referring to FIG. 3, a LiDAR device 1000 according to one embodiment may include a laser emitting unit for outputting a laser and a detecting unit for detecting the laser. The descriptions of the laser emitting unit and the detecting unit have been provided above and will not be repeated here.

Also referring to FIG. 3, a data processing unit according to one embodiment may obtain LiDAR data 1200 based on the laser detected by the LiDAR device 1000.

Also, the data processing unit may be included in the LiDAR device 1000, or may be included in the controller of the LiDAR device 1000 described above. However, it is not limited thereto and may be positioned to obtain signals generated from the detecting unit included in the LiDAR device 1000 via at least one communication method.

Referring again to FIG. 3, the LiDAR device 1000 according to one embodiment may emit a laser to form a field of view (FOV) 1100 and may obtain LiDAR data 1200 by detecting the laser reflected within the field of view 1100.

Also, the field of view 1100 of the LiDAR device 1000 may indicate a region where the laser is emitted or a region where the laser can be detected, but is not limited thereto.

Also, the LiDAR data 1200 may refer to various types of data obtained from the LiDAR device 1000. For example, the data may include point data, point cloud, or frame data obtained from the LiDAR device 1000, but is not limited thereto.

Also, the point data may include distance information, location information, and the like. The point cloud may refer to clustered data of the point data, but is not limited thereto.

Also, the frame data may refer to a group of the point data, but is not limited thereto.

Also, the field of view 1100 of the LiDAR device 1000 may include a horizontal field of view 1110 corresponding to the scan range in the horizontal direction and a vertical field of view 1120 corresponding to the scan range in the vertical direction.

Also, the horizontal field of view 1110 and the vertical field of view 1120 may be defined by the emitted laser.

For example, the horizontal field of view 1110 may be defined by a first laser 1111 emitted at a first angle and a second laser 1112 emitted at a second angle, and more specifically, by the difference between the first and second angles. However, the present invention is not limited thereto.

Likewise, the vertical field of view 1120 may be defined by a third laser 1121 emitted at a third angle and a fourth laser 1122 emitted at a fourth angle, and more specifically, by the difference between the third and fourth angles. However, the present invention is not limited thereto.

Also, the definitions of the horizontal field of view 1110 and vertical field of view 1120 of the LiDAR device 1000 are not limited to the above examples and may be defined by various methods representing the area in which the laser is emitted from the LiDAR device 1000.

Also, the horizontal and vertical fields of view 1110 and 1120 may also be defined based on the detected laser, more specifically, based on point data generated by the detected laser.

For example, the horizontal field of view 1110 may be defined by a first point data 1210 and a second point data 1220, more specifically, by the difference between the emission angles of the lasers corresponding to the respective point data. However, the present invention is not limited thereto.

Similarly, the vertical field of view 1120 may be defined by a third point data 1230 and a fourth point data 1240, more specifically, by the difference between the emission angles of the lasers corresponding to the respective point data. However, the present invention is not limited thereto.

Also, the definitions of the horizontal and vertical fields of view of the LiDAR device 1000 are not limited to the above examples and may be defined by various methods representing the detectable area of the laser.

Also referring to FIG. 3, the laser that forms the field of view 1100 in the LiDAR device 1000 may be emitted to have angular resolution.

Also, the angular resolution may include horizontal angular resolution for the horizontal direction and vertical angular resolution for the vertical direction.

Also, the horizontal and vertical angular resolutions may be defined by the emitted lasers.

For example, the horizontal angular resolution may be defined by a fifth laser 1131 emitted at a fifth angle and a sixth laser 1132 emitted at a sixth angle, and more specifically, by the difference between those angles. However, the present invention is not limited thereto.

Likewise, the vertical angular resolution may be defined by a seventh laser 1141 and an eighth laser 1142, and more specifically, by the difference between their respective emission angles. However, the present invention is not limited thereto.

Also, the definitions of horizontal and vertical angular resolutions of the LiDAR device 1000 are not limited to the above examples and may be defined by various methods for expressing the angular resolution capable of distinguishing target objects.

Also referring to FIG. 3, the LiDAR data 1200 obtained from the LiDAR device 1000 may include point data having angular resolution.

Also, the angular resolution may include horizontal angular resolution and vertical angular resolution.

Also, these resolutions may be defined by the detected laser, and more specifically, by point data generated by the detected laser.

For example, the horizontal angular resolution may be defined by a fifth point data 1250 and a sixth point data 1260, and more specifically, by the difference between the emission angles of the lasers corresponding to the respective point data. However, the present invention is not limited thereto.

Likewise, the vertical angular resolution may be defined by a seventh point data 1270 and an eighth point data 1280, and more specifically, by the difference between their corresponding laser emission angles. However, the present invention is not limited thereto.

Again, the definitions of the horizontal and vertical angular resolutions are not limited to the above and may be determined in various ways that express the ability to distinguish target objects.

Also, each laser emitted from the LiDAR device 1000 may have a specific size and divergence angle.

For example, each laser emitted from the LiDAR device 1000 may have a major axis length, a minor axis length, and a divergence angle, but is not limited thereto.

Also, each point data included in the LiDAR data 1200 may include distance information.

Also, an optical origin 1300 may be defined for the LiDAR device 1000.

Also, the optical origin 1300 may represent the origin of a coordinate system used to express the LiDAR data described above.

Also, the optical origin 1300 may represent the assumed origin point from which the laser is emitted in the LiDAR device 1000.

Also, the optical origin 1300 may represent the reference point used for distance measurement using a laser in the LiDAR device 1000.

Also, the optical origin 1300 may represent the reference point for describing the point data obtained from the LiDAR device 1000.

Also, the optical origin 1300 may represent a physically derived optical origin or, alternatively, an artificially defined optical origin for the LiDAR device 1000, but is not limited thereto.

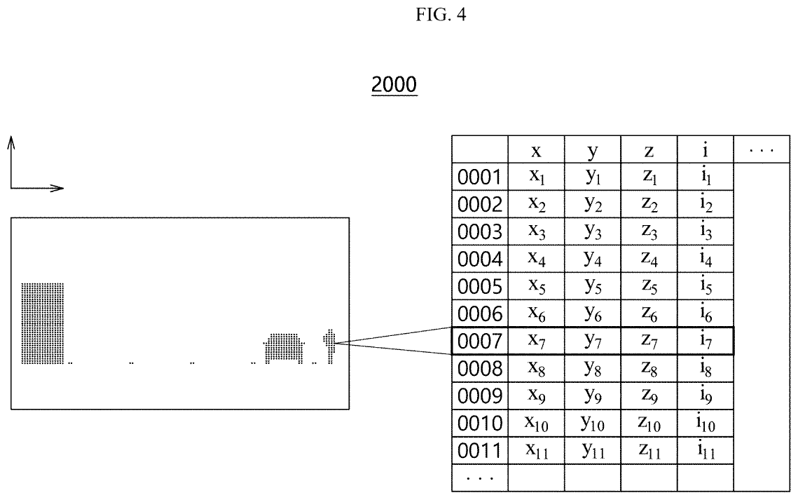

FIG. 4 is a diagram illustrating LiDAR data according to an embodiment.

LiDAR data according to an embodiment may be represented in various formats such as a point cloud, a depth map, and an intensity map.

In this case, the point cloud may be a format in which the information of each measurement point is converted into positional information, and the point cloud according to an embodiment may include position coordinate values x, y, and z and intensity value I, which are acquired on the basis of the angle information and distance information at which a laser is emitted or acquired, but is not limited thereto.

Further, in this case, the depth map may be a format that includes two-dimensional pixel position information and distance information for each measurement point, and the depth map according to an embodiment may include pixel values x and y and a distance value D, which are acquired on the basis of the angle information at which a laser is emitted or acquired, but is not limited thereto.

Further, the intensity map may be a format that includes two-dimensional pixel position information and intensity information for each measurement point, and the intensity map according to an embodiment may include pixel values x and y and an intensity value I, which are acquired on the basis of the angle information at which a laser is emitted or acquired, but is not limited thereto.

Further, in addition to the examples described above, LiDAR data may be acquired in various formats, but, for the convenience of explanation, the following description will be based on LiDAR data acquired in the format of a point cloud.

Referring to FIG. 4, LiDAR data according to an embodiment may include point cloud data 2000.

Further, the point cloud data 2000 according to an embodiment may include a plurality of point data. In other words, the point cloud data 2000 may be a point data set that includes a plurality of point data.

Further, a plurality of point data according to an embodiment each may include position coordinate values x, y, and z and an intensity value i, but is not limited thereto.

A method of determining position coordinates of point data is briefly explained for better understanding. A plurality of laser emission directions determined within the field of view (FOV) of the LiDAR device 1000 described above may correspond to the laser emission elements (e.g., VCSELs), respectively. That is, the laser emission direction of each of the laser emission elements, with respect to the optical origin, may be defined by the horizontal angle ϕ and the vertical angle θ in a spherical coordinate system. In this case, the flight time of a laser and the intensity of sensed light may be acquired on the basis of electrical emission information detected by the detector elements corresponding to the laser emission elements, respectively. The flight time, as described above, can be converted into distance, and the distance can be converted into an r-value in a spherical coordinate system with respect to the optical origin. That is, the location of an object sensed by a plurality of lasers or a reflective surface that is at least a portion of an object can be represented by spherical coordinates (r, θ, φ) defined by the horizontal angle, vertical angle, and distance value in the spherical coordinate system. Of course, the spherical coordinates described above can be converted into Cartesian coordinates (x, y, z). That is, the position coordinate values included in each of the plurality of point data can be acquired on the basis of the distance value between an object and the LiDAR device (more specifically, the optical origin of the LiDAR device) that is converted on the basis of the emission direction and flight time of a laser.

For example, the position coordinate values included in each of the plurality of point data can be acquired on the basis of an angle (or coordinate) value at which a laser is emitted and a distance value acquired on the basis of the emitted laser, but the present disclosure is not limited thereto.

Further, the position coordinate values included in each of the plurality of point data can be acquired on the basis of the coordinate values of a detector that acquires a laser and a distance value acquired on the basis of the acquired laser, but the present disclosure is not limited thereto.

Further, the intensity value included in each of the plurality of point data can be acquired on the basis of an electrical signal acquired from the detector unit.

For example, the intensity value included in each of the plurality of point data can be acquired on the basis of characteristics such as the magnitude and width of an electrical signal acquired from the detector unit, but is not limited thereto, and can be acquired by various algorithms for an electrical signal acquired from the detector unit.

Further, for example, the intensity value included in each of the plurality of point data can be acquired on the basis of histogram data created on the basis of an electrical signal acquired from the detector unit, but is not limited thereto.

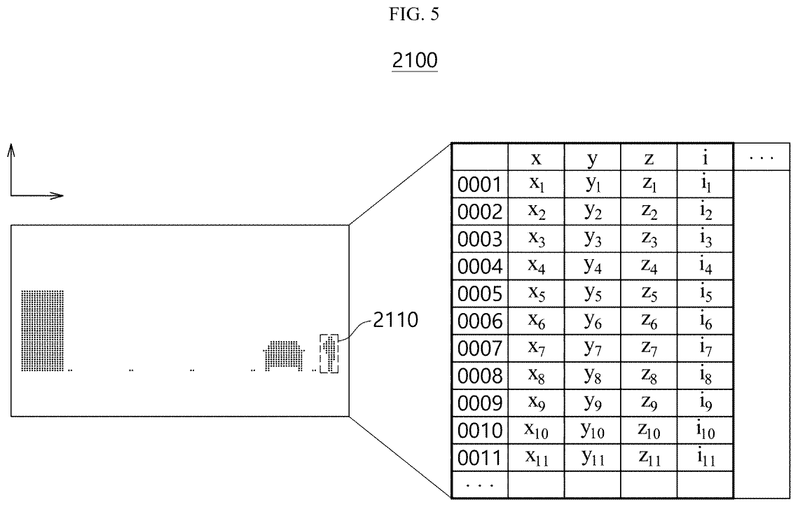

FIG. 5 is a diagram illustrating LiDAR data according to an embodiment.

Referring to FIG. 5, LiDAR data according to an embodiment may include point cloud data 2100.

In this case, since the above descriptions can be applied to the point cloud data 2100, repetitive descriptions are omitted.

The point cloud data 2100 according to an embodiment may include at least one sub-point data set 2110.

In this case, the at least one sub-point data set 2110 may refer to a set of point data grouped by a specific rule, algorithm, or the like.

For example, the at least one sub-point data set 2110 may refer to a set of point data grouped by human input, but is not limited thereto.

Further, for example, the at least one sub-point data set 2110 may refer to a set of point data grouped by a segment algorithm for the same object, but is not limited thereto.

Further, for example, the at least one sub-point data set 2110 may refer to a set of point data grouped by a clustering algorithm, but is not limited thereto.

Further, for example, the at least one sub-point data set 2110 may refer to a set of point data grouped by a trained machine learning model, but is not limited thereto.

Further, for example, the at least one sub-point data set 2110 may refer to a set of point data grouped by a trained deep learning model, but is not limited thereto.

Further, the LiDAR data processing unit according to an embodiment may acquire property data for the at least one sub-point data set 2110 described above.

For example, the LiDAR data processing unit may acquire at least one piece of property data for the at least one sub-point data set 2110 in accordance with human input, but is not limited thereto.

Further, for example, the LiDAR data processing unit may acquire at least one piece of property data for the at least one sub-point data set 2110 using a specific algorithm, but is not limited thereto.

Further, for example, the LiDAR data processing unit may acquire at least one piece of property data for the at least one sub-point data set 2110 using a trained machine learning model, but is not limited thereto.

Further, for example, the LiDAR data processing unit may acquire at least one piece of property data for the at least one sub-point data set 2110 using a trained deep learning model, but is not limited thereto.

Further, the machine learning model or deep learning model described above may include at least one Artificial Neural Network (ANN).

For example, the machine learning model or deep learning model described above may include at least one artificial neural network layer of various artificial neural network layers such as a feedforward neural network, a radial basis function network or a Kohonen self-organizing network, a Deep Neural Network (DNN), a Convolutional Neural Network (CNN), a Recurrent Neural Network (RNN), a Long Short Term Memory (LSTM) network, or Gated Recurrent Units (GRU), but is not limited thereto.

Further, the at least one artificial neural network layer included in the machine learning model or deep learning model described above may be designed to use the same or different activation functions.

In this case, the activation function may include a Sigmoid Function, a Tanh Function, a Rectified Linear unit Function (Relu Function), a leaky Relu Function, an Exponential Linear unit (ELU) function, a Softmax function, etc., but is not limited thereto, and may include various activation functions (including custom activation functions) for outputting or transmitting a result value to other artificial neural network layers.

Further, the machine learning model or deep learning model described above can be trained using at least one loss function.

In this case, the at least one loss function may include Mean Squared Error (MEM), Root Mean Squared Error (RMSE), Binary Crossentropy, Categorical Crossentropy, and Sparse Categorical Crossentropy, but is not limited thereto, and may include various functions (including custom loss functions) for calculating the difference between a predicted result value and an actual result value.

Further, the machine learning model or deep learning model described above can be trained using at least one optimizer.

In this case, the optimizer can be used to update relationship-defining parameters between an input value and a result value.

In this case, the at least one optimizer may include Gradient descent, Batch Gradient Descent, Stochastic Gradient Descent, Mini-batch Gradient Descent, Momentum, AdaGrad, RMSProp, AdaDelta, Adam, NAG, NAdam, RAdam, AdamW, etc., but is not limited thereto.

Hereafter, acquired property data are described in more detail.

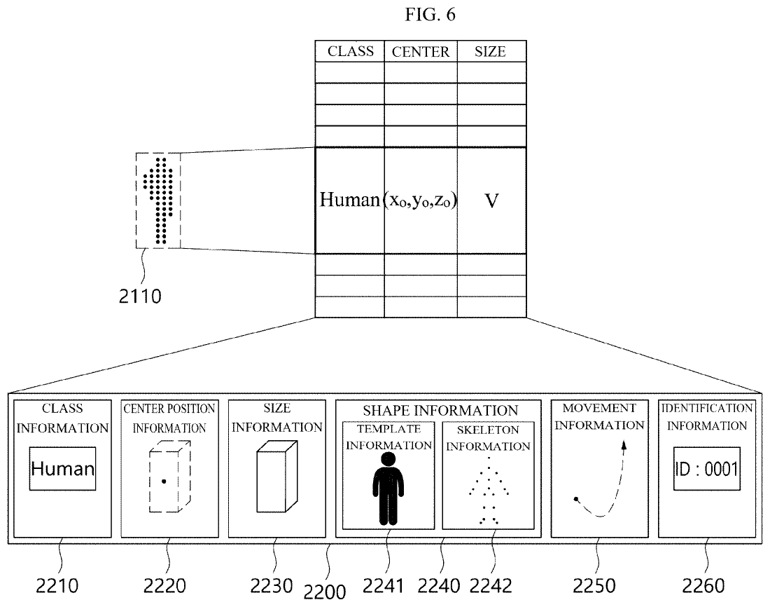

FIG. 6 is a diagram illustrating pieces of information included in property data according to an embodiment.

Referring to FIG. 6, the LiDAR data processing unit according to an embodiment can acquire at least one piece of property data 2200 for the sub-point data set 2110 according to the embodiment.

In this case, the at least one piece of property data 2200 may include class information 2210, center position information 2220, size information 2230, shape information 2240, movement information 2250, identification information 2260, etc. of an object represented by the sub-point data set 2110, but is not limited thereto.

Further, in order to acquire each of the property data included in the at least one piece of property data 2200, the same algorithm or model may be used, and different algorithms or models may also be used.

Further, the at least one piece of property data 2200 can be acquired on the basis of point cloud data included in one piece of frame data.

For example, the property data, such as the class information 2210, center position information 2220, size information 2230, and shape information 2240 of an object included in the at least one piece of property data 2200, can be acquired on the basis of point cloud data included in one piece of frame data, but is not limited thereto.

Further, the at least one piece of property data 2200 can be acquired on the basis of point cloud data included in a plurality of frame data.

For example, property data such as movement information 2250 and identification information 2260, which are included in the at least one piece of property data 2200, may be acquired on the basis of point cloud data included in a plurality of frame data, but are not limited thereto.

Further, although LiDAR data acquired in the form of a point cloud was described with reference to FIG. 4 to FIG. 6, the contents described above may also be applicable to LiDAR data acquired in formats such as a depth map and an intensity map other than the form of a point cloud, as described above.

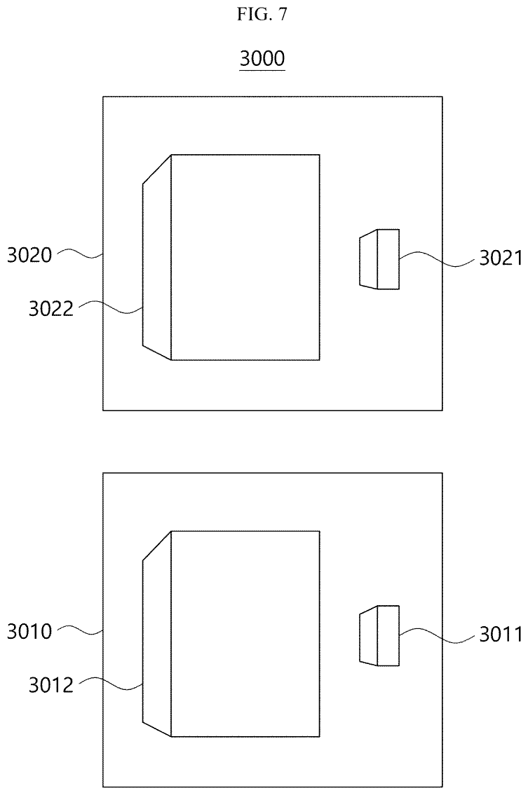

FIG. 7 is a diagram illustrating a LiDAR device according to an embodiment.

Referring to FIG. 7, a LiDAR device 3000 according to one embodiment may include a transmission module 3010 and a reception module 3020.

Additionally, the transmission module 3010 may include a laser emitting array 3011 and a first lens assembly 3012, but is not limited thereto.

In this case, since the laser emitting array 3011 may correspond to the above-described laser emitting unit and the like, redundant descriptions will be omitted.

Also, in this case, the first lens assembly 3012 may be referred to, for convenience, as a transmission lens assembly, transmission optic, transmission optic unit, transmission optic module, emitting optic, emitting optic unit, or emitting optic module, but is not limited thereto.

Additionally, the laser emitting array 3011 may output at least one laser. For example, the laser emitting array 3011 may output a plurality of lasers, but is not limited thereto.

Additionally, the laser emitting array 3011 may output at least one laser at a first wavelength. For example, the laser emitting array 3011 may output at least one laser at a wavelength of 940 nm, or may output a plurality of lasers at a wavelength of 940 nm, but is not limited thereto.

In this case, the first wavelength may be a wavelength range including a tolerance. For example, the first wavelength may refer to a range of 935 nm to 945 nm, representing a 940 nm wavelength with a tolerance of +5 nm, but is not limited thereto.

Additionally, the laser emitting array 3011 may output at least one laser at the same time point. For example, the laser emitting array 3011 may output a first laser at a first time point, or may output a first and a second laser at a second time point. That is, the laser emitting array 3011 may output at least one laser at the same time point.

Additionally, the first lens assembly 3012 may include at least two or more lens layers. For example, the first lens assembly 3012 may include at least four lens layers, but is not limited thereto.

Additionally, the first lens assembly 3012 may collimate a laser emitted from the laser emitting array 3011. For example, the first lens assembly 3012 may collimate a first laser emitted from the laser emitting array 3011 and change the divergence of the first laser, but is not limited thereto.

Additionally, the first lens assembly 3012 may steer the laser emitted from the laser emitting array 3011. For example, the first lens assembly 3012 may steer a first laser emitted from the laser emitting array 3011 in a first direction and may steer a second laser emitted from the laser emitting array 3011 in a second direction, but is not limited thereto.

Additionally, the first lens assembly 3012 may steer a plurality of lasers emitted from the laser emitting array 3011 at different angles within a range from (x) degrees to (y) degrees. For example, the first lens assembly 3012 may steer a first laser in a first direction so that the first laser is emitted at (x) degrees, and may steer a second laser in a second direction so that the second laser is emitted at (y) degrees, but is not limited thereto.

Additionally, the reception module 3020 may include a laser detecting array 3021 and a second lens assembly 3022, but is not limited thereto.

In this case, since the laser detecting array 3021 may correspond to the above-described detecting unit and the like, redundant descriptions will be omitted.

Also, in this case, the second lens assembly 3022 may be referred to, for convenience, as a reception lens assembly, reception optic, reception optic unit, reception optic module, receiving optic, receiving optic unit, or receiving optic module, but is not limited thereto.

Additionally, the laser detecting array 3021 may detect at least one laser. For example, the laser detecting array 3021 may detect a plurality of lasers.

Additionally, the laser detecting array 3021 may include a plurality of detectors. For example, the laser detecting array 3021 may include a first detector and a second detector, but is not limited thereto.

Additionally, each of the plurality of detectors included in the laser detecting array 3021 may receive different lasers. For example, a first detector included in the laser detecting array 3021 may receive a first laser from a first direction, and a second detector may receive a second laser from a second direction, but is not limited thereto.

Additionally, the laser detecting array 3021 may detect at least a part of the laser emitted from the transmission module 3010. For example, the laser detecting array 3021 may detect at least a portion of a first laser emitted from the transmission module 3010 and may detect at least a portion of a second laser, but is not limited thereto.

Additionally, the second lens assembly 3022 may deliver the laser emitted from the transmission module 3010 to the laser detecting array 3021. For example, when a first laser emitted in a first direction from the transmission module 3010 is reflected from a target located in the first direction, the second lens assembly 3022 may deliver the first laser to the laser detecting array 3021. Likewise, when a second laser emitted in a second direction is reflected from a target located in the second direction, the second lens assembly 3022 may deliver the second laser to the laser detecting array 3021, but is not limited thereto.

Additionally, the second lens assembly 3022 may distribute the laser emitted from the transmission module 3010 to at least two different detectors. For example, when a first laser emitted in a first direction from the transmission module 3010 is reflected from a target located in the first direction, the second lens assembly 3022 may distribute the first laser to a first detector included in the laser detecting array 3021. Likewise, when a second laser emitted in a second direction is reflected from a target located in the second direction, the second lens assembly 3022 may distribute the second laser to a second detector included in the laser detecting array 3021, but is not limited thereto.

Additionally, the laser emitting array 3011 and the laser detecting array 3021 may at least partially correspond to each other. For example, a first laser output from a first laser emitting element included in the laser emitting array 3011 may be detected by a first detector included in the laser detecting array 3021, and a second laser output from a second laser emitting element included in the laser emitting array 3011 may be detected by a second detector included in the laser detecting array 3021, but is not limited thereto.

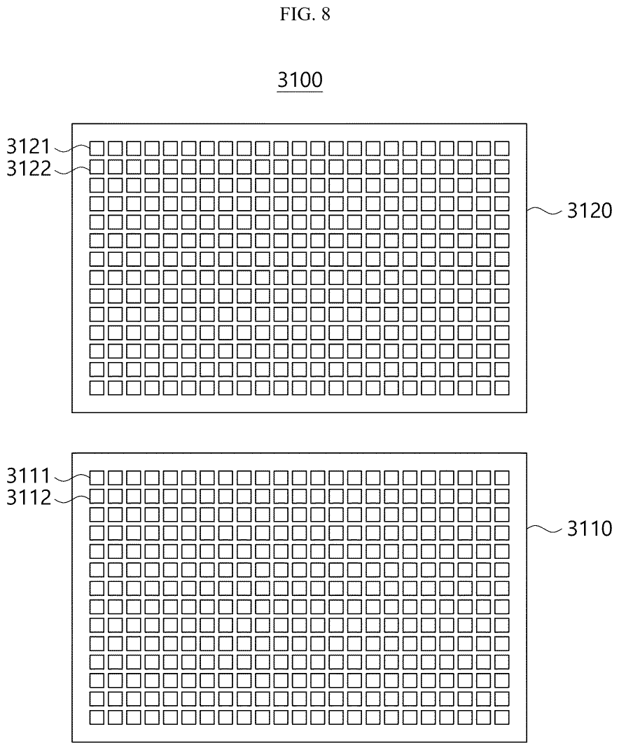

FIG. 8 is a diagram for illustrating a laser emitting array and a laser detecting array included in a LiDAR device according to an embodiment.

Referring to FIG. 8, the LiDAR device 3100 according to an embodiment may include a laser emitting array 3110 and a laser detecting array 3120.

In this case, since the above descriptions may be applied to the laser emitting array 3110 and the laser detecting array 3120, redundant descriptions will be omitted.

The laser emitting array 3110 may include a plurality of laser emitting units.

For example, the laser emitting array 3110 may include a first laser emitting unit 3111 and a second laser emitting unit 3112.

Also, the laser emitting array 3110 may be an array in which a plurality of laser emitting units are arranged in a two-dimensional matrix form.

For example, the laser emitting array 3110 may be an array in which a plurality of laser emitting units are arranged in a two-dimensional matrix form with M rows and N columns, but is not limited thereto.

Also, each of the plurality of laser emitting units may include at least one laser emitting element.

For example, the first laser emitting unit 3111 included in the plurality of laser emitting units may be composed of one laser emitting element, and the second laser emitting unit 3112 may be composed of one laser emitting element, but is not limited thereto.

Also, for example, the first laser emitting unit 3111 may be composed of two or more laser emitting elements, and the second laser emitting unit 3112 may be composed of two or more laser emitting elements, but is not limited thereto.

Also, the lasers output from the respective laser emitting units may be emitted in different directions.

For example, a first laser output from the first laser emitting unit 3111 may be emitted in a first direction, and a second laser output from the second laser emitting unit 3112 may be emitted in a second direction, but is not limited thereto.

Also, the lasers output from each of the plurality of laser emitting units may not overlap at the target location.

For example, the first laser output from the first laser emitting unit 3111 may not overlap with the second laser output from the second laser emitting unit 3112 at a distance of 100 meters, but is not limited thereto.

The laser detecting array 3120 may include a plurality of detecting units.

For example, the laser detecting array 3120 may include a first detecting unit 3121 and a second detecting unit 3122.

Also, the laser detecting array 3120 may be an array in which a plurality of detecting units are arranged in a two-dimensional matrix form.

For example, the laser detecting array 3120 may be an array in which a plurality of detecting units are arranged in a two-dimensional matrix form with M rows and N columns, but is not limited thereto.

Also, each of the plurality of detecting units may include at least one laser detecting element.

For example, the first detecting unit 3121 included in the plurality of detecting units may be composed of one laser detecting element, and the second detecting unit 3122 may be composed of one laser detecting element, but is not limited thereto.

Also, for example, the first detecting unit 3121 may be composed of two or more laser detecting elements, and the second detecting unit 3122 may be composed of two or more laser detecting elements, but is not limited thereto.

Also, each of the plurality of detecting units may detect lasers emitted in different directions.

For example, the first detecting unit 3121 may detect a first laser emitted in a first direction, and the second detecting unit 3122 may detect a second laser emitted in a second direction, but is not limited thereto.

Also, each of the plurality of detecting units may detect a laser output from a corresponding laser emitting unit arranged in correspondence.

For example, the first detecting unit 3121 may detect a first laser output from the first laser emitting unit 3111 arranged to correspond to the first detecting unit 3121, and the second detecting unit 3122 may detect a second laser output from the second laser emitting unit 3112 arranged to correspond to the second detecting unit 3122, but is not limited thereto.

Also, each of the plurality of detecting units may detect lasers output from at least two or more laser emitting units depending on the position of the target object.

For example, the second detecting unit 3122 may detect the second laser output from the second laser emitting unit 3112 when the target is located within a first distance range, and may detect the first laser output from the first laser emitting unit 3111 when the target is located within a second distance range, but is not limited thereto.

Also, at least one detecting value may be generated based on signals obtained from each of the plurality of detecting units.

In this case, the detecting value may include a depth value (distance value), an intensity value, etc., but is not limited thereto.

Also, the coordinates of the detecting value may be determined based on the arrangement of the respective detecting units.

For example, the first detecting unit 3121 may be arranged at the position (1,1) in the laser detecting array, and the coordinates of a first detecting value generated based on the signal obtained from the first detecting unit 3121 may be determined as (1,1), but is not limited thereto.

Also, for example, the second detecting unit 3122 may be arranged at the position (2,1) in the laser detecting array, and the coordinates of a second detecting value generated based on the signal obtained from the second detecting unit 3122 may be determined as (2,1), but is not limited thereto.

Also, the above examples merely describe cases in which coordinate values directly corresponding to the positions of the respective detecting units are calculated, and the scope of the present invention is not limited thereto, and may include various rules by which coordinates of the detecting values are determined based on the arrangement of the respective detecting units.

Also, point data may be generated based on the detecting value and the coordinates of the detecting value.

For example, based on the first detecting value generated from the signal obtained from the first detecting unit 3121 and the first coordinate value corresponding to the coordinates of the first detecting value, first point data may be generated, and the first point data may include a 3D position coordinate value and an intensity value, but is not limited thereto.

Also, for example, based on the second detecting value generated from the signal obtained from the second detecting unit 3122 and the second coordinate value corresponding to the coordinates of the second detecting value, second point data may be generated, and the second point data may include a 3D position coordinate value and an intensity value, but is not limited thereto.

Also, the laser emitting array 3110 and the laser detecting array 3120 may be arranged as arrays having the same dimensions.

For example, the laser emitting array 3110 and the laser detecting array 3120 may be arranged as arrays in which the plurality of laser emitting units and the plurality of detecting units have M rows and N columns, respectively, but is not limited thereto.

Also, the laser emitting array 3110 and the laser detecting array 3120 may be arranged as arrays having different dimensions.

For example, the laser emitting array 3110 may be arranged as an array in which the plurality of laser emitting units have M rows and N columns, while the laser detecting array 3120 may be arranged as an array in which the plurality of detecting units have M+3 rows and N columns, but is not limited thereto.

Also, the number of the plurality of laser emitting units included in the laser emitting array 3110 may be equal to the number of the plurality of detecting units included in the laser detecting array 3120.

For example, the laser emitting array 3110 may include M×N laser emitting units, and the laser detecting array 3120 may include M×N detecting units, but is not limited thereto.

Also, the number of the plurality of laser emitting units included in the laser emitting array 3110 may be different from the number of the plurality of detecting units included in the laser detecting array 3120.

For example, the laser emitting array 3110 may include M×N laser emitting units, and the laser detecting array 3120 may include (M+3)×N detecting units, but is not limited thereto.

Also, for example, the laser emitting array 3110 may include (M×N)/2 laser emitting units, and the laser detecting array 3120 may include M×N detecting units, but is not limited thereto.

Also, for example, the laser emitting array 3110 may include (M×N)/2 laser emitting units, and the laser detecting array 3120 may include (M+3) xN detecting units, but is not limited thereto.

Also, the number of laser emitting elements included in each of the plurality of laser emitting units included in the laser emitting array 3110 may be different from the number of laser detecting elements included in each of the plurality of detecting units included in the laser detecting array 3120.

For example, when the number of laser emitting elements included in the first laser emitting unit 3111 is one, the number of laser detecting elements included in the first detecting unit 3121 may be nine, but is not limited thereto.

Also, for example, when the number of laser emitting elements included in the second laser emitting unit 3112 is one, the number of laser detecting elements included in the second detecting unit 3122 may be nine, but is not limited thereto.

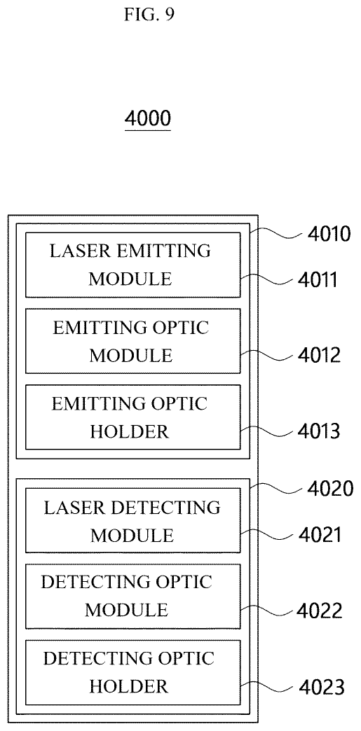

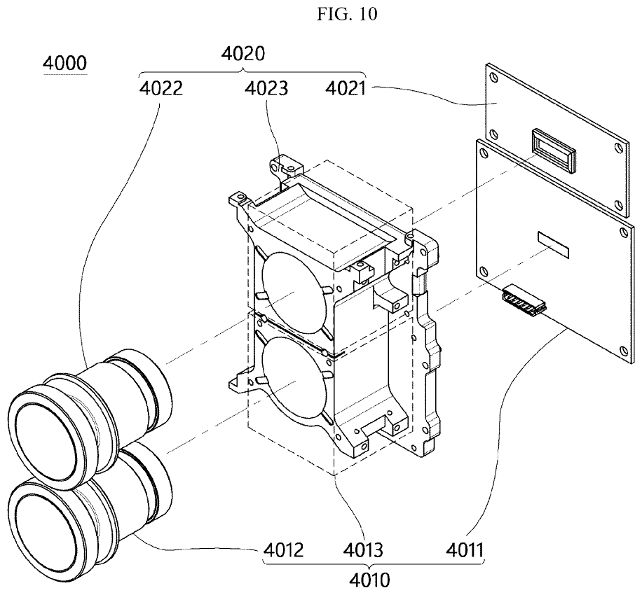

FIG. 9 and FIG. 10 are diagrams illustrating a LiDAR device according to an embodiment.

Referring to FIG. 9 and FIG. 10, a LiDAR device 4000 according to an embodiment may include a transmission module 4010 and a reception module 4020.

Further, referring to FIG. 9 and FIG. 10, the transmission module 4010 may include a laser emitting module 4011, an emitting optic module 4012, and an emitting optic holder 4013.

In this configuration, the laser emitting module 4011 may include a laser emission array, and since the above descriptions can be applied to the laser emission array, repetitive descriptions are omitted.

Further, the emitting optic module 4012 may include a lens assembly, and since the above descriptions of the first lens assembly, etc. can be applied to the lens assembly, repetitive descriptions are omitted.

Further, the emitting optic holder 4013 may be positioned between the laser emitting module 4011 and the emitting optic module 4012.

For example, the emitting optic holder 4013 may be positioned between the laser emitting module 4011 and the emitting optic module 4012 to fix the relative positional relationship between the laser emitting module 4011 and the emitting optic module 4012, but the present disclosure is not limited thereto.

Further, the emitting optic holder 4013 may be formed to fix movement of the emitting optic module 4012.

For example, the emitting optic holder 4013 may be formed to include a hole in which at least a portion of the emitting optic module 4012 is inserted, to restrict movement of the emitting optic module 4012, but the present disclosure is not limited thereto.

Further, referring to FIG. 9 and FIG. 10, the transmission module 4010 according to an embodiment may include a laser detecting module 4021, a detecting optic module 4022, and a detecting optic holder 4023.

In this configuration, the laser detecting module 4021 may include a laser detecting array, and since the above descriptions can be applied to the laser detecting array, repetitive descriptions are omitted.

Further, the detecting optic module 4022 may include a lens assembly, and since the above descriptions of the second lens assembly, etc. can be applied to the lens assembly, repetitive descriptions are omitted.

Further, the detecting optic holder 4023 may be positioned between the laser detecting module 4021 and the detecting optic module 4022.

For example, the detecting optic holder 4023 may be positioned between the laser detecting module 4021 and the detecting optic module 4022 to fix the relative positional relationship between the laser detecting module 4021 and the detecting optic module 4022, but the present disclosure is not limited thereto.

Further, the detecting optic holder 4023 may be formed to fix movement of the detecting optic module 4022.

For example, the detecting optic holder 4023 may be formed to include a hole in which at least a portion of the detecting optic module 4022 is inserted, to restrict movement of the detecting optic module 4022, but the present disclosure is not limited thereto.

Further, the emitting optic holder 4013 and the detecting optic holder may be integrally formed.

For example, the emitting optic holder 4013 and the detecting optic holder 4023 may be integrally formed and two holes of one optic holder may be formed such that the emitting optic module 4012 and the detecting optic module 4022 are at least partially inserted therein, respectively, but the present disclosure is not limited thereto.

Further, the emitting optic holder 4013 and the detecting optic holder 4023 may not be physically separated and may conceptually refer to a first part and a second part of one optic holder, but the present disclosure is not limited thereto.

Further, FIG. 10 is a diagram illustrating an embodiment of the LiDAR device of FIG. 9, and the shapes shown in FIG. 10 do not limit the contents described in FIG. 9 and the present disclosure.

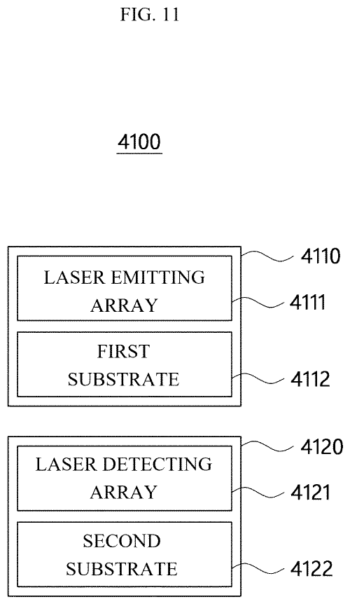

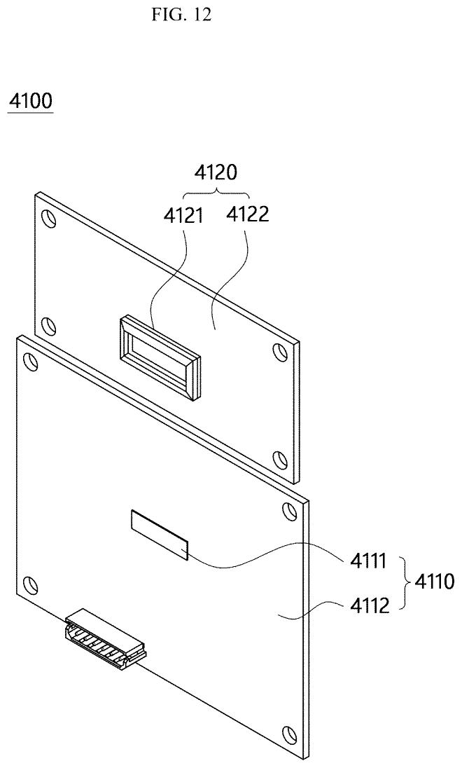

FIG. 11 and FIG. 12 are diagrams illustrating a laser emitting module and a laser detecting module according to an embodiment.

Referring to FIG. 11 and FIG. 12, a LiDAR device 4100 according to an embodiment may include a laser emitting module 4110 and a laser detecting module 4120.

Further, referring to FIG. 11 and FIG. 12, the laser emitting module 4110 according to an embodiment may include a laser emitting array 4111 and a first substrate 4112.

In this case, since the above descriptions can be applied to the laser emitting array 4111, repetitive descriptions are omitted.

The laser emitting array 4111 according to an embodiment may be provided in the form of a chip with a plurality of laser emitting units arranged in an array, but is not limited thereto.

For example, the laser emitting array 4111 may be provided in the form of a laser emitting chip, but is not limited thereto.

Further, the laser emitting array 4111 may be positioned on the first substrate 4112, but is not limited thereto.

Further, the first substrate 4112 may include a laser emitting driver for controlling the operation of the laser emitting array 4111, but is not limited thereto.

Further, referring to FIG. 11 and FIG. 12, the laser detecting module 4120 according to an embodiment may include a laser detecting array 4121 and a second substrate 4122.

In this case, since the above descriptions can be applied to the laser detecting array 4121, repetitive descriptions are omitted.

The laser detecting array 4121 according to an embodiment may be provided in the form of a chip with a plurality of laser detecting units arranged in an array, but is not limited thereto.

For example, the laser detecting array 4121 may be provided in the form of a laser detecting chip, but is not limited thereto.

Further, the laser detecting array 4121 may be positioned on the second substrate 4122, but is not limited thereto.

Further, the second substrate 4122 may include a laser detecting driver for controlling the operation of the laser detecting array 4121, but is not limited thereto.

Further, the first substrate 4112 and the second substrate 4122, as shown in FIG. 11, may be provided separately from each other, but they are not limited thereto and may be provided as one substrate.

Further, FIG. 12 is a diagram illustrating an embodiment of the LiDAR device of FIG. 11, and the shapes shown in FIG. 12 do not limit the contents described in FIG. 11 and the present disclosure.

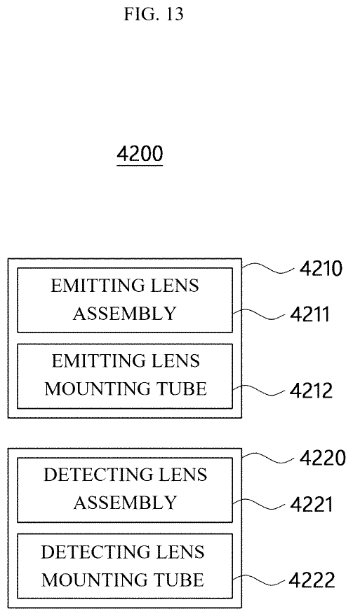

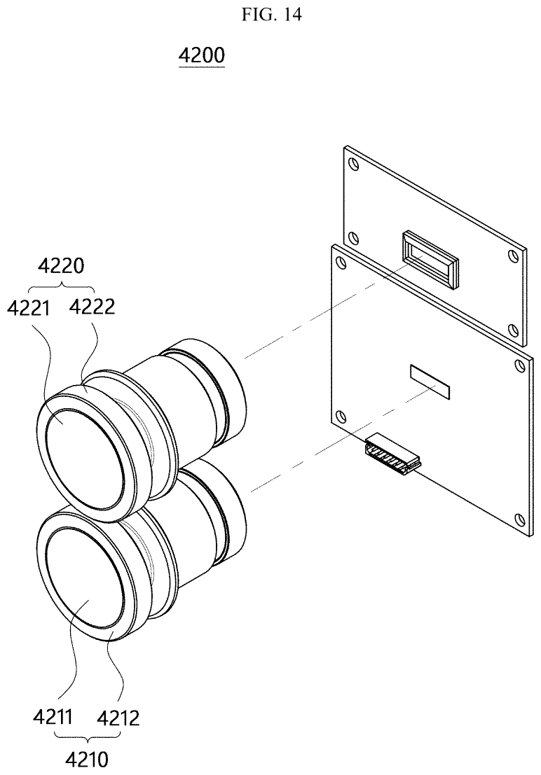

FIG. 13 and FIG. 14 are diagrams illustrating an emitting lens module and a detecting lens module according to an embodiment.

Referring to FIG. 13 and FIG. 14, a LiDAR device 4200 according to an embodiment may include an emitting lens module 4210 and a detecting lens module 4220.

Further, referring to FIG. 13 and FIG. 14, the emitting lens module 4210 according to an embodiment may include an emitting lens assembly 4211 and an emitting lens mounting tube 4212.

In this case, since the above descriptions can be applied to the emitting lens assembly 4211, repetitive descriptions are omitted.

The emitting lens assembly 4211 according to an embodiment may be disposed in the emitting lens mounting tube 4212.

Further, the emitting lens mounting tube 4212 may refer to a cylindrical tube surrounding the emitting lens assembly 4211, but is not limited thereto.

Further, referring to FIG. 13 and FIG. 14, the detecting lens module 4220 according to an embodiment may include a detecting lens assembly 4221 and a detecting lens mounting tube 4222.

In this case, since the above descriptions can be applied to the detecting lens assembly 4221, repetitive descriptions are omitted.

The detecting lens assembly 4221 according to an embodiment may be disposed in the detecting lens mounting tube 4222.

Further, the detecting lens mounting tube 4222 may refer to a cylindrical tube surrounding the detecting lens assembly 4221, but is not limited thereto.

Further, referring to FIG. 14, the emitting lens module 4210 may be disposed to be aligned with the laser emitting module described above.

In this case, the meaning that the emitting lens module 4210 is disposed to be aligned with the laser emitting module described above may include the meaning that it is disposed to have a preset relative physical positional relationship and the meaning that it is aligned to be able to emit a laser at an optically targeted angle, but is not limited thereto.

Further, referring to FIG. 14, the detecting lens module 4220 may be disposed to be aligned with the laser detecting module described above.

In this case, the meaning that the detecting lens module 4220 is disposed to be aligned with the laser detecting module described above may include the meaning that it is disposed to have a preset relative physical positional relationship and the meaning that it is aligned to be able to sense a laser that is received at an optically targeted angle, but is not limited thereto.

Further, FIG. 14 is a diagram illustrating an embodiment of the LiDAR device of FIG. 13, and the shapes shown in FIG. 14 do not limit the contents described in FIG. 13 and the present disclosure.

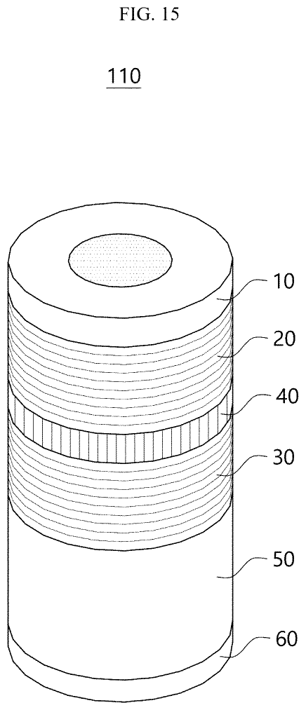

FIG. 15 is a diagram illustrating a laser emitting unit according to an embodiment.

Referring to FIG. 15, a laser emitting unit 100 according to an embodiment may include a VCSEL emitter 110.

The VCSEL emitter 110 according to an embodiment may include an upper metal contact 10, an upper Distributed Bragg reflector (DBR) layer 20, an active layer 40 (quantum well), a lower DBR layer 30, a substrate 50, and a lower metal contact 60.

Further, the VCSEL emitter 110 according to an embodiment may emit a laser beam vertically from its top surface. For example, the VCSEL emitter 110 can emit a laser beam in a direction perpendicular to the surface of the upper metal contact 10. Further, for example, the VCSEL emitter 110 can emit a laser beam perpendicularly to the active layer 40.

The VCSEL emitter 110 according to an embodiment may include an upper DBR layer 20 and a lower DBR layer 30.

The upper DBR layer 20 and the lower DBR layer 30 according to an embodiment may be composed of a plurality of reflective layers. For example, the plurality of reflective layers may include high-reflectivity reflective layers and low-reflectivity reflective layers alternately arranged. In this case, the thickness of the plurality of reflective layers may be one fourth of the wavelength of a laser emitted from the VCSEL emitter 110, but is not limited thereto.

Further, the upper DBR layer 20 and the lower DBR layer 30 according to an embodiment may be doped as p-type and n-type, respectively. For example, the upper DBR layer 20 may be doped as p-type and the lower DBR layer 30 may be doped as n-type. Alternatively, the upper DBR layer 20 may be doped as n-type and the lower DBR layer 30 may be doped as p-type.

Further, according to an embodiment, the substrate 50 may be disposed between the lower DBR layer 30 and the lower metal contact 60. When the lower DBR layer 30 is doped as p-type, the substrate 50 may be a p-type substrate, and when the lower DBR layer 30 is doped as n-type, the substrate 50 may also be an n-type substrate.

The VCSEL emitter 110 according to an embodiment may include the active layer 40.

The active layer 40 according to an embodiment may be disposed between the upper DBR layer 20 and the lower DBR layer 30.

The active layer 40 according to an embodiment may include a plurality of quantum wells generating a laser beam. The active layer 40 can emit a laser beam.

The VCSEL emitter 110 according to an embodiment may include a metal contact for electrical connection with a power source, etc. For example, the VCSEL emitter 110 may include the upper metal contact 10 and the lower metal contact 60.

Further, the VCSEL emitter 110 according to an embodiment may be electrically connected to the upper DBR layer 20 and the lower DBR layer 30 through a metal contact.

For example, when the upper DBR layer 20 is doped as p-type and the lower DBR layer 30 is doped as n-type, p-type power is supplied to the upper metal contact 10, so the upper metal contact 10 can be electrically connected to the upper DBR layer 20, and n-type power is supplied to the lower metal contact 60, so the lower metal contact 60 can be electrically connected to the lower DBR layer 30.

Further, for example, when the upper DBR layer 20 is doped as n-type and the lower DBR layer 30 is doped as p-type, n-type power is supplied to the upper metal contact 10, so the upper metal contact 10 can be electrically connected to the upper DBR layer 20, and p-type power is supplied to the lower metal contact 60, so the lower metal contact 60 can be electrically connected to the lower DBR layer 30.

The VCSEL emitter 110 according to an embodiment may include an oxidation area. The oxidation area may be disposed over the active layer.

The oxidation area according to an embodiment may be insulating. For example, the oxidation area may limit electrical flow. For example, the oxidation area may limit electrical connection.

Further, the oxidation area according to an embodiment may serve as an aperture. In detail, since the oxidation area is insulating, a beam generated from the active layer 40 can be emitted only from the portion other than the oxidation area.

A laser emitting unit according to an embodiment may include a plurality of VCSEL emitters 110.

Further, the laser emitting unit according to an embodiment can turn on the plurality of VCSEL emitters 110 at once or individually.

The laser emitting unit according to an embodiment can emit laser beams of various wavelengths. For example, the laser emitting unit may emit a laser beam with a wavelength of 905 nm. Further, for example, the laser emitting unit may emit a laser beam with a wavelength of 940 nm. Further, for example, the laser emitting unit may emit a laser beam with a wavelength of 1550 nm.

Further, the wavelength of the laser emitted from the laser emitting unit according to an embodiment may be changed by the surrounding environment. For example, the wavelength of the laser emitted from the laser emitting unit may increase as the temperature of the surrounding environment increases. Alternatively, the wavelength of the laser emitted from the laser emitting unit may decrease as the temperature of the surrounding environment decreases. The surrounding environment may include temperature, humidity, pressure, concentration of dust, ambient light level, altitude, gravity, acceleration, and the like, but is not limited thereto.

The laser emitting unit can emit a laser beam in a direction perpendicular to a supporting surface. Alternatively, the laser emitting unit can emit a laser beam in a direction perpendicular to the emission surface.

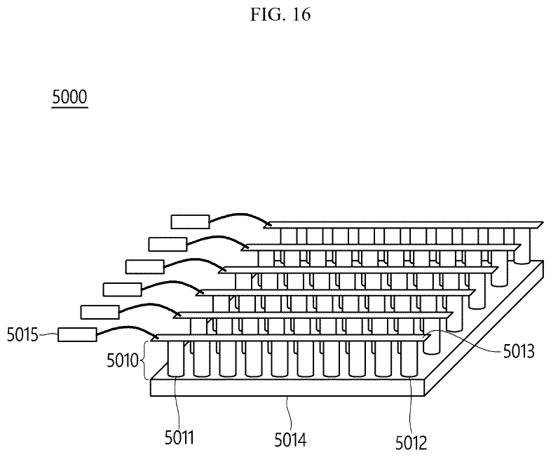

FIG. 16 is a diagram illustrating a laser emission array according to an embodiment.

Referring to FIG. 16, a laser emission array 5000 according to an embodiment may include a plurality of laser emission units, at least one subarray, at least one upper conductor, at least one lower conductor, and at least one power supply.

In this case, the at least one subarray may refer to a group of laser emission units operatively connected among the plurality of laser emission units, may refer to a group of laser emission units physically connected, may refer to a group of laser emission units connected to the same power supply, may refer to a group of laser emission units defined by the at least one upper conductor, and may refer to a group of laser emission units defined by a capacitor electrically connected to the at least one power supply, but is not limited thereto.

At least one subarray according to an embodiment may include a plurality of subarrays.

For example, at least one subarray according to an embodiment may include a plurality of subarrays including a first subarray 5010, but is not limited thereto.

At least one subarray according to an embodiment may include a plurality of laser emission units.

For example, the first subarray 5010 may include a plurality of laser emission units, but is not limited thereto.

To give a more specific example, the first subarray 5010 may include a first laser emission unit 5011 and a second laser emission unit 5012, but is not limited thereto.

Further, a plurality of laser emission units included in at least one subarray according to an embodiment may be connected to at least one upper conductor.

For example, a plurality of laser emission units included in the first subarray 5010 according to an embodiment may be connected to a first upper conductor 5013 through the upper metal contact, but is not limited thereto.

Further, for example, the first laser emission unit 5011 and the second laser emission unit 5012 included in the first subarray 5010 according to an embodiment may be connected to the first upper conductor 5013 through their respective upper metal contacts, but are not limited thereto.

Further, a plurality of laser emission units included in at least one subarray according to an embodiment may be connected to at least one lower conductor.

For example, a plurality of laser emission units included in at least one subarray according to an embodiment may be connected to a first lower conductor 5014 through the lower metal contact, but is not limited thereto.

Further, for example, the first laser emission unit 5011 and the second laser emission unit 5012 included in at least one subarray according to an embodiment may be connected to the first lower conductor 5014 through their respective lower metal contacts, but are not limited thereto.

Further, a plurality of laser emission units included in at least one subarray according to an embodiment may be supplied with energy from at least one power supply.

For example, the first laser emission unit 5011 and the second laser emission unit 5012 included in the first subarray 5010, which is included in at least one subarray according to an embodiment, may be connected to a first power supply 5015 through the first upper conductor 5013, whereby they can be supplied with energy from the first power supply 5015, but are not limited thereto.

For example, the first laser emission unit 5011 and the second laser emission unit 5012 included in the first subarray 5010, which is included in at least one subarray according to an embodiment, may be connected to the first power supply 5015 through the first lower conductor 5014, whereby they can be supplied with energy from the first power supply 5015, but are not limited thereto.

Further, a plurality of laser emission units included in at least one subarray according to an embodiment may receive a voltage applied from at least one power supply.

For example, the first laser emission unit 5011 and the second laser emission unit 5012 included in the first subarray 5010, which is included in at least one subarray according to an embodiment, may be connected to the first power supply 5015 through the first upper conductor 5013, whereby they can receive a voltage applied from the first power supply 5015, but are not limited thereto.

For example, the first laser emission unit 5011 and the second laser emission unit 5012 included in the first subarray 5010, which is included in at least one subarray according to an embodiment, may be connected to the first power supply 5015 through the first lower conductor 5014, whereby they can receive a voltage applied from the first power supply 5015, but are not limited thereto.

Further, the lengths of electrical paths between at least one laser emission unit included in at least one subarray according to an embodiment and at least one power supply may differ from each other.

For example, as shown in FIG. 16, the electrical path between the first laser emission unit 5011 included in the first subarray 5010 and the first power supply 5015 may be shorter than the electrical path between the second laser emission unit 5012 and the first power supply 5015, but the present disclosure is not limited thereto.

In this case, the electrical path may refer to a path along which current or electrons travel from the power supply to each laser emission unit, and may include a concept that can be understood as an electrical path by those skilled in the art.

Further, the above descriptions based on the first subarray 5010, etc., can be applied to other subarrays, etc., so repetitive descriptions are omitted.

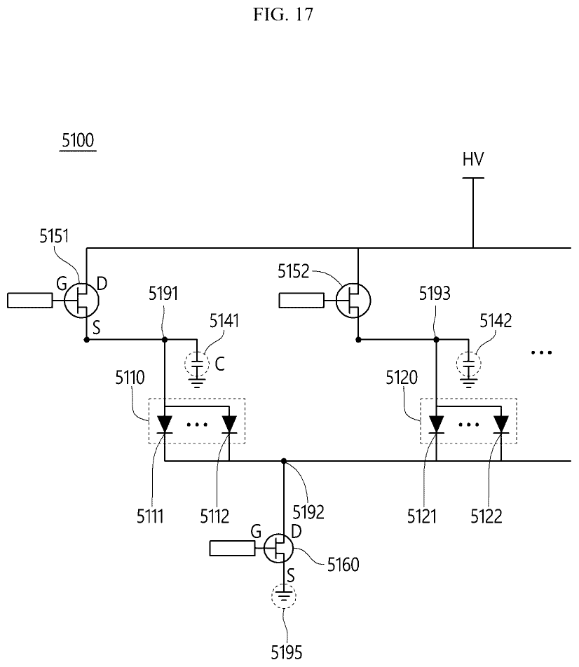

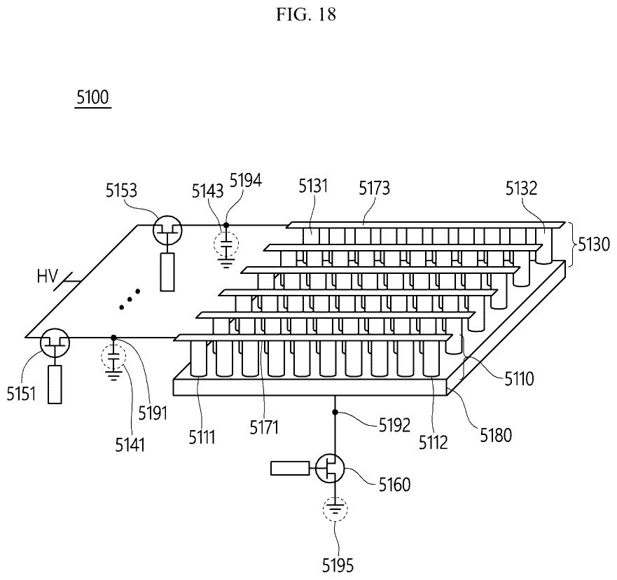

FIG. 17 and FIG. 18 are diagrams illustrating a laser emission array according to an embodiment.

Prior to describing FIG. 17 and FIG. 18, the corresponding description above can be applied to the components to be described with reference to FIG. 17 and FIG. 18, so repetitive descriptions are omitted.

Referring to FIG. 17, a laser emission array 5100 according to an embodiment may include a plurality of laser emission units, at least one subarray, at least one upper conductor, at least one lower conductor, at least one power supply, at least one switch, and at least one capacitor.

In this case, the at least one subarray may refer to a group of laser emission units operatively connected among the plurality of laser emission units, may refer to a group of laser emission units physically connected, may refer to a group of laser emission units connected to the same power supply, may refer to a group of laser emission units defined by the at least one upper conductor, and may refer to a group of laser emission units defined by a capacitor electrically connected to the at least one power supply, but is not limited thereto.

The laser emission array 5100 according to an embodiment may include a plurality of laser emission units.

For example, the laser emission array 5100 according to an embodiment may include a first laser emission unit 5111, a second laser emission unit 5112, a third laser emission unit 5121, a fourth laser emission unit 5122, a fifth laser emission unit 5131, and a sixth laser emission unit 5132, but is not limited thereto.

The laser emission array 5100 according to an embodiment may include a plurality of subarrays including at least one laser emission unit.

For example, the laser emission array 5100 according to an embodiment may include a first subarray 5110 including the first laser emission unit 5111 and the second laser emission unit 5112, a second subarray 5120 including the third laser emission unit 5121 and the fourth laser emission unit 5122, and a third subarray 5130 including the fifth laser emission unit 5131 and the sixth laser emission unit 5132, but is not limited thereto.

Further, a plurality of laser emission units included in the laser emission array 5100 according to an embodiment may be positioned between nodes having different voltages when each of the plurality of laser emission units emits a laser.

For example, the first laser emission unit 5111 included in the laser emission array 5100 according to an embodiment may be positioned between a first node 5191 and a second node 5192 having different voltages when the first laser emission unit 5111 emits a first laser, but the present disclosure is not limited thereto.

In this case, energy is supplied to the first laser emission unit 5111 by the voltage difference between the first node 5191 and the second node 5192, so the first laser can be emitted, but the present disclosure is not limited thereto.

Further, for example, the third laser emission unit 5121 included in the laser emission array 5100 according to an embodiment may be positioned between a third node 5193 and the second node 5192 having different voltages when the third laser emission unit 5121 emits a third laser, but the present disclosure is not limited thereto.

In this case, energy is supplied to the third laser emission unit 5121 by the voltage difference between the third node 5193 and the second node 5192, so the third laser can be emitted, but the present disclosure is not limited thereto.

Further, for example, the fifth laser emission unit 5131 included in the laser emission array 5100 according to an embodiment may be positioned between a fourth node 5194 and the second node 5192 having different voltages when the fifth laser emission unit 5131 emits a fifth laser, but the present disclosure is not limited thereto.

In this case, energy is supplied to the fifth laser emission unit 5121 by the voltage difference between the fourth node 5194 and the second node 5192, so the fifth laser can be emitted, but the present disclosure is not limited thereto.

Further, a plurality of laser emission units included in at least one subarray included in the laser emission array 5100 according to an embodiment may be positioned between the same nodes.

For example, the first laser emission unit 5111 and the second laser emission unit 5112 included in the first subarray 5110 may be positioned between the first node 5191 and the second node 5192, but they are not limited thereto.

For example, the third laser emission unit 5121 and the fourth laser emission unit 5122 included in the second subarray 5120 may be positioned between the third node 5193 and the second node 5192, but they are not limited thereto.

For example, the fifth laser emission unit 5131 and the sixth laser emission unit 5132 included in the third subarray 5130 may be positioned between the fourth node 5194 and the second node 5192, but they are not limited thereto.

Further, the laser emission array 5100 according to an embodiment may include at least one capacitor for supplying energy to at least one laser emission unit.

In this case, the energy that is supplied to the at least one laser emission unit may be represented as voltage, current, charge, or the like for convenience, and may be represented in various terms related to the energy required for laser emission from the at least one laser emission unit.

For example, the laser emission array 5100 according to an embodiment may include a first capacitor 5141, and the first capacitor 5141 can function to supply energy to the first laser emission unit 5111, but is not limited thereto.

Further, for example, the laser emission array 5100 according to an embodiment may include a second capacitor 5142, and the second capacitor 5142 can function to supply energy to the third laser emission unit 5121, but is not limited thereto.

Further, for example, the laser emission array 5100 according to an embodiment may include a third capacitor 5143, and the third capacitor 5143 can function to supply energy to the fifth laser emission unit 5131, but is not limited thereto.

Further, at least one capacitor included in the laser emission array 5100 according to an embodiment can function to supply energy to at least one subarray included in the laser emission array 5100.

For example, the first capacitor 5141 can function to supply energy to the first subarray 5110 including the first laser emission unit 5111 and the second laser emission unit 5112, but is not limited thereto.

Further, for example, the second capacitor 5142 can function to supply energy to the second subarray 5120 including the third laser emission unit 5121 and the fourth laser emission unit 5122, but is not limited thereto.

Further, for example, the third capacitor 5143 can function to supply energy to the third subarray 5130 including the fifth laser emission unit 5131 and the fifth laser emission unit 5132, but is not limited thereto.

Further, at least one capacitor included in the laser emission array 5100 according to an embodiment may be connected (coupled) to at least one node.

For example, the first capacitor 5141 may be connected to the first node 5191, but is not limited thereto.

Further, for example, the second capacitor 5142 may be connected to the third node 5193, but is not limited thereto.

Further, for example, the third capacitor 5143 may be connected to the fourth node 5194, but is not limited thereto.

Further, at least one capacitor included in the laser emission array 5100 according to an embodiment may be electrically connected to the upper conductor that is connected to the upper metal contact of each of a plurality of laser emission units included in at least one subarray.

For example, referring to FIG. 18, the first capacitor 5141 may be electrically connected to the first upper conductor 5171, which is connected to the upper metal contact of the first laser emission unit 5111 and the upper metal contact of the second laser emission unit 5112, but is not limited thereto.

Further, for example, referring to FIG. 18, the third capacitor 5143 may be electrically connected to the third upper conductor 5173, which is connected to the upper metal contact of the fifth laser emission unit 5131 and the upper metal contact of the sixth laser emission unit 5132, but is not limited thereto.

Further, the laser emission array 5100 according to an embodiment may include at least one power supply HV for charging the at least one capacitor.

For example, the laser emission array 5100 according to an embodiment may include a power supply HV for charging the first capacitor 5141, the second capacitor 5142, and the third capacitor 5143, but is not limited thereto.

In this case, the power supply HV may be provided as one, but is not limited thereto, and may be provided as multiple to charge one capacitor each, or may be provided as multiple to charge multiple capacitors each.

However, FIG. 17 and FIG. 18 are described on the basis of the laser emission array 5100 including one power supply for convenience of explanation, but this is only for convenience of explanation and does not limit the spirit of the present disclosure.

Further, at least one power supply HV included in the laser emission array 5100 according to an embodiment can function to charge the at least one capacitor through the node connected to the at least one capacitor.

For example, the power supply HV according to an embodiment can function to charge the first capacitor 5141 through the first node 5191, but is not limited thereto.

Further, for example, the power supply HV according to an embodiment can function to charge the second capacitor 5142 through the third node 5193, but is not limited thereto.

Further, for example, the power supply HV according to an embodiment can function to charge the third capacitor 5143 through the fourth node 5194, but is not limited thereto.

Further, the laser emission array 5100 according to an embodiment may include at least one charging switch for controlling charging of the at least one capacitor and a charging switch driver for controlling driving of the at least one charging switch.

In this case, the at least one charging switch may be implemented as a Field Effect Transistor (FET), but is not limited thereto.

For example, the laser emission array 5100 according to an embodiment may include a first charging switch 5151 for controlling charging of the first capacitor 5141 and a first charging switch driver for controlling driving of the first charging switch 5151, but is not limited thereto.

To give more specific example, the laser emission array 5100 according to an embodiment may include a first charging switch 5151 for controlling charging of the first capacitor 5141 and a first charging switch driver connected to a gate of the first charging switch 5151 to control a voltage that is applied, but is not limited thereto.

Further, for example, the laser emission array 5100 according to an embodiment may include a second charging switch 5152 for controlling charging of the second capacitor 5142 and a second charging switch driver for controlling driving of the second charging switch 5152, but is not limited thereto.

To give more specific example, the laser emission array 5100 according to an embodiment may include a second charging switch 5152 for controlling charging of the second capacitor 5142 and a second charging switch driver connected to a gate of the second charging switch 5152 to control a voltage that is applied, but is not limited thereto.

Further, for example, the laser emission array 5100 according to an embodiment may include a third charging switch 5153 for controlling charging of the third capacitor 5143 and a third charging switch driver for controlling driving of the third charging switch 5153, but is not limited thereto.

To give more specific example, the laser emission array 5100 according to an embodiment may include a third charging switch 5153 for controlling charging of the third capacitor 5143 and a third charging switch driver connected to a gate of the third charging switch 5153 to control a voltage that is applied, but is not limited thereto.

Further, at least one charging switch according to an embodiment may be positioned between the at least one power supply included in the laser emission array 5100 and the at least one capacitor.

For example, the first charging switch 5151 according to an embodiment may be positioned between the power supply HV and the first capacitor 5141, but is not limited thereto.

Further, for example, the second charging switch 5152 according to an embodiment may be positioned between the power supply HV and the second capacitor 5142, but is not limited thereto.

Further, for example, the third charging switch 5153 according to an embodiment may be positioned between the power supply HV and the third capacitor 5143, but is not limited thereto.

Further, at least one charging switch included in the laser emission array 5100 according to an embodiment may be connected (coupled) to at least one node.

For example, the first charging switch 5151 may be connected to the first node 5191, but is not limited thereto.

Further, for example, the second charging switch 5152 may be connected to the third node 5193, but is not limited thereto.

Further, for example, the third charging switch 5153 may be connected to the fourth node 5194, but is not limited thereto.

Further, the laser emission array 5100 according to an embodiment may include at least one common driving switch for controlling the driving of at least one laser emission unit and a common driving switch driver for controlling driving of the at least one common driving switch.

In this case, the at least one common driving switch may be implemented as a Field Effect Transistor (FET), but is not limited thereto.

For example, the laser emission array 5100 according to an embodiment may include a common driving switch 5160 for controlling driving of the first laser emission unit 5111 and a common driving switch driver for controlling driving of the common driving switch 5160, but is not limited thereto.

Further, the laser emission array 5100 according to an embodiment may include at least one common driving switch for controlling the driving of a plurality laser emission units included in at least one subarray and a common driving switch driver for controlling driving of the at least one common driving switch.

For example, the laser emission array 5100 according to an embodiment may include a common driving switch 5160 for controlling driving of the first laser emission unit 5111 and the second laser emission unit 5112 included in the first subarray 5110, and a common driving switch driver for controlling driving of the common driving switch 5160, but is not limited thereto.

Further, at least one common driving switch according to an embodiment may be positioned between at least one laser emission unit included in the laser emission array 5100 and a ground.

For example, the common driving switch 5160 according to an embodiment may be positioned between the first laser emission unit 5111 and a first ground 5195, but is not limited thereto.

Further, for example, the common driving switch 5160 according to an embodiment may be positioned between the third laser emission unit 5121 and the first ground 5195, but is not limited thereto.

Further, for example, the common driving switch 5160 according to an embodiment may be positioned between the fifth laser emission unit 5131 and the first ground 5195, but is not limited thereto.

Further, at least one common driving switch according to an embodiment may be positioned between a lower conductor connected to the lower metal of a plurality of laser emission units included in the laser emission array 5100 and a ground.

For example, the common driving switch 5160 according to an embodiment may be positioned between the lower conductor 5180 connected to the lower metal of each of the first to sixth laser emission units 5111 to 5132 included in the laser emission array 5100 and the first ground 5195, but is not limited thereto.

Further, at least one common driving switch included in the laser emission array 5100 according to an embodiment may be connected (coupled) to at least one node.

For example, the common driving switch 5160 may be connected to the second node 5192, but is not limited thereto.

Hereafter, the operation of the laser emission array having the configuration described above is described in more detail.

### [Laser Emission Operation of the First Laser Emission Unit 5111 and the Second Laser Emission Unit 5112 Included in the First Subarray 5110]

In a first charging sequence according to an embodiment, the first charging switch 5151 can be turned on.

For example, in the first charging sequence according to an embodiment, the first charging switch 5151 can be turned on by the operation of a first charging switch driver connected to the gate of the first charging switch 5151, but is not limited thereto.

Further, in the first charging sequence according to an embodiment, as the first charging switch 5151 is turned on, the first capacitor 5141 can be charged by the power supply HV.

For example, in the first charging sequence according to an embodiment, as the first charging switch 5151 is turned on, current can flow from the power supply HV to the first capacitor 5141 through the first charging switch 5151 and the first node 5191, whereby the first capacitor 5141 can be charged, but the present disclosure is not limited thereto.

Further, in the first charging sequence according to an embodiment, the common driving switch 5160 can be turned on.

For example, in the first charging sequence according to an embodiment, the common driving switch 5160 can be turned on by the operation of the common driving switch driver connected to the gate of the common driving switch 5160, but is not limited thereto.

Further, in the first driving sequence according to an embodiment, as the common driving switch 5160 is turned on, energy can be supplied to the first laser emission unit 5111 and the second laser emission unit 5112 included in the first subarray 5110 by the first capacitor 5141, whereby a first laser and a second laser can be emitted.

For example, in the first driving sequence according to an embodiment, as the common driving switch 5160 is turned on, the electric charges stored in the first capacitor 5141 are discharged, current can flow between the first capacitor 5141 and the first ground 5195, at least a portion of the current can generate light in the active area of the first laser emission unit 5111 by passing through the first laser emission unit 5111, another at least portion of the current can generate light in the active area of the second laser emission unit 5112 by passing through the second laser emission unit 5112, and the light generated from the first and second laser emission units 5111 and 5112 can be emitted from their respective surfaces, which can be represented as the third laser and the fourth laser, respectively, but the present disclosure is not limited thereto.

### [Laser Emission Operation of the Third Laser Emission Unit 5121 and the Fourth Laser Emission Unit 5122 Included in the Second Subarray 5120]

In a second charging sequence according to an embodiment, the second charging switch 5152 can be turned on.

For example, in the second charging sequence according to an embodiment, the second charging switch 5152 can be turned on by the operation of a second charging switch driver connected to the gate of the second charging switch 5152, but is not limited thereto.

Further, in the second charging sequence according to an embodiment, as the second charging switch 5152 is turned on, the second capacitor 5142 can be charged by the power supply HV.

For example, in the second charging sequence according to an embodiment, as the second charging switch 5152 is turned on, current can flow from the power supply HV to the second capacitor 5142 through the second charging switch 5152 and the third node 5193, whereby the second capacitor 5142 can be charged, but the present disclosure is not limited thereto.

Further, in the second charging sequence according to an embodiment, the common driving switch 5160 can be turned on.

For example, in the second charging sequence according to an embodiment, the common driving switch 5160 can be turned on by the operation of the common driving switch driver connected to the gate of the common driving switch 5160, but is not limited thereto.

Further, in the second driving sequence according to an embodiment, as the common driving switch 5160 is turned on, energy can be supplied to the third laser emission unit 5121 and the fourth laser emission unit 5122 included in the second subarray 5120 by the second capacitor 5142, whereby a third laser and a fourth laser can be emitted.

For example, in the second driving sequence according to an embodiment, as the common driving switch 5160 is turned on, the electric charges stored in the second capacitor 5142 are discharged, current can flow between the second capacitor 5142 and the first ground 5195, at least a portion of the current can generate light in the active area of the third laser emission unit 5121 by passing through the third laser emission unit 5111, another at least portion of the current can generate light in the active area of the fourth laser emission unit 5122 by passing through the fourth laser emission unit 5122, and the light generated from the third and fourth laser emission units 5121 and 5122 can be emitted from their respective surfaces, which can be represented as the third laser and the fourth laser, respectively, but the present disclosure is not limited thereto.

### [Laser Emission Operation of the Fifth Laser Emission Unit 5131 and the Sixth Laser Emission Unit 5132 Included in the Third Subarray 5130]

In a third charging sequence according to an embodiment, the third charging switch 5153 can be turned on.

For example, in the third charging sequence according to an embodiment, the third charging switch 5153 can be turned on by the operation of a third charging switch driver connected to the gate of the third charging switch 5153, but is not limited thereto.

Further, in the third charging sequence according to an embodiment, as the third charging switch 5153 is turned on, the third capacitor 5143 can be charged by the power supply HV.

For example, in the third charging sequence according to an embodiment, as the third charging switch 5153 is turned on, current can flow from the power supply HV to the third capacitor 5143 through the third charging switch 5152 and the fourth node 5194, whereby the third capacitor 5143 can be charged, but the present disclosure is not limited thereto.

Further, in the third charging sequence according to an embodiment, the common driving switch 5160 can be turned on.

For example, in the third charging sequence according to an embodiment, the common driving switch 5160 can be turned on by the operation of the common driving switch driver connected to the gate of the common driving switch 5160, but is not limited thereto.

Further, in the third driving sequence according to an embodiment, as the common driving switch 5160 is turned on, energy can be supplied to the fifth laser emission unit 5131 and the sixth laser emission unit 5132 included in the third subarray 5130 by the third capacitor 5143, whereby a fifth laser and a sixth laser can be emitted.

For example, in the third driving sequence according to an embodiment, as the common driving switch 5160 is turned on, the electric charges stored in the third capacitor 5143 are discharged, current can flow between the third capacitor 5143 and the first ground 5195, at least a portion of the current can generate light in the active area of the fifth laser emission unit 5131 by passing through the fifth laser emission unit 5131, another at least portion of the current can generate light in the active area of the sixth laser emission unit 5132 by passing through the sixth laser emission unit 5132, and the light generated from the fifth and sixth laser emission units 5131 and 5132 can be emitted from their respective surfaces, which can be represented as the fifth laser and the sixth laser, respectively, but the present disclosure is not limited thereto.

### [Selection of Laser Emission Channel (Subarray)]

As described above, in the case of a laser emission array that controls final laser emission using a common driving switch, like the laser emission array 5100 according to an embodiment, a laser emission channel (subarray from which a laser is emitted) may be selected by a capacitor that is charged.

For example, when the common driving switch 5160 is driven, if the first capacitor 5141 has been charged, the first subarray 5110 can be selected as a laser emission channel; when the common driving switch 5160 is driven, if the second capacitor 5142 has been charged, the second subarray 5120 may be selected as a laser emission channel; and when the common driving switch 5160 is driven, if the third capacitor 5143 has been charged, the third subarray 5130 may be selected as a laser emission channel. Depending on the intention, one capacitor may have been charged, or a plurality of capacitors may have been charged, but the present disclosure is not limited thereto.

This may ultimately mean that a channel can be selected depending on whether the capacitor connected to each subarray has been charged, and may also mean that independent control is possible for each operating unit (subarray).

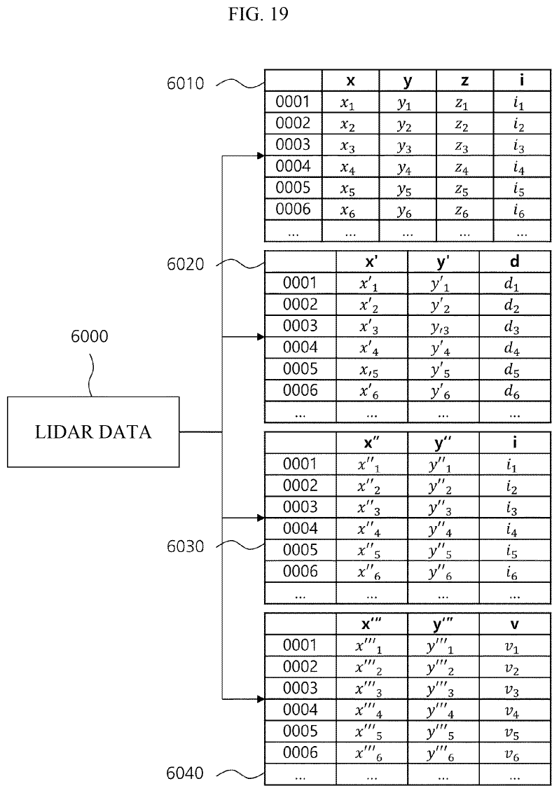

FIG. 19 is a diagram illustrating LiDAR data according to an embodiment.

Referring to FIG. 19, LiDAR data 6000 according to an embodiment may include at least one of point cloud data 6010, depth map data 6020, intensity map data 6030, and light capture map data 6040.

The depth map data 6020 according to an embodiment may be data for representing a distance value for the position of a two-dimensional pixel.

Further, the depth map data 6020 according to an embodiment may include at least one piece of point data.

In this case, the at least one piece of point data may include a pixel coordinate (x′, y′) and a distance value d corresponding to the pixel coordinate (x′, y′).

Further, the pixel coordinate (x′, y′) included in the depth map data 6020 according to an embodiment may correspond to a laser detecting unit.

For example, a first pixel coordinate included in the depth map data 6020 according to an embodiment may correspond to a first laser detecting unit, and a second pixel coordinate may correspond to a second laser detecting unit, but they are not limited thereto.

Further, a pixel coordinate (x′, y′) included in the depth map data 6020 according to an embodiment may correspond to the position of a laser detecting unit on a laser detecting array.

For example, when a first pixel coordinate included in the depth map data 6020 according to an embodiment corresponds to a first laser detecting unit and the first laser detecting unit is positioned at (1, 1) on a laser detecting array, the first pixel coordinate may be (1, 1), and when a second pixel coordinate corresponds to a second laser detecting unit and the second laser detecting unit is positioned at (1, 2) on the laser detecting array, the second pixel coordinate may be (1, 2), but they are not limited thereto.

Further, a distance value d included in the depth map data 6020 according to an embodiment may be obtained on the basis of a signal generated from a laser detecting unit.

For example, a first distance value corresponding to a first pixel coordinate may be obtained on the basis of a signal generated from a first laser detecting unit, and a second distance value corresponding to a second pixel coordinate may be obtained on the basis of a signal generated from a second laser detecting unit, but they are not limited thereto.

Further, for example, a first distance value corresponding to a first pixel coordinate may be obtained on the basis of first histogram data generated on the basis of a signal generated from a first laser detecting unit, and a second distance value corresponding to a second pixel coordinate may be obtained on the basis of second histogram data generated on the basis of a signal generated from a second laser detecting unit, but they are not limited thereto.

Further, the intensity map data 6030 according to an embodiment may be data for representing an intensity value for the position of a two-dimensional pixel.

Further, the intensity map data 6030 according to an embodiment may include at least one piece of point data.

In this case, the at least one piece of point data may include a pixel coordinate (x″, y″) and an intensity value i corresponding to the pixel coordinate (x″, y″).

Further, the pixel coordinate (x′, y′) included in the intensity map data 6030 according to an embodiment may correspond to a laser detecting unit.

For example, a first pixel coordinate included in the intensity map data 6030 according to an embodiment may correspond to a first laser detecting unit, and a second pixel coordinate may correspond to a second laser detecting unit, but they are not limited thereto.

Further, a pixel coordinate (x″, y″) included in the intensity map data 6030 according to an embodiment may correspond to the position of a laser detecting unit on a laser detecting array.

For example, when a first pixel coordinate included in the intensity map data 6030 according to an embodiment corresponds to a first laser detecting unit and the first laser detecting unit is positioned at (1, 1) on a laser detecting array, the first pixel coordinate may be (1, 1), and when a second pixel coordinate corresponds to a second laser detecting unit and the second laser detecting unit is positioned at (1, 2) on the laser detecting array, the second pixel coordinate may be (1, 2), but they are not limited thereto.

Further, an intensity value i included in the intensity map data 6030 according to an embodiment may be obtained on the basis of a signal generated from a laser detecting unit.

For example, a first intensity value corresponding to a first pixel coordinate may be obtained on the basis of a signal generated from a first laser detecting unit, and a second intensity value corresponding to a second pixel coordinate may be obtained on the basis of a signal generated from a second laser detecting unit, but they are not limited thereto.

Further, for example, a first intensity value corresponding to a first pixel coordinate may be obtained on the basis of first histogram data generated on the basis of a signal generated from a first laser detecting unit, and a second intensity value corresponding to a second pixel coordinate may be obtained on the basis of second histogram data generated on the basis of a signal generated from a second laser detecting unit, but they are not limited thereto.

Further, the light capture map data 6040 according to an embodiment may be data for representing a light capture value at a two-dimensional pixel position.

In this case, the light capture value is a value of light intensity obtained during a unit time, and may relate the number of photons obtained from a detecting unit during the unit time.

Further, the light capture value may be represented as an ambient value, etc. in accordance with an embodiment, and the light capture map data 6040 may be represented as ambient map data, etc.

This may mean that the light capture value reflects the number of photons due to external light, but is not limited thereto.

Further, the light capture map data 6040 according to an embodiment may include at least one piece of point data.

In this case, the at least one piece of point data may include a pixel coordinate (x′ “, y”) and a light capture value v corresponding to the pixel coordinate (x′″, y″).

Further, the pixel coordinate (x″, y″) included in the light capture map data 6040 according to an embodiment may correspond to a laser detecting unit.

For example, a first pixel coordinate included in the light capture map data 6040 according to an embodiment may correspond to a first laser detecting unit, and a second pixel coordinate may correspond to a second laser detecting unit, but they are not limited thereto.

Further, a pixel coordinate (x″, y″) included in the light capture map data 6040 according to an embodiment may correspond to the position of a laser detecting unit on a laser detecting array.

For example, when a first pixel coordinate included in the light capture map data 6040 according to an embodiment corresponds to a first laser detecting unit and the first laser detecting unit is positioned at (1, 1) on a laser detecting array, the first pixel coordinate may be (1, 1), and when a second pixel coordinate corresponds to a second laser detecting unit and the second laser detecting unit is positioned at (1, 2) on the laser detecting array, the second pixel coordinate may be (1, 2), but they are not limited thereto.

Further, a light capture value v included in the light capture map data 6040 according to an embodiment may be obtained on the basis of a signal generated from a laser detecting unit.

For example, a first light capture value corresponding to a first pixel coordinate may be obtained on the basis of a signal generated from a first laser detecting unit, and a second light capture value corresponding to a second pixel coordinate may be obtained on the basis of a signal generated from a second laser detecting unit, but they are not limited thereto.

Further, for example, a first light capture value corresponding to a first pixel coordinate may be obtained by summing counting values generated on the basis of signals generated from a first laser detecting unit during a unit time, and a second light capture value corresponding to a second pixel coordinate may be obtained by summing counting values generated on the basis of signals generated from a second laser detecting unit during the unit time, but they are not limited thereto.

Further, the point cloud data 6010 according to an example may be data for representing the position of a three-dimensional point or various values for the position of the three-dimensional point.

Further, the point cloud data 6010 according to an example may include at least one piece of point data.

In this case, the at least one piece of point data may include a position coordinate (x, y, z) and various values such as an intensity value i or a light capture value v corresponding to the position coordinate (x, y, z).

Further, the position coordinate (x, y, z) included in the point cloud data 6010 according to an embodiment may be obtained on the basis of a direction in which a laser is emitted and a distance value.

For example, when a distance value obtained by a laser emitted in a first direction is a first distance value, a first position coordinate may be obtained on the basis of the first direction and the first distance value, and when a distance value obtained by a laser emitted in a second direction is a second distance value, a second position coordinate may be obtained on the basis of the second direction and the second distance value, but they are not limited thereto.

Further, the position coordinate (x, y, z) included in the point cloud data 6010 according to an embodiment can be obtained on the basis of a pixel coordinate corresponding to a laser detecting unit and a distance value corresponding thereto.

For example, when a pixel coordinate corresponding to a first laser detecting unit is a first pixel coordinate and a distance value obtained on the basis of a signal generated from the first laser detecting unit is a first distance value, a first position coordinate may be obtained on the basis of the first pixel coordinate and the first distance value, and when a pixel coordinate included in a second laser detecting unit is a second pixel coordinate and a distance value obtained on the basis of a signal generated from the second laser detecting unit is a second distance value, a second position coordinate may be obtained on the basis of the second pixel coordinate and the second distance value, but they are not limited thereto.

Further, an intensity value i or a light capture value v included in the point cloud data 6010 according to an embodiment may be a value corresponding to a pixel coordinate that serves as a basis for obtaining a position coordinate.

For example, a first intensity value corresponding to a first position coordinate may be a first intensity value corresponding to a first pixel coordinate, and a second intensity value corresponding to a second position coordinate may be a second intensity value corresponding to a second pixel coordinate, but they are not limited thereto.

Further, according to an embodiment, pixel coordinates included in the depth map data 6020, the intensity map data 6030, and the light capture map data 6040, respectively, may be identical, but they are not limited thereto and may differ from each other.

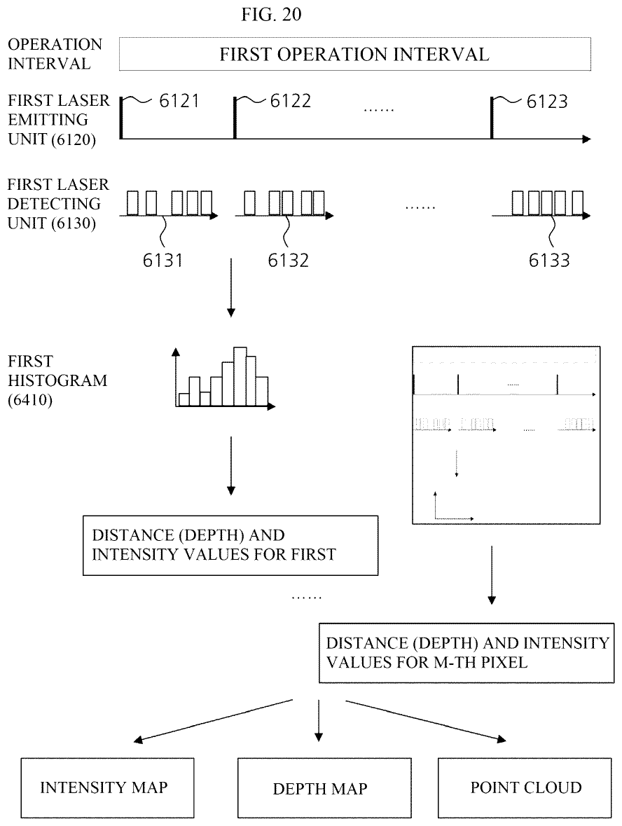

FIG. 20 is a diagram illustrating a method of obtaining detection values and LiDAR data according to an embodiment.

Referring to FIG. 20, an operation interval of a LiDAR device according to an embodiment may include a first operation interval 6110.

In this case, the operation interval of the LiDAR device according to an embodiment may refer to a time interval during which the LiDAR device performs a series of operations in order to obtain values for at least a part of point data included in LiDAR data according to an embodiment.

In the first operation interval 6110 of the LiDAR device according to an embodiment, a first laser emitting unit 6120 can emit a plurality of lasers.

For example, in the first operation interval 6110 of the LiDAR device according to an embodiment, the first laser emitting unit 6120 can emit a first laser 6121, a second laser 6122, and an N^{th} laser 6123, but is not limited thereto.

Further, in the first operation interval 6110 of the LiDAR device according to an embodiment, the first laser detecting unit 6130 can detect obtained light and generate at least one signal.

For example, in a first operation interval 6110 of the LiDAR device according to an embodiment, when a laser emitted from the first laser emitting unit 6120 is reflected from an object and delivered to the first laser detecting unit 6130, the first laser detecting unit 6130 can detect the laser emitted from the first laser emitting unit 6120 and reflected from the object, and generate a detection signal, but is not limited thereto.

Further, in the first operation interval 6110 of the LiDAR device according to an embodiment, the first laser detecting unit 6130 can detect light obtained in a plurality of detecting windows and generate at least one signal.

For example, in a first operation interval 6110 of the LiDAR device according to an embodiment, the first laser detecting unit 6130 can detect at least a portion of a first laser 6121 emitted from the first laser emitting unit 6120 in a first detecting window 6131 and generate a first detection signal, can detect at least a portion of a second laser 6122 emitted from the first laser emitting unit 6120 in a second detecting window 6132 and generates a second detection signal, and can detect at least a portion of an Nth laser 6123 emitted from the first laser emitting unit 6120 in an Nth detecting window 6133 and generates an Nth detection signal, but is not limited thereto.

In this configuration, the detecting window may be understood as an interval for detecting light obtained by a laser detecting unit according to an embodiment, but is not limited thereto.

Further, the first operation interval 6110 of the LiDAR device according to an embodiment can be represented as an operation interval for obtaining a distance value, an operation interval for obtaining an intensity value, an operation interval for obtaining both distance and intensity values, etc., but is not limited thereto.

Further, the LiDAR device according to an embodiment can generate at least one counting value on the basis of a signal generated from the first laser detecting unit 6130.

For example, the LiDAR device according to an embodiment can generate at least one counting value assigned to at least one time bin on the basis of a detection signal generated from the first laser detecting unit 6130 and the time at which the detection signal is generated in the first detecting window 6131, but is not limited thereto.

Further, for example, the LiDAR device according to an embodiment can generate at least one counting value assigned to at least one time bin on the basis of a detection signal generated from the first laser detecting unit 6130 and the time at which the detection signal is generated in the second detecting window 6132, but is not limited thereto.

Further, for example, the LiDAR device according to an embodiment can generate at least one counting value assigned to at least one time bin on the basis of a detection signal generated from the first laser detecting unit 6130 and the time at which the detection signal is generated in the Nth detecting window 6133, but is not limited thereto.

Further, the LiDAR device according to an embodiment can generate first histogram data 6140 on the basis of a detection signal generated from the first detecting unit 6130 in the first operation interval 6110.

Further, the LiDAR device according to an embodiment can generate first histogram data 6140 on the basis of detection signals generated from the first detecting unit 6130 in a plurality of detecting windows included in the first operation interval 6110.

For example, the LiDAR device according to an embodiment can generate first histogram data 6140 on the basis of at least one counting value generated on the basis of a detection signal generated from the first laser detecting unit 6130 in the first detecting window 6131, at least one counting value generated on the basis of a detection signal generated from the first laser detecting unit 6130 in the second detecting window 6132, and at least one counting value generated on the basis of a detection signal generated from the first laser detecting unit 6130 in the Nth detecting window 6132.

In this case, the first histogram data 6140 may be generated by an algorithm that accumulates counting values assigned to time bins, which are unit times for dividing each of a plurality of detecting windows, but is not limited thereto, and may be generated by various algorithms that can generally generate a histogram on the basis of signals generally obtained from a laser detecting unit.

Further, the LiDAR device according to an embodiment can generate at least one detection value on the basis of the first histogram data 6140, and the operation of generating the detection value may be implemented through at least one processor, but the present disclosure is not limited thereto.

For example, the LiDAR device according to an embodiment can generate a distance value for a first pixel on the basis of the first histogram data 6140, but is not limited thereto.

For example, the LiDAR device according to an embodiment can generate an intensity value for the first pixel on the basis of the first histogram data 6140, but is not limited thereto.

Further, the operation of generating the detection value according to an embodiment may be implemented by various algorithms.

For example, according to an embodiment, in order to generate a distance value for a first pixel on the basis of the first histogram data 6140, an algorithm that obtains a rising edge on the basis of a threshold value and generates a distance value on the basis of the rising edge may be used, but the present disclosure is not limited thereto and various algorithms for generating a distance value using histogram data may be used.

Further, for example, in order to generate an intensity value for a first pixel on the basis of the first histogram data 6140 according to an embodiment, an algorithm using pulse width, peak power, etc. may be used, but the present disclosure is not limited thereto, and various algorithms may be used to generate an intensity value using histogram data.

Further, the LiDAR device according to an embodiment may include a plurality of laser emitting units and a plurality of detecting units, and may generate detection values for a plurality of pixels on the basis of operations that can be understood as the operations of the first laser emitting unit 6120 and the second laser detecting unit 6130 described above.

For example, the LiDAR device according to an embodiment may include an Mth laser emitting unit and an Mth laser detecting unit, and can generate a distance value and an intensity value for an Mth pixel on the basis of the operations of the Mth laser emitting unit and the Mth laser detecting unit, but is not limited thereto.

Further, the LiDAR device according to an embodiment can obtain at least one piece of LiDAR data using the detection values for a plurality of pixels.

For example, the LiDAR device according to an embodiment can obtain a depth map using distance values for a plurality of pixels, but is not limited thereto.

Further, for example, the LiDAR device according to an embodiment can obtain an intensity map using intensity values for a plurality of pixels, but is not limited thereto.

Further, for example, the LiDAR device according to an embodiment can obtain a point cloud using distance values and intensity values for a plurality of pixels, but is not limited thereto.

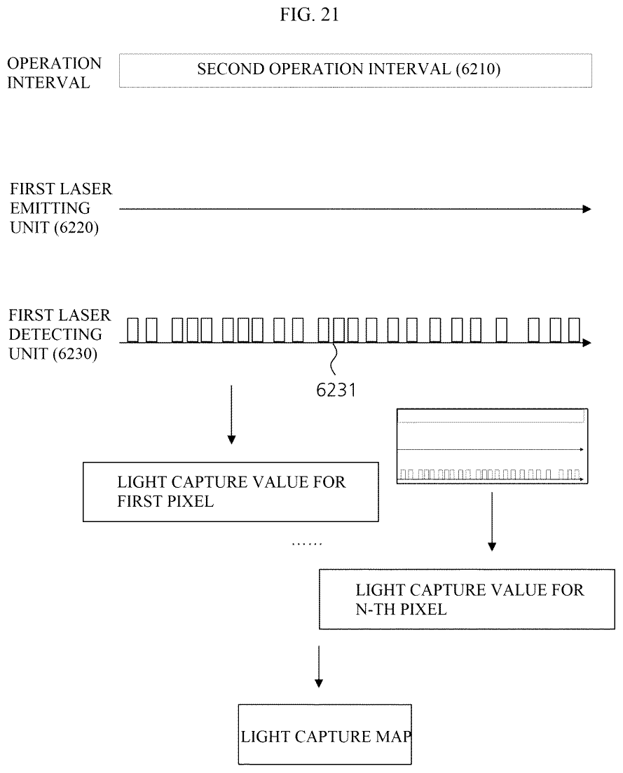

FIG. 21 is a diagram illustrating a method of obtaining detection values and LiDAR data according to an embodiment.

Referring to FIG. 21, an operation interval of a LiDAR device according to an embodiment may include a second operation interval 6210.

In this case, the operation interval of the LiDAR device according to an embodiment may refer to a time interval during which the LiDAR device performs a series of operations in order to obtain values for at least a part of point data included in LiDAR data according to an embodiment.

In the second operation interval 6210 of the LiDAR device according to an embodiment, the first laser emitting unit 6220 may not emit a laser, but is not limited thereto.

Further, in the second operation interval 6210 of the LiDAR device according to an embodiment, the first laser detecting unit 6230 can detect obtained light and generate at least one signal.

Further, in the second operation interval 6210 of the LiDAR device according to an embodiment, the first laser detecting unit 6230 can detect light external to the LiDAR device and generate at least one signal, but is not limited thereto.

Further, in the second operation interval 6210 of the LiDAR device according to an embodiment, the first laser detecting unit 6230 can detect light obtained during a detecting window and generate at least one signal.

For example, in the second operation interval 6210 of the LiDAR device according to an embodiment, the first laser detecting unit 6230 can detect external light obtained at a first time point during the detecting window 6231 and generate a first detection signal, and can detect external light obtained at a second time point and generate a second detection signal, but is not limited thereto.

In this configuration, the detecting window may be understood as an interval for detecting light obtained by a laser detecting unit according to an embodiment, but is not limited thereto.

Further, the second operation interval 6210 of the LiDAR device according to an embodiment may be expressed as an operation interval for obtaining light capture values, an operation interval for obtaining ambient values, or the like, but is not limited thereto.

Further, the LiDAR device according to an embodiment can generate at least one counting value on the basis of a signal generated from the first laser detecting unit 6230.

For example, the LiDAR device according to an embodiment can generate a first counting value on the basis of a first detection signal generated by detecting external light obtained at a first time point during the detecting window 6231, and can generate a second counting value on the basis of a second detection signal generated by detecting external light obtained at a second time point, but is not limited thereto.

Further, the LiDAR device according to an embodiment can generate at least one detection value on the basis of a detection signal generated from the first laser detecting unit 6230 in the second operation interval 6210, and the operation of generating the detection value may be implemented through at least one processor, but the present disclosure is not limited thereto.

For example, the LiDAR device according to an embodiment can generate a light capture value for a first pixel on the basis of a detection signal generated from the first laser detecting unit 6230 in the second operation interval 6210, but is not limited thereto.

Further, for example, the LiDAR device according to an embodiment can generate an ambient value for the first pixel on the basis of a detection signal generated from the first laser detecting unit 6230 in the second operation interval 6210, but is not limited thereto.

Further, for example, the LiDAR device according to an embodiment can generate a light capture value for the first pixel on the basis of at least one counting value generated on the basis of a detection signal generated from the first laser detecting unit 6230 in the second operation interval 6210, but is not limited thereto.

Further, for example, the LiDAR device according to an embodiment can generate an ambient value for the first pixel on the basis of at least one counting value generated on the basis of a detection signal generated from the first laser detecting unit 6230 in the second operation interval 6210, but is not limited thereto.

Further, the operation of generating the detection value according to an embodiment may be implemented by various algorithms.

For example, according to an embodiment, in order to generate a light capture value for a first pixel, an algorithm that adds at least one counting value generated on the basis of a signal generated from the first laser detecting unit 6230 may be used, but the present disclosure is not limited thereto.

Further, for example, according to an embodiment, in order to generate a light capture value for a first pixel, an algorithm that counts the number of signals generated from the first laser detecting unit 6230 may be used, but the present disclosure is not limited thereto.

Further, the LiDAR device according to an embodiment may include a plurality of laser emitting units and a plurality of laser detecting units, and may generate detection values for a plurality of pixels on the basis of operations that can be understood as the operations of the first laser emitting unit 6220 and the second laser detecting unit 6230 described above.

For example, the LiDAR device according to an embodiment may include an Mth laser emitting unit and an Mth laser detecting unit, and can generate a light capture value for an Mth pixel on the basis of the operations of the Mth laser emitting unit and the Mth laser detecting unit, but is not limited thereto.

Further, the LiDAR device according to an embodiment can obtain at least one piece of LiDAR data using the detection values for a plurality of pixels.

For example, the LiDAR device according to an embodiment can obtain a light capture map using light capture values for a plurality of pixels, but is not limited thereto.

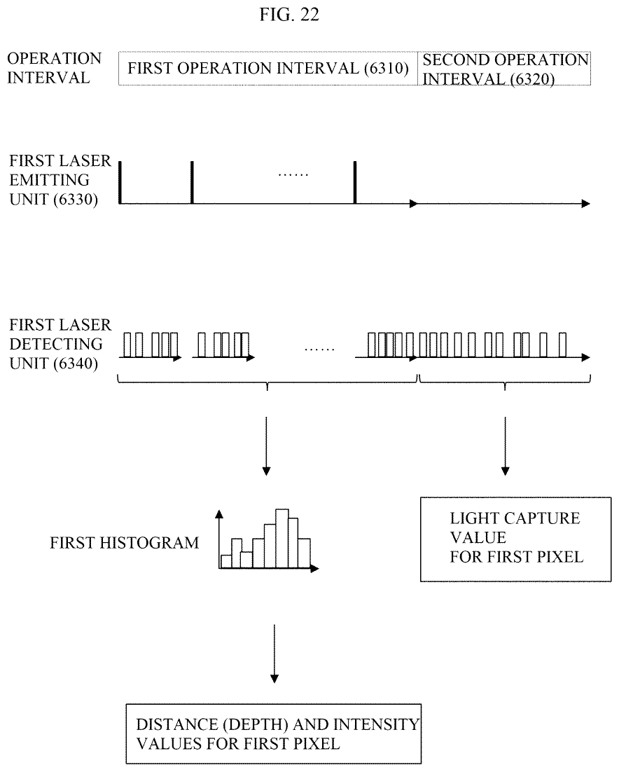

FIG. 22 is a diagram illustrating the operation interval of a LiDAR device according to an embodiment.

Referring to FIG. 22, the operation interval of a LiDAR device according to an embodiment may include a first operation interval 6310 and a second operation interval 6320.

In this case, the operation interval of the LiDAR device according to an embodiment may refer to a time interval during which the LiDAR device performs a series of operations in order to obtain values for at least a part of point data included in LiDAR data according to an embodiment.

Further, in this case, with respect to the first operation interval 6310 and the second operation interval 6320 according to an embodiment, the above descriptions regarding the first operation interval and the second operation interval may be applied, and thus redundant descriptions are omitted.

According to an embodiment, the first operation interval 6310 and the second operation interval 6320 of the LiDAR device may be temporally separated.

For example, the operation of the LiDAR device in the first operation interval 6310 of the LiDAR device according to an embodiment may be performed, and then, the operation of the LiDAR device in the second operation interval 6320 may be performed, but the present disclosure is not limited thereto.

Further, according to an embodiment, the first operation interval 6310 and the second operation interval 6320 of the LiDAR device may at least partially overlap in time.

For example, the second operation interval 6320 may be included in the first operation interval 6310 of the LiDAR device according to an embodiment, but is not limited thereto.

Further, according to an embodiment, the first operation interval 6310 and the second operation interval 6320 of the LiDAR device may be temporally the same.

For example, the operation of the LiDAR device performed in the first operation interval 6310 and the operation of the LiDAR device performed in the second operation interval 6320 may be performed during the same time interval, but the present disclosure is not limited thereto.

Further, according to an embodiment, the operation of the first laser emitting unit 6330 in the first operation interval 6310 of the LiDAR device may be different from the operation of the first laser emitting unit 6330 in the second operation interval 6320.

For example, in the first operation interval 6310 of the LiDAR device, the first laser emitting unit 6330 may emit a laser at a first cycle, and in the second operation interval 6320, the first laser emitting unit 6330 may not emit a laser, but the present disclosure is not limited thereto.

Further, according to an embodiment, the operation of the first laser detecting unit 6340 in the first operation interval 6310 of the LiDAR device may be different from the operation of the first laser detecting unit 6340 in the second operation interval 6320.

In this case, the operation of the first laser detecting unit 6340 may include a method of processing a detection signal obtained from the first laser detecting unit 6340, which is merely described by associating the method of processing a detection signal with the operation of a detecting unit for convenience of description.

For example, in the first operation interval 6310 of the LiDAR device, counting values generated on the basis of a plurality of detection signals obtained in a plurality of detection windows, respectively, may be assigned to a plurality of time bins, and in the second operation interval 6320, one detection value may be generated on the basis of the plurality of detection signals obtained in the detection windows, but the present disclosure is not limited thereto.

Further, for example, in the first operation interval 6310 of the LiDAR device, histogram data may be generated by accumulating counting values assigned to the same time bin, which is considered to have the same time from the laser emission time point, and in the second operation interval 6320, one detection value may be generated on the basis of a plurality of detection signals obtained in a detection window regardless of the laser emission time point, but the present is not limited thereto.

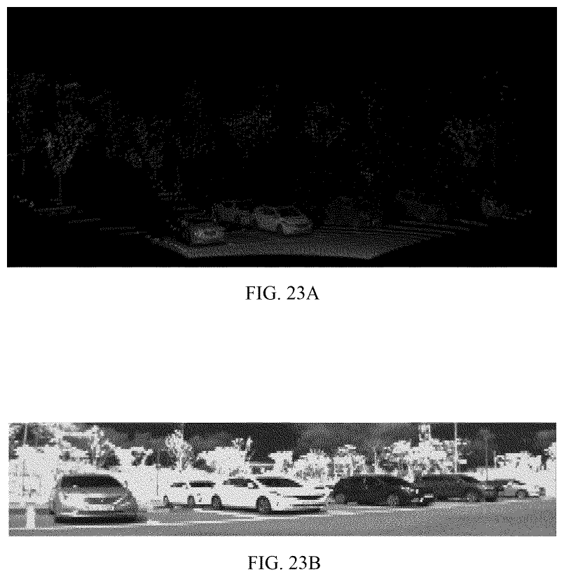

FIGS. 23A and 23B are an exemplary diagram of LiDAR data according to an embodiment.

In more detail, FIG. 23A is a diagram exemplarily illustrating point cloud data obtained on the basis of detection values for first to Mth pixels, which are obtained in accordance with the operation in the first operation interval described with reference to FIG. 20 and FIG. 22, and FIG. 23B is a diagram exemplarily illustrating light capture map data obtained on the basis of detection values for first to Mth pixels, which are obtained in accordance with the operation in the second operation interval described with reference to FIG. 21 and FIG. 22.

Referring to FIGS. 23A and 23B, the point cloud data according to an embodiment includes more specific information on three-dimensional spatial positions of a surrounding environment than the light capture map data according to an embodiment, and by using this, it is possible to more clearly detect three-dimensional spatial positional relationships of the surrounding environment.

Further, referring again to FIGS. 23A and 23B, light capture map data according to an embodiment may provide better visibility of the surrounding environment than point cloud data according to an embodiment.

That is, light capture map data according to an embodiment may be more similar to information obtained through human eyes than point cloud data according to an embodiment.

Therefore, since different LiDAR data obtained from different operation intervals of the LiDAR device may reflect different characteristics of the surrounding environment, it is possible to more clearly perceive the surrounding situation by appropriately using such different LiDAR data than by using only one piece of LiDAR data.

However, in the case of light capture map data according to an embodiment, the quality of the data that is obtained may vary depending on the intensity of external light.

For example, light capture map data according to an embodiment obtained during the daytime, when the intensity of external light is strong, may include more information about the surrounding environment than light capture map data according to an embodiment obtained at night, when the intensity of external light is weak.

Therefore, in order to reduce changes in the quality of LiDAR data in response to environmental changes or variations in recognition performance for surrounding situations, and to improve stability, it is necessary to obtain “enhanced light capture map data” whose quality is less affected by changes in external light intensity.

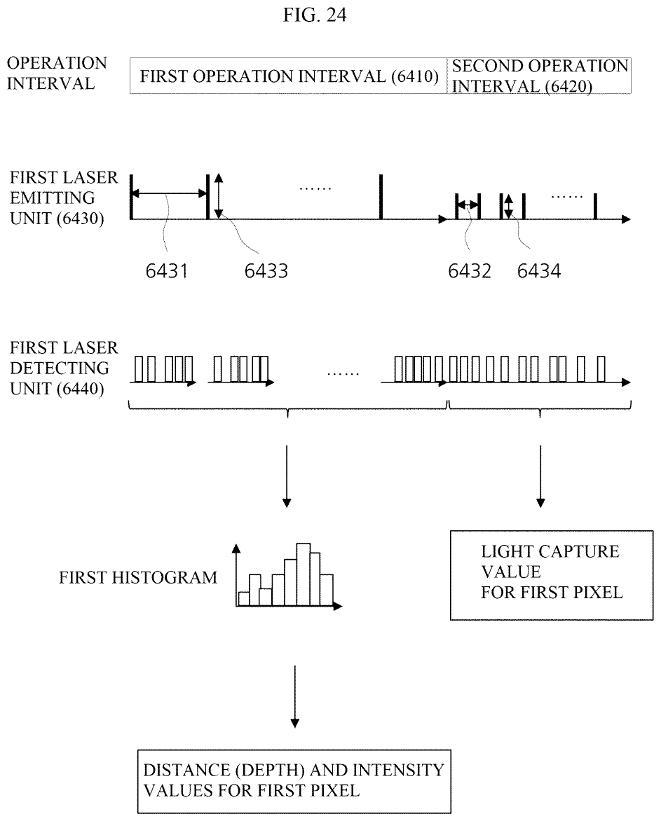

FIG. 24 is a diagram illustrating the operation of a LiDAR device for generating an enhanced light capture map according to an embodiment.

Referring to FIG. 24, the operation interval of a LiDAR device according to an embodiment may include a first operation interval 6410 and a second operation interval 6420.

In this case, the operation interval of the LiDAR device according to an embodiment may refer to a time interval during which the LiDAR device performs a series of operations in order to obtain values for at least a part of point data included in LiDAR data according to an embodiment.

Further, in this case, with respect to the first operation interval 6410 and the second operation interval 6420 according to an embodiment, the above descriptions regarding the first operation interval and the second operation interval may be applied, and thus redundant descriptions are omitted.

Further, according to an embodiment, in order to generate an enhanced light capture map, the operation of the first laser emitting unit in the second operation interval described with reference to FIG. 21 and FIG. 22 may differ, and hereafter, for convenience of description, this will be described in comparison with the operation of the first laser emitting unit in the first operation interval.

According to an embodiment, the operation of the first laser emitting unit 6430 in the first operation interval 6410 of an enhanced LiDAR device may differ from the operation of the first laser emitting unit 6430 in the second operation interval 6420.

For example, in the first operation interval 6310 of the LiDAR device, the first laser emitting unit 6330 can emit a laser at a first cycle 6431, and in the second operation interval 6320, the first laser emitting unit 6330 can emit a laser at a second cycle 6432, but is not limited thereto. In this case, the second cycle 6432 may be shorter than the first cycle 6431.

This is because the first operation interval 6410 of the LiDAR device is an operation interval for determining a time point at which a laser emitted at a specific time point is detected by the first laser detecting unit in a detecting window and determining a distance on the basis of the time point, whereas the second operation interval 6420 is an operation interval for determining the number, size, and the like of photons detected by the first laser detecting unit in a detecting window, and therefore, the interval between lasers emitted in the second operation interval 6420 are irrelevant to a detecting window.

Further, for example, for example, in the first operation interval 6410 of the LiDAR device, the first laser emitting unit 6430 can emit a laser at a first power 6433, and in the second operation interval 6420, the first laser emitting unit 6430 can emit a laser at a second power 6434, but is not limited thereto.

In this case, the second power 6434 may be lower than the first power 6433.

This is because the first operation interval 6410 of the LiDAR device is an operation interval for determining a time point at which a laser emitted at a specific time point is detected by the first laser detecting unit in a detecting window and determining a distance on the basis of the time point, whereas the second operation interval 6420 is an operation interval for determining the number, size, and the like of photons detected by the first laser detecting unit in a detecting window, and therefore, the power of the laser emitted in the second operation interval 6420 may not need to be as high as that of the laser emitted in the first operation interval 6410.

Further, this may be because, when the number of lasers emitted per unit time in the second operation interval 6420 is greater than the number of lasers emitted per unit time in the first operation interval 6410, the power of the lasers emitted in the second operation interval 6420 needs to be adjusted to satisfy eye-safety standards.

Further, for example, in the first operation interval 6310 of the LiDAR device, the first laser emitting unit 6330 can emit lasers having a first pulse width, and in the second operation interval 6320, the first laser emitting unit 6330 can emit lasers having a second pulse width, but is not limited thereto.

In this case, the second pulse width may be smaller than the first pulse width, but the present disclosure is not limited thereto.

Further, for example, the distribution of powers of a plurality of lasers emitted from the first laser emitting unit 6330 in the first operation interval 6310 of the LiDAR device may differ from the distribution of powers of a plurality of lasers emitted from the first laser emitting unit 6330 in the second operation interval 6320, but the present disclosure is not limited thereto.

In this case, the distribution of powers of the plurality of lasers emitted from the first laser emitting unit 6330 in the second operation interval 6320 may be greater than the distribution of powers of the plurality of lasers emitted from the first laser emitting unit 6330 in the first operation interval 6310, but the present disclosure is not limited thereto.

Hereafter, the operation of the laser emitting array for implementing the operation of a laser emitting unit described above is described in more detail.

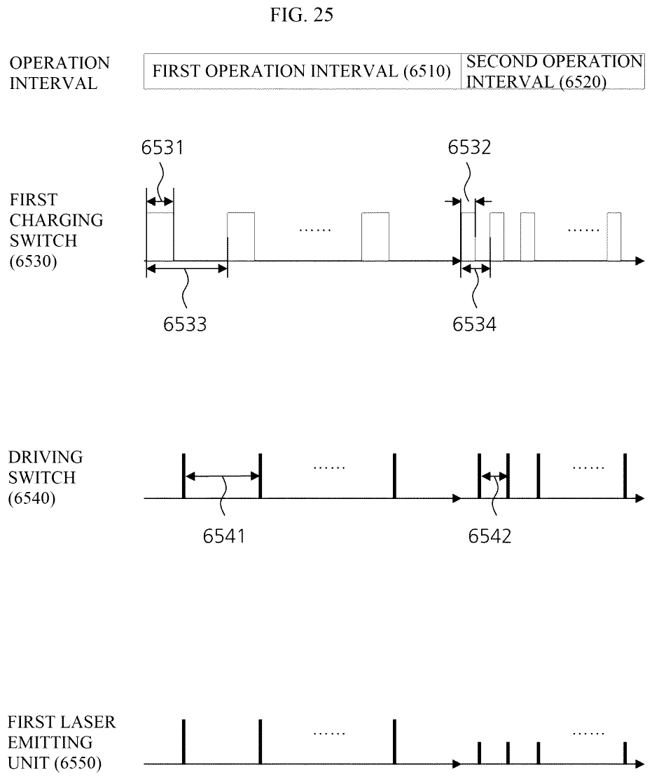

FIG. 25 is a diagram illustrating the operation of a laser emitting array according to an embodiment.

First, FIG. 25 will be described by using the configuration and operation of the laser emitting array described with reference to FIG. 17 and FIG. 18 for convenience of description, and for ease of understanding, the configurations of FIG. 17 and FIG. 18 may be referred to.

Specifically, FIG. 25 may be described on the basis of an embodiment in which the first laser emitting unit 6550 is supplied with energy by a first capacitor and emits a laser, a first charging switch 6530 is used to control charging of the first capacitor, and a driving switch 6540 is used to control the laser emission of the first laser emitting unit 6550.

Accordingly, regarding the first laser emitting unit 6550, the descriptions related to the laser emitting unit can be applied, regarding the first charging switch 6530, the descriptions related to the charging switch can be applied, and regarding the driving switch 6540, the descriptions related to the driving switch can be applied, and therefore, redundant descriptions are omitted.

Referring to FIG. 25, the operation interval of a LiDAR device according to an embodiment may include a first operation interval 6510 and a second operation interval 6520.

In this case, the operation interval of the LiDAR device according to an embodiment may refer to a time interval during which the LiDAR device performs a series of operations in order to obtain values for at least a part of point data included in LiDAR data according to an embodiment.

Further, in this case, with respect to the first operation interval 6510 and the second operation interval 6520 according to an embodiment, the above descriptions regarding the first operation interval and the second operation interval may be applied, and thus redundant descriptions are omitted.

According to an embodiment, a first charging switch 6530 may be driven to control charging of a first capacitor for supplying energy to a first laser emitting unit 6550 in the first operation interval 6510 and the second operation interval 6520.

Further, according to an embodiment, the time during which the first charging switch 6530 is driven in the first operation interval 6510 and the time during which the first charging switch 6530 is driven in the second operation interval 6520 may be controlled to be different from each other.

For example, the time during which the first charging switch 6530 is driven in the first operation interval 6510 may be controlled as a first time 6531, and the time during which the first charging switch 6530 is driven in the second operation interval 6520 may be controlled as a second time 6532, and the first time 6531 and the second time 6532 may be different from each other.

Further, for example, the second time 6532, which is the time during which the first charging switch 6530 is driven in the second operation interval 6520, may be controlled to be shorter than the first time 6531, which is the time during which the first charging switch 6530 is driven in the first operation interval 6510, but the present disclosure is not limited thereto.

Further, for example, the first time 6531, which is the time during which the first charging switch 6530 is driven in the first operation interval 6510, may be controlled to 800 ns, and the second time 6532, which is the time during which the first charging switch 6530 is driven in the second operation interval 6520, may be controlled to 16 ns, but the present disclosure is not limited thereto.

In this configuration, the second time 6532, which is the time during which the first charging switch 6530 is driven in the second operation interval 6520 of the LiDAR device, may be controlled as a multiple of 16 ns, such as 16 ns, 32 ns, or 256 ns, but is not limited thereto.

Further, according to an embodiment, the period during which the first charging switch 6530 is driven in the first operation interval 6510 of the LiDAR device may be different from the period during which the first charging switch 6530 is driven in the second operation interval 6520.

For example, the period during which the first charging switch 6530 is driven in the first operation interval 6510 of the LiDAR device may be a first period 6533, and the period during which the first charging switch 6530 is driven in the second operation interval 6520 may be a second period 6534, and the first period 6533 may be different from the second period 6534.

Further, for example, the second period 6534, which is the period during which the first charging switch 6530 is driven in the second operation interval 6520 of the LiDAR device, may be shorter than the first period 6533, which is the period during which the first charging switch 6530 is driven in the first operation interval 6510, but the present disclosure is not limited thereto.

Further, according to an embodiment, in the first operation interval 6510 and the second operation interval 6520, the driving switch 6540 may be driven so that a laser is emitted from the first laser emitting unit 6550.

Further, according to an embodiment, the time during which the driving switch 6540 is driven in the first operation interval 6510 and the time during which the driving switch 6540 is driven in the second operation interval 6520 may be controlled to be different from each other.

For example, the time during which the driving switch 6540 is driven in the first operation interval 6510 may be controlled to be a first time, and the time during which the driving switch 6540 is driven in the second operation interval 6520 may be controlled to be a second time, and the first time and the second time may be different from each other.

Further, for example, the second time, which is the time during which the driving switch 6540 is driven in the second operation interval 6520, may be controlled to be shorter than the first time, which is the time during which the driving switch 6540 is driven in the first operation interval 6510, but the present disclosure is not limited thereto.

Further, according to an embodiment, the period during which the driving switch 6540 is driven in the first operation interval 6510 may be different from the period during which the driving switch 6540 is driven in the second operation interval 6520.

For example, the period during which the driving switch 6540 is driven in the first operation interval 6510 of the LiDAR device may be a first period 6541, and the period during which the driving switch 6540 is driven in the second operation interval 6520 may be a second period 6542, and the first period 6533 may be different from the second period 6534.

Further, for example, the second period 6542, which is the period during which the driving switch 6540 is driven in the second operation interval 6520 of the LiDAR device, may be shorter than the first period 6541, which is the period during which the driving switch 6540 is driven in the first operation interval 6510, but the present disclosure is not limited thereto.

Further, according to an embodiment, a laser may be emitted from the first laser emitting unit 6550 in the first operation interval 6510 and the second operation interval 6520 of the LiDAR device, and since the above descriptions may be applied thereto, redundant descriptions are omitted.

Further, according to an embodiment, the number of times the first charging switch 6530 is driven, the number of times the driving switch 6540 is driven, and the number of times the first laser emitting unit 6550 emits a laser in the second operation interval 6520 of the LiDAR device may be preset numbers of times.

For example, according to an embodiment, the number of times the first charging switch 6530 is driven, the number of times the driving switch 6540 is driven, and the number of times the first laser emitting unit 6550 emits a laser in the second operation interval 6520 of the LiDAR device may be 52 times, but are not limited thereto.

Further, according to an embodiment, the number of times the first charging switch 6530 is driven, the number of times the driving switch 6540 is driven, and the number of times the first laser emitting unit 6550 emits a laser in the second operation interval 6520 of the LiDAR device may be changed, depending on time.

For example, according to an embodiment, the number of times the first charging switch 6530 is driven, the number of times the driving switch 6540 is driven, and the number of times the first laser emitting unit 6550 emits a laser in the second operation interval 6520 of the LiDAR device may be one time in the morning, 10 times in the afternoon, and 52 times in the evening, but are not limited thereto.

Further, according to an embodiment, the number of times the first charging switch 6530 is driven, the number of times the driving switch 6540 is driven, and the number of times the first laser emitting unit 6550 emits a laser in the second operation interval 6520 of the LiDAR device may be changed, depending the amount of external light.

For example, according to an embodiment, the number of times the first charging switch 6530 is driven, the number of times the driving switch 6540 is driven, and the number of times the first laser emitting unit 6550 emits a laser in the second operation interval 6520 of the LiDAR device may be 52 times when the amount of external light is at level 1, 10 times when the amount of external light is at level 2, and 1 time when the amount of external light is at level 3, but the present disclosure is not limited thereto.

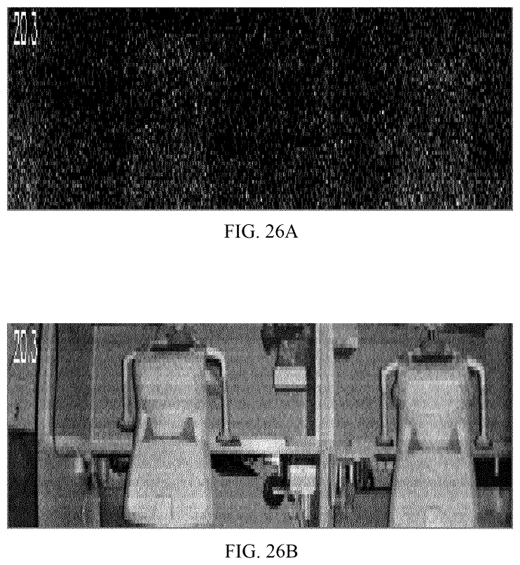

FIGS. 26A and 26B are an exemplary diagram of LiDAR data according to an embodiment.

In more detail, FIG. 26A is a diagram exemplarily illustrating light capture map data obtained on the basis of detection values for first to Mth pixels, which are obtained in accordance with the operation in the second operation interval described with reference to FIG. 21 and FIG. 22, and FIG. 26B is a diagram exemplarily illustrating enhanced light capture map data obtained in accordance with the operation in the second operation interval described with reference to FIG. 24 and FIG. 25.

In particular, FIGS. 26A and 26B are a diagram exemplarily illustrating light capture map data and enhanced light capture map data obtained when the intensity of external light is weak.

Referring to FIGS. 26A and 26B, it can be seen that the enhanced light capture map data may be data from which sufficient information is obtained even when the intensity of external light is weak.

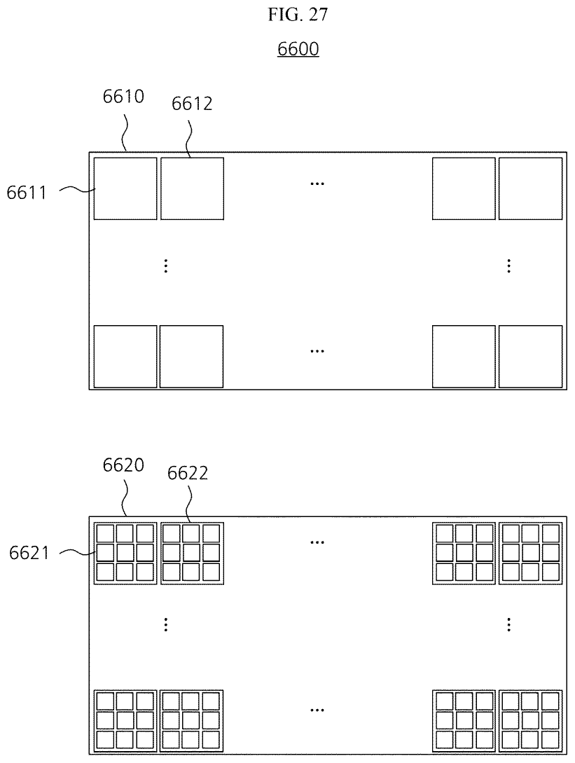

FIG. 27 is a diagram illustrating a laser emitting array and a laser detecting array included in a LiDAR device according to an embodiment.

Referring to FIG. 27, a LiDAR device 6600 according to an embodiment may include a laser emitting array 6610 and a laser detecting array 6620.

In this case, since the above descriptions can be applied to the laser emitting array 6610 and the laser detecting array 6620, redundant descriptions are omitted.

The laser emitting array 6610 according to an embodiment may include a plurality of laser emitting units.

For example, the laser emitting array 6610 according to an embodiment may include a first laser emitting unit 6611 and a second laser emitting unit 6612, but is not limited thereto.

Further, the laser emitting array 6610 according to an embodiment may be an array in which a plurality of laser emitting units is arranged in a two-dimensional matrix form.

For example, the laser emitting array 6610 according to an embodiment may be an array in which a plurality of laser emitting units is arranged in a two-dimensional matrix form having 56 rows and 192 columns, but is not limited thereto.

Further, the laser emitting array 6610 according to an embodiment may be an array in which a plurality of laser emitting elements is arranged in a two-dimensional matrix form.

For example, the laser emitting array 6610 according to an embodiment may be an array in which a plurality of laser emitting elements is arranged in a two-dimensional matrix form having 56 rows and 192 columns, but is not limited thereto.

Further, each of the plurality of laser emitting units included in the laser emitting array 6610 according to an embodiment may include at least one laser emitting element.

Further, the laser detecting array 6620 according to an embodiment may include a plurality of laser detecting units.

For example, the laser detecting array 6620 according to an embodiment may include a first laser detecting unit 6621 and a second laser detecting unit 6622, but is not limited thereto.

Further, the laser detecting array 6620 according to an embodiment may be an array in which a plurality of laser detecting units is arranged in a two-dimensional matrix form.

For example, the laser detecting array 6620 according to an embodiment may be an array in which a plurality of laser detecting units is arranged in a two-dimensional matrix form having 56 rows and 192 columns, but is not limited thereto.

Further, the laser detecting array 6620 according to an embodiment may be an array in which a plurality of laser detecting elements is arranged in a two-dimensional matrix form.

For example, the laser detecting array 6620 according to an embodiment may be an array in which a plurality of laser detecting elements is arranged in a two-dimensional matrix form having 168 rows and 576 columns, but is not limited thereto.

Further, each of the plurality of laser detecting units included in the laser detecting array 6620 according to an embodiment may include a plurality of laser detecting elements.

For example, as illustrated in FIG. 27, each of the first laser detecting unit 6621 and the second laser detecting unit 6622 according to an embodiment may include nine laser detecting elements, but the present disclosure is not limited thereto, and each of the first laser detecting unit 6621 and the second laser detecting unit 6622 may include two, three, four, five, six, seven, eight, or nine laser detecting elements.

Further, the plurality of laser detecting elements according to an embodiment may be referred to as sub-detecting units, depending on embodiments.

Further, the number of laser emitting elements included in each laser emitting unit according to an embodiment and the number of laser detecting elements included in each laser detecting unit may be different from each other.

For example, as illustrated in FIG. 27, the ratio of the number of laser emitting elements included in each laser emitting unit according to an embodiment to the number of laser detecting elements included in each laser detecting unit may be 1:9, but is not limited thereto and may be provided in various ratios such as 1:2, 1:3, 1:4, 1:5, 1:6, 1:7, 1:8, or 1:9.

Further, the laser detecting unit according to an embodiment may refer to a group of laser detecting elements for generating one distance value included in LiDAR data.

For example, the first laser detecting unit 6621 according to an embodiment may refer to a group of laser detecting elements for generating a first distance value included in depth map data, and the second laser detecting unit 6622 may refer to a group of laser detecting elements for generating a second distance value included in depth map data, but the present disclosure is not limited thereto.

Further, for example, the first laser detecting unit 6621 according to an embodiment may refer to a group of laser detecting elements for generating a first distance value that is used to generate a first position coordinate included in point cloud data, and the second laser detecting unit 6622 may refer to a group of laser detecting elements for generating a second distance value that is used to generate a second position coordinate included in point cloud data, but the present disclosure is not limited thereto.

Further, the laser detecting unit according to an embodiment may refer to a group of laser detecting elements for generating a detection value for a pixel coordinate.

For example, the first laser detecting unit 6621 according to an embodiment may refer to a group of laser detecting elements for generating a first detection value (a first distance value or a first intensity value) for a first pixel coordinate, and the second laser detecting unit 6622 may refer to a group of laser detecting elements for generating a second detection value (a second distance value or a second intensity value) for a second pixel coordinate, but the present disclosure is not limited thereto.

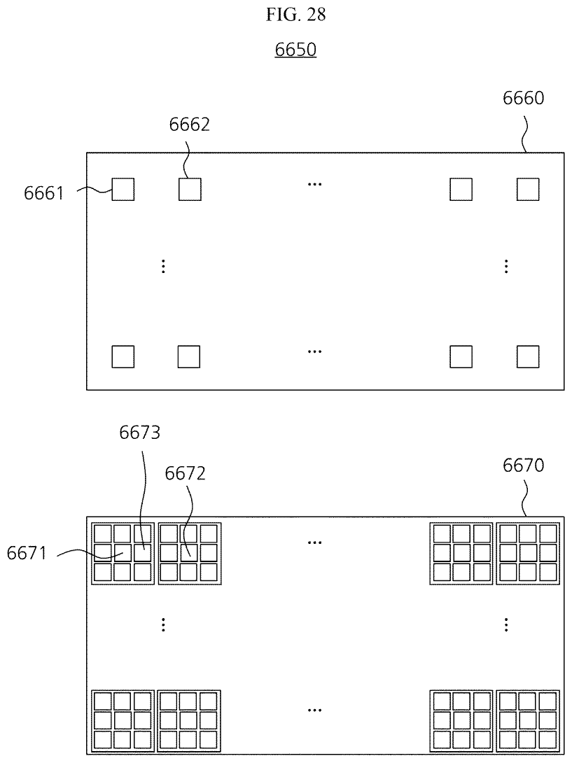

FIG. 28 is a diagram illustrating a laser emitting array and a laser detecting array included in a LiDAR device according to an embodiment.

Referring to FIG. 28, a LiDAR device 6650 according to an embodiment may include a transmission module and a reception module, in which the transmission module may include a laser emitting array 6660 and a transmission optic (not shown) and the reception module may include a laser detecting array 6670 and a reception optic (not shown).

In this case, since the above descriptions can be applied to the laser emitting array 6660 and the laser detecting array 6670, redundant descriptions are omitted.

Further, since the above descriptions can be applied to the transmission optic (not shown) and the reception optic (not shown), redundant descriptions are omitted.

The laser emitting array 6660 according to an embodiment may include a plurality of laser emitting units.

For example, the laser emitting array 6660 according to an embodiment may include a first laser emitting unit 6661 and a second laser emitting unit 6662, but is not limited thereto.

Further, the laser emitting array 6660 according to an embodiment may be an array in which a plurality of laser emitting units is arranged in a two-dimensional matrix form.

For example, the laser emitting array 6660 according to an embodiment may be an array in which a plurality of laser emitting units is arranged in a two-dimensional matrix form having 56 rows and 192 columns, but is not limited thereto.

Further, the laser emitting array 6660 according to an embodiment may be an array in which a plurality of laser emitting elements is arranged in a two-dimensional matrix form.

For example, the laser emitting array 6660 according to an embodiment may be an array in which a plurality of laser emitting elements is arranged in a two-dimensional matrix form having 56 rows and 192 columns, but is not limited thereto.

Further, each of the plurality of laser emitting units included in the laser emitting array 6660 according to an embodiment may include at least one laser emitting element.

For example, a first laser emitting unit 6661 included in the laser emitting array 6660 according to an embodiment may be composed of one laser emitting element or a plurality of laser emitting elements, and a second laser emitting unit 6662 may be composed of one laser emitting element or a plurality of laser emitting elements, but the present disclosure is not limited thereto.

Further, a transmission optic (not shown) according to an embodiment can collimate a laser emitted from the laser emitting array 6660.

For example, the transmission optic (not shown) can change divergence of a first laser emitted from the laser emitting array 6660 by collimating the first laser, but is not limited thereto.

Further, the transmission optic (not shown) according to an embodiment can steer a laser emitted from the laser emitting array 6660.

For example, the transmission optic (not shown) can steer a first laser emitted from the first laser emitting unit 6661 included in the laser emitting array 6660 in a first direction and can steer a second laser emitted from the second laser emitting unit 6662 included in the laser emitting array 6660 in a second direction, but is not limited thereto.

Further, according to an embodiment, a plurality of lasers emitted from the laser emitting array 6660 and steered by the transmission optic (not shown) may be discrete from each other.

For example, a first laser emitted from the first laser emitting unit 6661 included in the laser emitting array 6660 and steered by the transmission optic (not shown) and a second laser emitted from the second laser emitting unit 6662 and steered by the transmission optic (not shown) may be discrete from each other, but the present disclosure is not limited thereto.

Further, the laser detecting array 6670 according to an embodiment may include a plurality of laser detecting units.

For example, the laser detecting array 6670 according to an embodiment may include a first laser detecting unit 6671 and a second laser detecting unit 6672, but is not limited thereto.

Further, when a laser emitted from the laser emitting array 6660 is reflected from an object, a reception optic (not shown) according to an embodiment can deliver the laser reflected from the object to the laser detecting array 6670.

Further, the LiDAR device 6650 according to an embodiment may be designed such that at least one laser emitting unit and at least one laser detecting unit are optically coupled to each other.

In this case, the fact that the laser emitting unit and the laser detecting unit are optically coupled to each other may mean that when a laser emitted from the laser emitting unit is reflected from an object, it is detected by the laser detecting unit.

For example, according to an embodiment, when a first laser emitted from the first laser emitting unit 6661 is reflected from an object, it is detected by the first laser detecting unit 6671, and when a second laser emitted from the second laser emitting unit 6662 is reflected from an object, it is detected by the second laser detecting unit 6672, and in this case the first laser emitting unit 6661 and the first laser detecting unit 6671 may be described as being optically coupled, and the second laser emitting unit 6662 and the second laser detecting unit 6672 may be described as being optically coupled, but the present disclosure is not limited thereto.

Further, the transmission module and the reception module according to an embodiment may be aligned such that at least one laser emitting unit and at least one laser detecting unit are optically coupled with each other.

For example, according to an embodiment, the laser emitting array 6660 and the transmission optic (not shown) may be aligned such that a first laser emitted from the first laser emitting unit 6661 is directed in a first direction through the transmission optic (not shown), and the laser detecting array 6670 and the reception optic (not shown) may be aligned such that, when the first laser emitted in the first direction is reflected from an object, it is delivered to the first laser detecting unit 6671 through the reception optic (not shown).

Further, in this case, a second laser emitted from the second laser emitting unit 6662 positioned adjacent to the first laser emitting unit 6661 may be directed in a second direction different from the first direction through the transmission optic (not shown), and when the second laser is reflected from the object, it may be delivered to a region different from the region where the first laser detecting unit 6671 is disposed, through the reception optic.

Accordingly, in this case, the second laser detecting unit 6672 included in the laser detecting array 6670 may have to be disposed to be optically coupled with the second laser emitting unit 6662, and to this end, the distance between the second laser detecting unit 6672 and the first laser detecting unit 6671 may be determined such that the second laser detecting unit 6672 is optically coupled with the second laser emitting unit 6662.

That is, according to an embodiment, the laser emitting array 6660 and the transmission optic need to be designed such that lasers emitted from a plurality of laser emitting units included in the laser emitting array 6660 are directed in different directions, and the laser detecting array 6670 and the reception optic need to be designed such that at least one laser emitting unit and at least one laser detecting unit are optically coupled. In this case, the distance between two laser detecting units may be determined such that two adjacent laser emitting units are optically coupled with two laser detecting units, respectively.

Accordingly, the distance between laser detecting units that are optically coupled with respective ones of a plurality of laser emitting units can only be determined on the basis of the arrangement of the plurality of laser emitting units, optical characteristics of the transmission optic (not shown), and optical characteristics of the reception optic (not shown), and accordingly, there may be a physical limitation in improving resolution in a solid-state LiDAR.

In this configuration, according to an embodiment, the laser detecting array 6670 may further include at least one ambient detecting unit.

For example, according to an embodiment, the laser detecting array 6670 may further include a first ambient detecting unit 6673 that is disposed between the first laser detecting unit 6671 and the second laser detecting unit 6672.

Further, in this configuration, the at least one ambient detecting unit according to an embodiment may output at least one detection signal, and at least one light capture value may be generated on the basis of the at least one detection signal output from the at least one ambient detecting unit, but the present disclosure is not limited thereto.

Further, in this configuration, the at least one ambient detecting unit according to an embodiment may be arranged not to be optically coupled with the plurality of laser emitting units included in the laser emitting array 6660.

For example, the first ambient detecting unit 6673 according to an embodiment may be arranged not to be optically coupled with the first laser emitting unit 6661 and the second laser emitting unit 6662, but is not limited thereto.

Further, in this configuration, the at least one ambient detecting unit according to an embodiment may be arranged to be optically coupled with at least one laser emitting unit included in the laser emitting array 6660.

For example, the first ambient detecting unit 6673 according to an embodiment may be arranged to be optically coupled with the first laser emitting unit 6661, but is not limited thereto.

Further, in this configuration, the distance between the center of the first laser emitting unit 6661 and the center of the second laser emitting unit 6662 according to an embodiment may be equal to the distance between the center of the first laser detecting unit 6671 and the center of the second laser detecting unit 6672, but the present disclosure is not limited thereto.

Further, in this configuration, the optical characteristics of the transmission optic (not shown) and the reception optic (not shown) according to an embodiment may be the same, but the present disclosure not limited thereto.

Further, in this configuration, the distance between the center of the first laser detecting unit 6671 and the center of the first ambient detecting unit 6673 according to an embodiment may be smaller than the distance between the center of the first laser emitting unit 6661 and the center of the second laser emitting unit 6662, but the present disclosure is not limited thereto.

Further, in this configuration, the first and second laser detecting units 6671 and 6672 and the first ambient detecting unit 6673 according to an embodiment may be implemented using the same detecting element, but the present disclosure is not limited thereto.

Further, in this configuration, the first and second laser detecting units 6671 and 6672 and the first ambient detecting unit 6673 according to an embodiment may implemented as SPADs (Single Photon Avalanche Diodes), but the present disclosure is not limited thereto.

Further, in this configuration, the number of the detecting elements included in the laser detecting array 6670 may be greater than the number of the laser emitting elements included in the laser emitting array 6660, but the present disclosure is not limited thereto.

Further, in this configuration, at least one ambient detecting unit according to an embodiment may perform the function of the sub-detecting unit described above, but the present disclosure is not limited thereto.

Further, when at least one ambient detecting unit that can be arranged regardless of whether it is optically coupled with the laser emitting units is included in the laser detecting array 6670, as described above, there is a possibility to obtain LiDAR data such as a light capture map and an ambient map of which the resolution is physically improved, so LiDAR data such as a depth map and a point cloud with improved resolution can be obtained through algorithms to be described below, and detailed descriptions thereof are provided below.

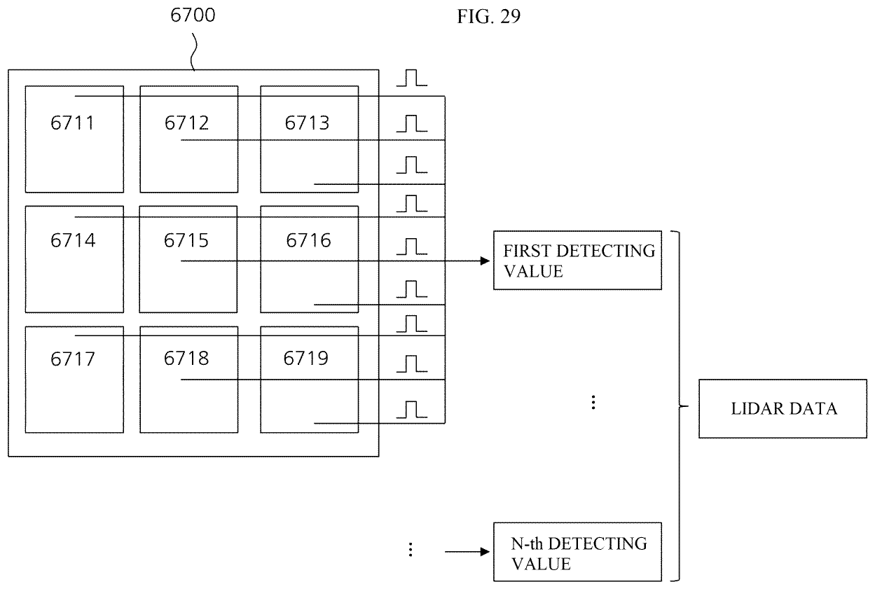

FIG. 29 is a diagram illustrating a laser detecting unit and detection values according to an embodiment.

Before describing FIG. 29, the laser detecting unit 6700 illustrated in FIG. 29 may be included in a laser detecting array included in a LiDAR device.

Referring to FIG. 29, the laser detecting unit 6700 according to an embodiment may include a plurality of sub-detecting units.

For example, the laser detecting unit 6700 according to an embodiment may include a first sub-detecting unit 6711, a second sub-detecting unit 6712, a third sub-detecting unit 6713, a fourth sub-detecting unit 6714, a fifth sub-detecting unit 6715, a sixth sub-detecting unit 6716, a seventh sub-detecting unit 6717, an eighth sub-detecting unit 6718, and a ninth sub-detecting unit 6719, but the present disclosure is not limited thereto.

In this configuration, the sub-detecting units according to an embodiment can be understood as laser detecting elements included in a laser detecting unit and can be understood as unit components that are included in a laser detecting unit and output detection signals, but are not limited thereto.

Each of the plurality of sub-detecting units according to an embodiment can detect light and output a detection signal.

For example, the first sub-detecting unit 6711 according to an embodiment can detect light and output a first detection signal, the second sub-detecting unit 6712 can detect light and output a second detection signal, the third sub-detecting unit 6713 can detect light and output a third detection signal, the fourth sub-detecting unit 6714 can detect light and output a fourth detection signal, the fifth sub-detecting unit 6715 can detect light and output a fifth detection signal, the sixth sub-detecting unit 6716 can detect light and output a sixth detection signal, the seventh sub-detecting unit 6717 can detect light and output a seventh detection signal, the eighth sub-detecting unit 6718 can detect light and output an eighth detection signal, and the ninth sub-detecting unit 6719 can detect light and output a ninth detection signal.

Further, according to an embodiment, a detection value may be generated on the basis of detection signals output from a plurality of sub-detecting units included in a laser detecting unit, respectively.

For example, according to an embodiment, a first detection value may be generated on the basis of detection signals output from the first to ninth sub-detecting units 6711 to 6719 included in the laser detecting unit 6700, but the present disclosure is not limited thereto.

In this case, the first detection value may be a distance value or an intensity value.

Further, in this case, regarding generating a distance value or an intensity value on the basis of a detection signal, the above descriptions can be applied, so redundant descriptions are omitted.

Further, according to an embodiment, a detection value for one pixel coordinate may be generated on the basis of a detection signal output from a laser detecting unit.

For example, according to an embodiment, a first detection value for a first pixel coordinate may be generated on the basis of detection signals output from the first to ninth sub-detecting units 6711 to 6719 included in the laser detecting unit 6700, but the present disclosure is not limited thereto.

Further, according to an embodiment, the above descriptions can be applied to each of a plurality of laser detecting units included in a laser detecting array included in a LiDAR device.

Further, according to an embodiment, a plurality of detection values may be generated on the basis of detection signals output respectively from a plurality of laser detecting units included in a laser detecting array included in a LiDAR device.

For example, when a laser detecting array included in a LiDAR device according to an embodiment includes 10,752 laser detecting units, 10,752 distance values for respective 10,752 pixel coordinates may be generated on the basis of detection signals output from the 10,752 laser detecting units, respectively, but the present disclosure is not limited thereto.

Further, when a laser detecting array included in a LiDAR device according to an embodiment includes 10,752 laser detecting units, 10,752 intensity values for respective 10,752 pixel coordinates may be generated on the basis of detection signals output from the 10,752 laser detecting units, respectively, but the present disclosure is not limited thereto.

Further, for example, when a plurality of laser detecting units according to an embodiment is arranged in a matrix form having 56 rows and 192 columns, distance values or intensity values for respective 10,752 pixel coordinates may be generated on the basis of detection signals output from 10,752 laser detecting units, respectively, but the present disclosure is not limited thereto.

Further, according to an embodiment, LiDAR data may be generated on the basis of a plurality of detection values.

For example, according to an embodiment, depth map data may be generated on the basis of a plurality of detection values generated on the basis of detection signals output from a plurality of laser detecting units, but the present disclosure is not limited thereto.

Further, for example, according to an embodiment, intensity map data may be generated on the basis of a plurality of detection values generated on the basis of detection signals output from a plurality of laser detecting units, but the present disclosure is not limited thereto.

Further, for example, according to an embodiment, point cloud data may be generated on the basis of a plurality of detection values generated on the basis of detection signals output from a plurality of laser detecting units, but the present disclosure is not limited thereto.

Further, according to an embodiment, generated LiDAR data may include point data corresponding to the number of a plurality of laser detecting units.

For example, when a laser detecting array included in a LiDAR device according to an embodiment includes 10,752 laser detecting units, depth map data generated in accordance with an embodiment may include 10,752 point data, and in this case, each of the point data may include a pixel coordinate and a corresponding distance value, but the present disclosure is not limited thereto.

Further, for example, when a laser detecting array included in a LiDAR device according to an embodiment includes 10,752 laser detecting units, intensity map data generated in accordance with an embodiment may include 10,752 point data, and in this case, each of the point data may include a pixel coordinate and a corresponding intensity value, but the present disclosure is not limited thereto.

Further, for example, when a laser detecting array included in a LiDAR device according to an embodiment includes 10,752 laser detecting units, point cloud data generated in accordance with an embodiment may include 10,752 point data, and in this case, each of the point data may include a pixel coordinate, but the present disclosure is not limited thereto.

Further, according to an embodiment, generated LiDAR data may have a resolution corresponding to the arrangement of a plurality of laser detecting units.

For example, when a plurality of laser detecting units according to an embodiment is arranged in a matrix form having 56 rows and 192 columns, the resolution of depth map data generated in accordance with an embodiment may be 192× 56 pixels, but the present disclosure is not limited thereto.

For example, when a plurality of laser detecting units according to an embodiment is arranged in a matrix form having 56 rows and 192 columns, the resolution of intensity map data generated in accordance with an embodiment may be 192× 56 pixels, but the present disclosure is not limited thereto.

For example, when a plurality of laser detecting units according to an embodiment is arranged in a matrix form having 56 rows and 192 columns, the resolution of point cloud data generated in accordance with an embodiment may be 192× 56 pixels, but the present disclosure is not limited thereto.

According to an embodiment, the reason that a LiDAR device is configured to generate a detection value for one pixel coordinate on the basis of a plurality of detection signals output respectively from a plurality of sub-detecting units included in a laser detecting unit as described in FIG. 29 is because a distance value or an intensity value included in a detection value corresponds to a detection result for an emitted laser, and this may be for reducing the number of detection cycles for obtaining detection values by using a plurality of detection results for one laser and may be for increasing the overall frame generation speed.

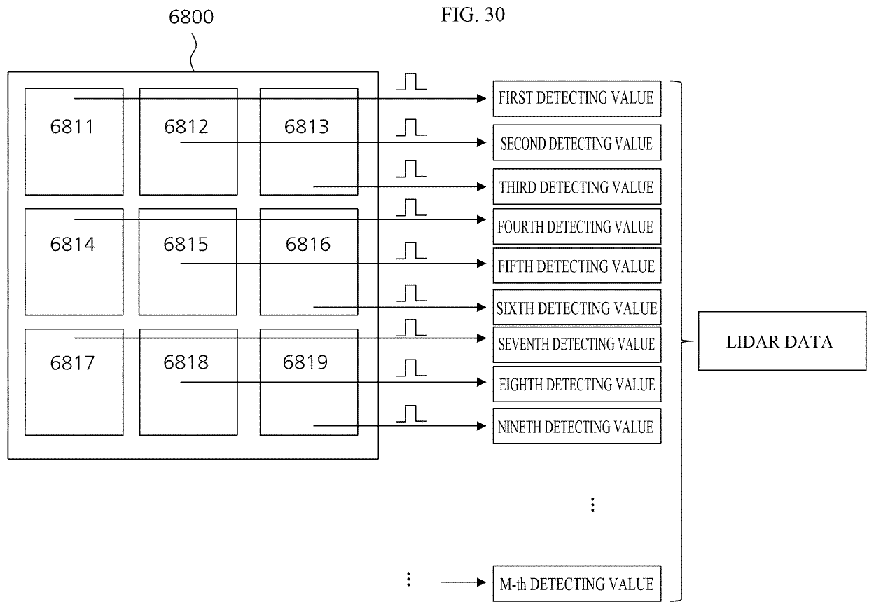

FIG. 30 is a diagram illustrating a laser detecting unit and detection values according to an embodiment.

Before describing FIG. 30, the laser detecting unit 6800 illustrated in FIG. 30 may be included in a laser detecting array included in a LiDAR device.

Referring to FIG. 30, the laser detecting unit 6800 according to an embodiment may include a plurality of sub-detecting units.

For example, the laser detecting unit 6800 according to an embodiment may include a first sub-detecting unit 6811, a second sub-detecting unit 6812, a third sub-detecting unit 6813, a fourth sub-detecting unit 6814, a fifth sub-detecting unit 6815, a sixth sub-detecting unit 6816, a seventh sub-detecting unit 6817, an eighth sub-detecting unit 6818, and a ninth sub-detecting unit 6819, but the present disclosure is not limited thereto.

In this configuration, the sub-detecting units according to an embodiment can be understood as laser detecting elements included in a laser detecting unit and can be understood as unit components that are included in a laser detecting unit and output detection signals, but are not limited thereto.

Each of the plurality of sub-detecting units according to an embodiment can detect light and output a detection signal.

For example, the first sub-detecting unit 6811 according to an embodiment can detect light and output a first detection signal, the second sub-detecting unit 6812 can detect light and output a second detection signal, the third sub-detecting unit 6813 can detect light and output a third detection signal, the fourth sub-detecting unit 6814 can detect light and output a fourth detection signal, the fifth sub-detecting unit 6815 can detect light and output a fifth detection signal, the sixth sub-detecting unit 6816 can detect light and output a sixth detection signal, the seventh sub-detecting unit 6817 can detect light and output a seventh detection signal, the eighth sub-detecting unit 6818 can detect light and output an eighth detection signal, and the ninth sub-detecting unit 6819 can detect light and output a ninth detection signal.

Further, according to an embodiment, a detection value may be generated on the basis of each of detection signals output from a plurality of sub-detecting units included in a laser detecting unit, respectively.

For example, according to an embodiment, a first detection value may be generated on the basis of a first detection signal output from the first detecting unit 6811 included in the laser detecting unit 6800, a second detection value may be generated on the basis of a second detection signal output from the second detecting unit 6812, a third detection value may be generated on the basis of a third detection signal output from the third detecting unit 6813, a fourth detection value may be generated on the basis of a fourth detection signal output from the fourth detecting unit 6814, a fifth detection value may be generated on the basis of a fifth detection signal output from the fifth detecting unit 6815, a sixth detection value may be generated on the basis of a sixth detection signal output from the sixth detecting unit 6816, a seventh detection value may be generated on the basis of a seventh detection signal output from the seventh detecting unit 6817, an eighth detection value may be generated on the basis of an eighth detection signal output from the eighth detecting unit 6818, and a ninth detection value may be generated on the basis of a ninth detection signal output from the ninth detecting unit 6819, but the present disclosure is not limited thereto.

In this case, the first to ninth detection values may be light capture values.

Further, in this case, regarding generating a light capture value on the basis of a detection signal, the above descriptions can be applied, so redundant descriptions are omitted.

Further, according to an embodiment, a plurality of detection values for a plurality of sub-pixel coordinates may be generated on the basis of detection signals output from a plurality of sub-detecting units included in a laser detecting unit, respectively.

For example, according to an embodiment, a first detection value for a first sub-pixel coordinate may be generated on the basis of a first detection signal output from the first detecting unit 6811 included in the laser detecting unit 6800, a second detection value for a second sub-pixel coordinate may be generated on the basis of a second detection signal output from the second detecting unit 6812, a third detection value for a third sub-pixel coordinate may be generated on the basis of a third detection signal output from the third detecting unit 6813, a fourth detection value for a fourth sub-pixel coordinate may be generated on the basis of a fourth detection signal output from the fourth detecting unit 6814, a fifth detection value for a fifth sub-pixel coordinate may be generated on the basis of a fifth detection signal output from the fifth detecting unit 6815, a sixth detection value for a sixth sub-pixel coordinate may be generated on the basis of a sixth detection signal output from the sixth detecting unit 6816, a seventh detection value for a seventh sub-pixel coordinate may be generated on the basis of a seventh detection signal output from the seventh detecting unit 6817, an eighth detection value for an eighth sub-pixel coordinate may be generated on the basis of an eighth detection signal output from the eighth detecting unit 6818, and a ninth detection value for a ninth sub-pixel coordinate may be generated on the basis of a ninth detection signal output from the ninth detecting unit 6819, but the present disclosure is not limited thereto.

Further, according to an embodiment, a plurality of detection values may be generated on the basis of detection signals respectively output from a plurality of sub-detecting units included in a plurality of laser detecting units, respectively.

For example, when a laser detecting array included in a LiDAR device according to an embodiment includes 10,752 laser detecting units and each of the laser detecting units includes 9 sub-detecting units, light capture values for respective 96,768 sub-pixel coordinates may be generated on the basis of detection signals output from the 96,768 sub-detecting units, respectively, but the present disclosure is not limited thereto.

Further, for example, when a plurality of laser detecting units according to an embodiment is arranged in a matrix form having 56 rows and 192 columns and a plurality of sub-detecting units included in each of the laser detecting units is arranged in a matrix form having 3 rows and 3 columns, light capture values for respective 96,768 sub-pixel coordinates may be generated on the basis of detection signals output from respective 96,768 sub-detecting units, but the present disclosure is not limited thereto.

Further, according to an embodiment, LiDAR data may be generated on the basis of a plurality of detection values.

For example, according to an embodiment, light capture map data may be generated on the basis of a plurality of detection values generated on the basis of detection signals output from a plurality of sub-detecting units, but the present disclosure is not limited thereto.

Further, according to an embodiment, generated LiDAR data may include sub-point data corresponding to the number of a plurality of sub-detecting units.

For example, when a laser detecting array included in a LiDAR device according to an embodiment includes 10,752 laser detecting units and each of the laser detecting units includes 9 sub-detecting units, light capture map data generated in accordance with an embodiment may include 96,768 sub-point data, and in this case, each of the sub-point data may include a sub-pixel coordinate and a corresponding light capture value, but the present disclosure is not limited thereto.

Further, according to an embodiment, generated LiDAR data may have a resolution corresponding to the arrangement of a plurality of laser detecting units and the arrangement of a plurality of sub-detecting units.

Further, for example, when a plurality of laser detecting units according to an embodiment is arranged in a matrix form having 56 rows and 192 columns and a plurality of sub-detecting units included in each of the laser detecting units is arranged in a matrix form having 3 rows and 3 columns, the resolution of light capture map data generated in accordance with an embodiment may be 576×168 pixels, but the present disclosure is not limited thereto.

The configuration in which a LiDAR device according to an embodiment generates a plurality of light capture values for a plurality of sub-pixel coordinates on the basis of a plurality of detection signals respectively output from a plurality of sub-detecting units included in a laser detecting unit, as described in FIG. 30, may be because it is not difficult to obtain each light capture value even without combining detection results of the plurality of sub-detecting units because a light capture value is related to the number of photons obtained within a detecting window, and may be for increasing the resolution of light capture map data.

As described with reference to FIG. 29 and FIG. 30, LiDAR data obtained from a LiDAR device according to an embodiment may have different resolutions.

For example, the resolution of light capture map data obtained from a LiDAR device according to an embodiment may be higher than the resolution of depth map data or intensity map data.

Hereinafter, a technique for generating “enhanced LiDAR data” (depth map data, intensity map data, and point cloud data) having a greater number of pixels than the number of laser detecting units, by obtaining a detection value for one pixel coordinate on the basis of detection signals obtained from a plurality of sub-detecting units as described with reference to FIG. 29, is described in more detail.

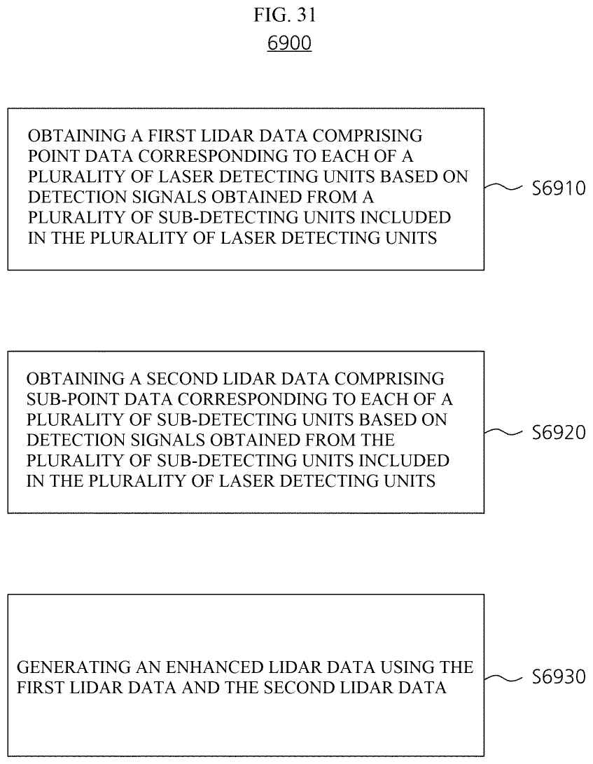

FIG. 31 is a diagram illustrating a method of generating enhanced LiDAR data according to an embodiment.

Before describing FIG. 31, an exemplary configuration of a LiDAR device for implementing the method of FIG. 31 is described.

However, this is merely an exemplary configuration for ease of understanding, and the configuration of the LiDAR device for implementing the method of FIG. 31 is not limited to the exemplary configuration.

A LIDAR device according to an embodiment may include a transmission module including a laser emitting array and a transmission optic, a reception module including a laser detecting array and a reception optic, and a controller configured to control operations of the laser emitting array and the laser detecting array and to process detection signals generated from the laser detecting array.

Further, the laser emitting array included in the LiDAR device according to an embodiment may include a plurality of laser emitting units, and each of the plurality of laser emitting units may include at least one laser emitting element.

Further, the laser detecting array included in the LiDAR device according to an embodiment may include a plurality of laser detecting units, and each of the plurality of laser detecting units may include a plurality of sub-detecting units.

Referring to FIG. 31, a method (6900) of generating enhanced LiDAR data according to an embodiment may include: a step of obtaining first LiDAR data including point data corresponding to a plurality of laser detecting units, respectively, on the basis of detection signals obtained from a plurality of sub-detecting units included in the plurality of laser detecting units (S6910); a step of obtaining second LiDAR data including sub-point data corresponding to the plurality of sub-detecting units, respectively, on the basis of detection signals obtained from the plurality of sub-detecting units included in the plurality of laser detecting units (S6920); and a step of generating enhanced LiDAR data using the first LiDAR data and the second LiDAR data.

Since the above descriptions can be applied to the step S6910 of obtaining first LiDAR data according to an embodiment, redundant descriptions are omitted.

In the step of obtaining first LiDAR data (S6910) according to an embodiment, each point data corresponding to each of the plurality of laser detecting units may include a pixel coordinate corresponding to each of the plurality of laser detecting units.

For example, in the step of obtaining first LiDAR data (S6910) according to an embodiment, first point data corresponding to a first laser detecting unit may include a first pixel coordinate corresponding to the first laser detecting unit, and second point data corresponding to a second laser detecting unit may include a second pixel coordinate corresponding to the second laser detecting unit, but the present disclosure is not limited thereto.

In this case, a pixel coordinate included in each of the point data may correspond to the position of a laser detecting unit.

For example, a first pixel coordinate included in first point data may correspond to the position of a first laser detecting unit on the laser detecting array, and a second pixel coordinate included in second point data may correspond to the position of a second laser detecting unit on the laser detecting array, but the present disclosure is not limited thereto.

Further, in the step of obtaining first LiDAR data (S6910) according to an embodiment, each point data corresponding to each of the plurality of laser detecting units may include a detection value corresponding to each of the plurality of laser detecting units.

For example, in the step of obtaining first LiDAR data (S6910) according to an embodiment, first point data corresponding to the first laser detecting unit may include a first distance value corresponding to the first laser detecting unit, and second point data corresponding to the second laser detecting unit may include a second distance value corresponding to the second laser detecting unit, but the present disclosure is not limited thereto.

Further, for example, in the step of obtaining first LiDAR data (S6910) according to an embodiment, first point data corresponding to the first laser detecting unit may include a first intensity value corresponding to the first laser detecting unit, and second point data corresponding to the second laser detecting unit may include a second intensity value corresponding to the second laser detecting unit, but the present disclosure is not limited thereto.

Further, in the step of obtaining first LiDAR data (S6910) according to an embodiment, each point data corresponding to each of the plurality of laser detecting units may include a three-dimensional position coordinate.

For example, in the step of obtaining first LiDAR data (S6910) according to an embodiment, first point data corresponding to the first laser detecting unit may include a first position coordinate obtained on the basis of a first distance value and a first pixel coordinate corresponding to the first laser detecting unit, and second point data corresponding to the second laser detecting unit may include a second position coordinate obtained on the basis of a second distance value and a second pixel coordinate corresponding to the second laser detecting unit, but the present disclosure is not limited thereto.

Further, in the step of obtaining first LiDAR data (S6910) according to an embodiment, a detection value included in each of the point data may be obtained on the basis of detection signals obtained from a plurality of sub-detecting units included in a corresponding laser detecting unit.

For example, in the step of obtaining first LiDAR data (S6910) according to an embodiment, a first detection value included in first point data may be obtained on the basis of detection signals obtained from a plurality of sub-detecting units included in the first laser detecting unit, and a second detection value included in second point data may be obtained on the basis of detection signals obtained from a plurality of sub-detecting units included in the second laser detecting unit, but the present disclosure is not limited thereto.

Further, in the step S6910 of obtaining first LiDAR data according to an embodiment, the first LiDAR data may include at least one piece of LiDAR data among depth map data, intensity map data, and point cloud data.

With respect to the step of obtaining second LiDAR data (S6920) according to an embodiment, the above descriptions can be applied, so redundant descriptions are omitted.

In the step of obtaining second LiDAR data (S6920) according to an embodiment, each of sub-point data corresponding to each of the plurality of sub-detecting units may include a sub-pixel coordinate corresponding to each of the plurality of sub-detecting units.

For example, in the step of obtaining second LiDAR data (S6920) according to an embodiment, first sub-point data corresponding to a first sub-detecting unit included in the first laser detecting unit may include a first sub-pixel coordinate corresponding to the first sub-detecting unit, second sub-point data corresponding to a second sub-detecting unit included in the first laser detecting unit may include a second sub-pixel coordinate corresponding to the second sub-detecting unit, and third sub-point data corresponding to a third sub-detecting unit included in the second laser detecting unit may include a third sub-pixel coordinate corresponding to the third sub-detecting unit, but the present disclosure is not limited thereto.

Further, in the step of obtaining second LiDAR data (S6920) according to an embodiment, each sub-point data corresponding to each of the plurality of sub-detecting units may include a detection value corresponding to each of the plurality of sub-detecting units.

For example, in the step of obtaining second LiDAR data (S6920) according to an embodiment, first sub-point data corresponding to the first sub-detecting unit included in the first laser detecting unit may include a first light capture value corresponding to the first sub-detecting unit, second sub-point data corresponding to the second sub-detecting unit included in the first laser detecting unit may include a second light capture value corresponding to the second sub-detecting unit, and third sub-point data corresponding to the third sub-detecting unit included in the second laser detecting unit may include a third light capture value corresponding to the third sub-detecting unit, but the present disclosure is not limited thereto.

Further, in the step of obtaining second LiDAR data (S6920) according to an embodiment, a detection value included in each of the sub-point data may be obtained on the basis of a detection signal obtained from a corresponding sub-detecting unit.

For example, in the step of obtaining second LiDAR data (S6920) according to an embodiment, the first light capture value included in the first sub-point data may be obtained on the basis of a detection signal obtained from the first sub-detecting unit included in the first laser detecting unit, the second light capture value included in the second sub-point data may be obtained on the basis of a detection signal obtained from the second sub-detecting unit included in the first laser detecting unit, and the third light capture value included in the third sub-point data may be obtained on the basis of a detection signal obtained from the third sub-detecting unit included in the second laser detecting unit, but the present disclosure is not limited thereto.

Further, in the step of obtaining second LiDAR data (S6920) according to an embodiment, the second LiDAR data may include light capture map data.

Further, according to an embodiment, the number of point data included in the first LiDAR data may be different from the number of sub-point data included in the second LiDAR data.

For example, according to an embodiment, the number of point data included in the first LiDAR data may be smaller than the number of sub-point data included in the second LiDAR data, but the present disclosure is not limited thereto.

Further, for example, according to an embodiment, the number of point data included in the first LiDAR data may be 10,920, and the number of sub-point data included in the second LiDAR data may be 98,768, but the present disclosure is not limited thereto.

Further, according to an embodiment, the number of sub-point data included in the second LiDAR data may be a multiple of the number of point data included in the first LiDAR data.

For example, according to an embodiment, the number of sub-point data included in the second LiDAR data may be three times the number of point data included in the first LiDAR data, but the present disclosure is not limited thereto.

Further, according to an embodiment, the resolution of the first LiDAR data and the resolution of the second LiDAR data may be different from each other.

For example, according to an embodiment, the resolution of the first LiDAR data may be 192×56 and the resolution of the second LiDAR data may be 576×56, but the present disclosure is not limited thereto.

Further, in the step of generating enhanced LiDAR data (S6930) according to an embodiment, the enhanced LiDAR data may include a plurality of enhanced point data.

Further, in the step of generating enhanced LiDAR data (S6930) according to an embodiment, at least some of a plurality of enhanced point data included in the enhanced LiDAR data may be generated on the basis of the point data included in the first LiDAR data and the sub-point data included in the second LiDAR data.

For example, in the step of generating enhanced LiDAR data (S6930) according to an embodiment, first enhanced point data may be generated on the basis of first point data included in the first LiDAR data, first sub-point data included in the second LiDAR data, and second sub-point data included in the second LiDAR data.

In this configuration, the first point data may be point data corresponding to the first laser detecting unit, the first sub-point data may be sub-point data corresponding to the first sub-detecting unit included in the first laser detecting unit, and the second sub-point data may be sub-point data corresponding to the second sub-detecting unit included in the second laser detecting unit.

Further, in the step S6930 of generating enhanced LiDAR data according to an embodiment, at least some of a plurality of enhanced point data included in the enhanced LiDAR data may be generated on the basis of detection values included in the first LiDAR data and light capture values included in the second LiDAR data.

For example, in the step of generating enhanced LiDAR data (S6930) according to an embodiment, a first enhanced distance value included in the first enhanced point data may be generated on the basis of a first distance value included in the first LiDAR data, a first light capture value included in the second LiDAR data, and a second light capture value included in the second LiDAR data.

In this case, the first distance value may be a distance value corresponding to the first laser detecting unit, the first light capture value may be a light capture value corresponding to the first sub-detecting unit included in the first laser detecting unit, and the second light capture value may be a light capture value corresponding to the second sub-detecting unit included in the second laser detecting unit.

Further, for example, in the step of generating enhanced LiDAR data (S6930) according to an embodiment, a first enhanced intensity value included in the first enhanced point data may be generated on the basis of a first intensity value included in the first LiDAR data, a first light capture value included in the second LiDAR data, and a second light capture value included in the second LiDAR data.

In this case, the first intensity value may be an intensity value corresponding to the first laser detecting unit, the first light capture value may be a light capture value corresponding to the first sub-detecting unit included in the first laser detecting unit, and the second light capture value may be a light capture value corresponding to the second sub-detecting unit included in the second laser detecting unit.

Further, in the step of generating enhanced LiDAR data (S6930) according to an embodiment, each of a plurality of enhanced point data included in the enhanced LiDAR data may include a pixel coordinate.

In this case, the pixel coordinate included in each of the enhanced point data may correspond to a sub-pixel coordinate included in the second LiDAR data.

For example, in the step of generating enhanced LiDAR data (S6930) according to an embodiment, a first pixel coordinate included in the first enhanced point data may correspond to a first sub-pixel coordinate included in first sub-point data included in the second LiDAR data, and a second pixel coordinate included in second enhanced point data may correspond to a second sub-pixel coordinate included in second sub-point data included in the second LiDAR data, but the present disclosure is not limited thereto.

Further, in this case, a pixel coordinate included in each of the enhanced point data may correspond to a sub-detecting unit.

For example, in the step of generating enhanced LiDAR data (S6930) according to an embodiment, the first pixel coordinate included in the first enhanced point data may correspond to the first sub-detecting unit included in the first laser detecting unit, the second pixel coordinate included in the second enhanced point data may correspond to the second sub-detecting unit included in the first laser detecting unit, and the third pixel coordinate included in the third enhanced point data may correspond to the third sub-detecting unit included in the second laser detecting unit, but the present disclosure is not limited thereto.

Further, in the step of generating enhanced LiDAR data (S6930) according to an embodiment, the enhanced LiDAR data may include at least one piece of data of enhanced depth map data, enhanced intensity map data, and enhanced point cloud data.

Further, according to an embodiment, the number of enhanced point data included in the enhanced LiDAR data may be different from the number of point data included in the first LiDAR data.

For example, according to an embodiment, the number of the enhanced point data included in the enhanced LiDAR data may be greater than the number of the point data included in the first LiDAR data, but the present disclosure is not limited thereto.

Further, for example, according to an embodiment, the number of the enhanced point data included in the enhanced LiDAR data may be 32,256 and the number of the point data included in the first LiDAR data may be 10,920, but the present disclosure is not limited thereto.

Further, according to an embodiment, the number of the enhanced point data included in the enhanced LiDAR data may be a multiple of the number of the point data included in the first LiDAR data.

For example, according to an embodiment, the number of the enhanced point data included in the enhanced LiDAR data may be three times the number of the point data included in the first LiDAR data, but the present disclosure is not limited thereto.

Further, according to an embodiment, the number of the enhanced point data included in the enhanced LiDAR data may be equal to the number of the sub-point data included in the second LiDAR data.

For example, according to an embodiment, the number of the enhanced point data included in the enhanced LiDAR data may be 32,256 and the number of the sub-point data included in the second LiDAR data may be 32,256, but the present disclosure is not limited thereto.

Further, according to an embodiment, the resolution of the enhanced LiDAR data and the resolution of the first LiDAR data may be different from each other.

For example, according to an embodiment, the resolution of the enhanced LiDAR data may be 576×56, and the resolution of the first LiDAR data may be 192×56, but the present disclosure is not limited thereto.

Further, according to an embodiment, the resolution of the enhanced LiDAR data and the resolution of the second LiDAR data may be the same as each other.

For example, according to an embodiment, the resolution of the enhanced LiDAR data may be 576×56 and the resolution of the second LiDAR data may be 576×56, but the present disclosure is not limited thereto.

Hereafter, the step of generating enhanced LiDAR data (S6930) according to an embodiment is described in more detail using more specific embodiments.

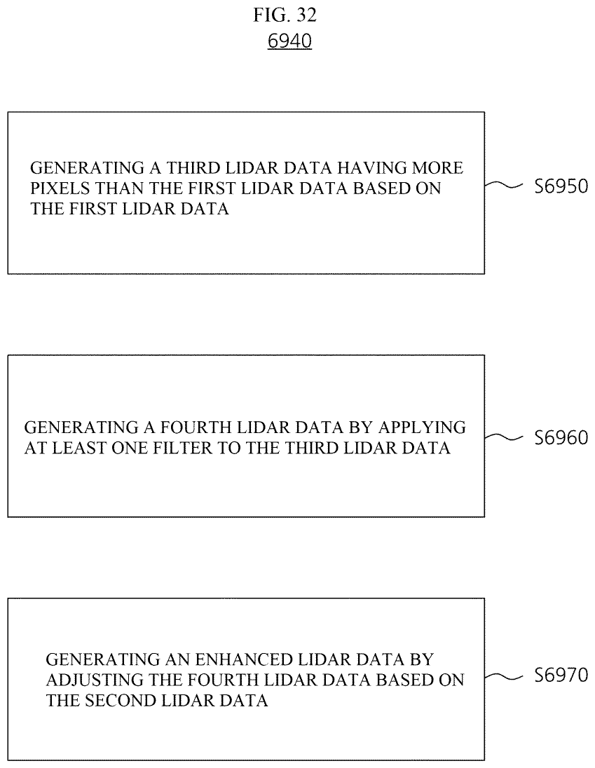

FIG. 32 to FIG. 35 are diagrams illustrating a method of generating enhanced LiDAR data according to an embodiment.

Before describing FIG. 32, it is noted that FIG. 32 is one embodiment among various embodiments of the method of generating enhanced LiDAR data described in FIG. 31.

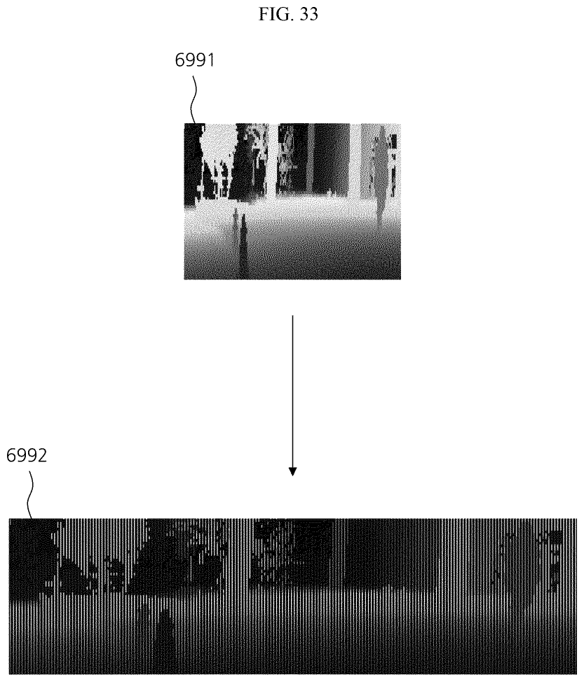

Further, FIG. 32 may be described with reference to FIG. 33 to FIG. 35.

Referring to FIG. 32, a method 6940 of generating enhanced LiDAR data according to an embodiment may include at least one of: a step of generating third LiDAR data having a greater number of pixels than the first LiDAR data on the basis of the first LiDAR data (S6950); a step of generating fourth LiDAR data by applying at least one filter to the third LiDAR data (S6960); and a step of generating enhanced LiDAR data by adjusting the fourth LiDAR data on the basis of the second LiDAR data (S6970).

The step of generating third LiDAR data (S6950) according to an embodiment can be understood with reference to FIG. 33.

Further, referring to FIG. 33, in the step of generating third LiDAR data (S6950) according to an embodiment, the third LiDAR data 6992 may be LiDAR data including a greater number of pixels than the first LiDAR data 6991.

For example, in the step of generating third LiDAR data (S6950) according to an embodiment, the number of pixels included in the third LiDAR data 6992 may be 32,256 and the number of pixels included in the first LiDAR data 6991 may be 10,752, but the present disclosure is not limited thereto.

Further, in the step of generating third LiDAR data (S6950) according to an embodiment, the third LiDAR data 6992 may be LiDAR data including a greater number of point data than the first LiDAR data 6991.

For example, in the step of generating third LiDAR data (S6950) according to an embodiment, the number of point data included in the third LiDAR data 6992 may be 32,256 and the number of point data included in the first LiDAR data 6991 may be 10,752, but the present disclosure is not limited thereto.

Further, in the step of generating third LiDAR data (S6950) according to an embodiment, the resolution of the third LiDAR data 6992 may be higher than the resolution of the first LiDAR data 6991.

For example, in the step of generating third LiDAR data (S6950) according to an embodiment, the resolution of the third LiDAR data 6992 may be 576×56 pixels and the resolution of the first LiDAR data 6991 may be 192× 56 pixels, but the present disclosure is not limited thereto.

Further, in the step of generating third LiDAR data (S6950) according to an embodiment, the number of pixels, the number of point data, or the resolution of the third LiDAR data 6992 may be the same as the number of sub-pixels, the number of sub-point data, or the resolution of the second LiDAR data described above.

Further, in the step of generating third LiDAR data (S6950) according to an embodiment, the third LiDAR data 6992 may be generated by inserting a pixel coordinate not having a detection value.

For example, according to an embodiment, the third LiDAR data 6992 may be generated by inserting a pixel coordinate not having a detection value between pixel coordinates included in the first LiDAR data 6991, but the present disclosure is not limited thereto.

Further, for example, according to an embodiment, the third LiDAR data 6992 may be generated by inserting a pixel coordinate not having a detection value around pixel coordinates included in the first LiDAR data 6991, but the present disclosure is not limited thereto.

Further, in the step of generating third LiDAR data (S6950) according to an embodiment, the third LiDAR data 6992 may be generated by assigning at least one detection value to a plurality of pixel coordinates included in the third LiDAR data 6992.

For example, according to an embodiment, a first detection value included in the first LiDAR data 6991 may be assigned to first point data included in the third LiDAR data 6992, and a second detection value of the first LiDAR data 6991 may be assigned to second point data, but the present disclosure is not limited thereto.

Further, the step of generating third LiDAR data (S6950) according to an embodiment may be performed on the basis of various methods of expanding the resolution of an obtained image in addition to the examples described above.

Further, in the step of generating third LiDAR data (S6950) according to an embodiment, the first LiDAR data 6991 and the third LiDAR data 6992 may be represented as at least one piece of data of depth map data, intensity map data, and point cloud data.

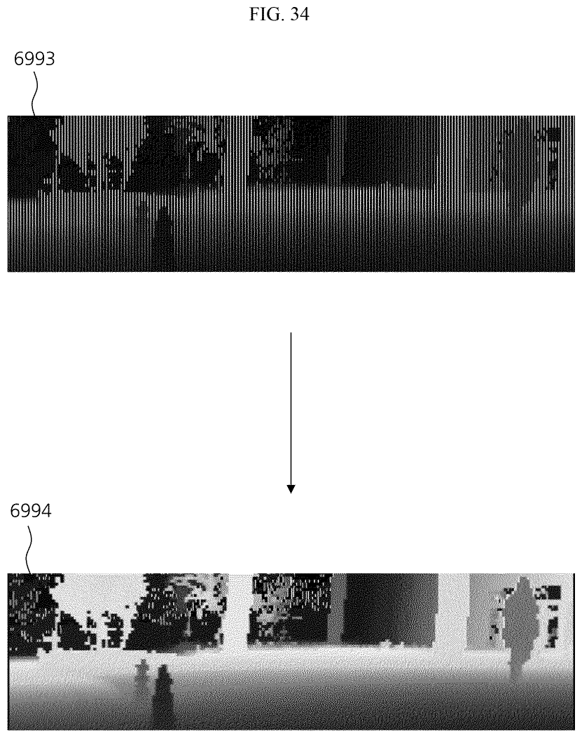

The step of generating fourth LiDAR data (S6960) according to an embodiment can be understood with reference to FIG. 34.

Further, referring to FIG. 34, in the step of generating fourth LiDAR data (S6960) according to an embodiment, the fourth LiDAR data 6994 may be obtained on the basis of pixel values (detection values) included in the third LiDAR data 6993.

For example, in the step of generating fourth LiDAR data (S6960) according to an embodiment, the fourth LiDAR data 6994 may be obtained by applying at least one filter to the pixel values (detection values) included in the third LiDAR data 6993, but is not limited thereto. Further, for example, in the step of generating fourth LiDAR data (S6960) according to an embodiment, the fourth LiDAR data 6994 may be obtained by interpolating the pixel values (detection values) included in the third LiDAR data 6993, but the present disclosure is not limited thereto.

Further, in the step of generating fourth LiDAR data (S6960) according to an embodiment, pixel values (detection values) of pixel coordinates included in the fourth LiDAR data 6994 may be generated on the basis of the pixel values (detection values) of pixel coordinates included in the third LiDAR data 6993 and the pixel values (detection values) of surrounding pixel coordinates.

For example, a pixel value (detection value) of a first pixel coordinate included in the fourth LiDAR data 6994 may be generated on the basis of a pixel value (detection value) of a first pixel coordinate included in the third LiDAR data 6993 and pixel values (detection values) of surrounding pixel coordinates.

Further, in the step of generating fourth LiDAR data (S6960) according to an embodiment, at least one filter may be understood as at least one kernel, etc. and may be understood as various tools capable of compensating pixel values by considering the relationship among the pixel values of surrounding pixels.

For example, in the step of generating fourth LiDAR data (S6960) according to an embodiment, at least one filter may refer to an average filter that considers the distances between surrounding pixels, but the present disclosure is not limited thereto.

For example, in the step of generating fourth LiDAR data (S6960) according to an embodiment, at least one filter may refer to a Gaussian filter that considers the distances between surrounding pixels, but the present disclosure is not limited thereto.

Further, in the step of generating fourth LiDAR data (S6960) according to an embodiment, the third LiDAR data 6993 and the fourth LiDAR data 6994 may be represented as at least one piece of data of depth map data, intensity map data, and point cloud data.

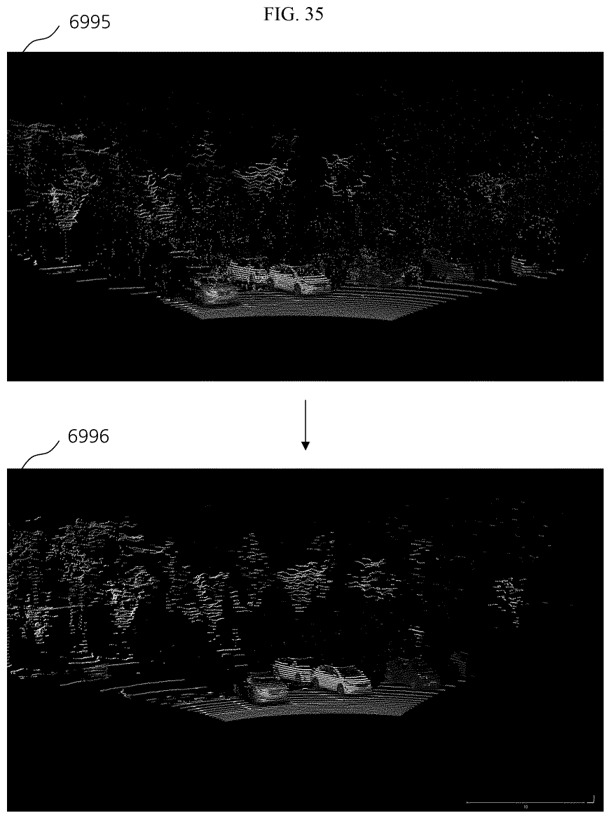

The step of generating enhanced LiDAR data (S6970) according to an embodiment can be understood with reference to FIG. 35.

Further, in the step of generating enhanced LiDAR data (S6970) according to an embodiment, the second LiDAR data may be understood as the light capture map data described above and the above description can be applied thereto, so redundant descriptions are omitted.

Further, referring to FIG. 35, in the step of generating enhanced LiDAR data (S6970) according to an embodiment, enhanced LiDAR data 6996 may be obtained on the basis of pixel values (detection values) included in the fourth LiDAR data 6995.

For example, in the step of generating enhanced LiDAR data (S6970) according to an embodiment, the enhanced LiDAR data 6996 may be obtained by applying a filter having a weight designed on the basis of the second LiDAR data to the pixel values (detection values) included in the fourth LiDAR data 6995, but the present disclosure is not limited thereto.

Further, in the step of generating enhanced LiDAR data (S6970) according to an embodiment, enhanced detection values included in the enhanced LiDAR data 6996 may be generated on the basis of the pixel values (detection values) included in the fourth LiDAR data 6995 and the light capture values included in the second LiDAR data.

For example, in the step of generating enhanced LiDAR data (S6970) according to an embodiment, an enhanced detection value for a first pixel coordinate positioned at (1, 1) in the enhanced LiDAR data 6996 may be generated on the basis of the pixel value (detection value) for a pixel coordinate positioned at (1, 1) in the fourth LiDAR data 6995, the light capture value for a pixel coordinate positioned at (1, 1) in the second LiDAR data, and the light capture values for pixel coordinates positioned around (1, 1) in the second LiDAR data, but the present disclosure is not limited thereto.

Further, the step of generating enhanced LiDAR data (S6970) according to an embodiment may be understood as a step of adjusting the pixel values (detection values) of the fourth LiDAR data in consideration of a distribution of the light capture values included in the second LiDAR data, and various methods other than the examples described above may also be applied.

Further, referring to FIG. 35, by considering the second LiDAR data, it can be seen that the enhanced LiDAR data 6996 may be data with reduced noise and better reflecting the shape of objects compared to the fourth LiDAR data 6995.

Further, in the step of generating enhanced LiDAR data (S6970) according to an embodiment, the enhanced LiDAR data 6996 and the fourth LiDAR data 6995 may be represented as at least one piece of data of depth map data, intensity map data, and point cloud data.

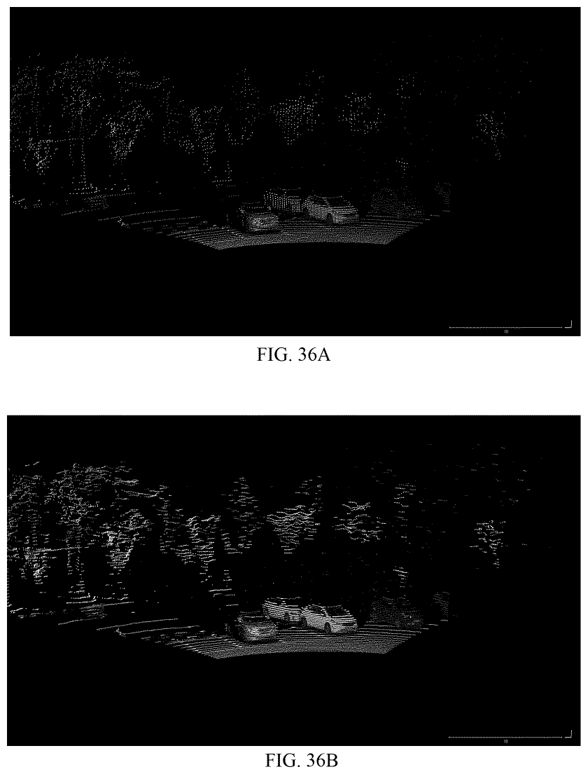

FIGS. 36A and 36B are an exemplary diagram of LiDAR data and enhanced LiDAR data according to an embodiment.

In more detail, FIG. 36A is a diagram illustrating point cloud data according to an embodiment and FIG. 36B is a diagram illustrating enhanced point cloud data according to an embodiment.

Referring to FIGS. 36A and 36B, an enhanced point cloud generated by the method of generating enhanced LiDAR data disclosed in the present disclosure can have a higher resolution than the LiDAR data according to an embodiment.

Therefore, empty spaces existing between point data included in the point cloud illustrated in FIG. 36A can be filled in the enhanced point cloud illustrated in FIG. 36B, and accordingly, it can be seen that LiDAR data having clearer and better-reflected object shapes can be generated.

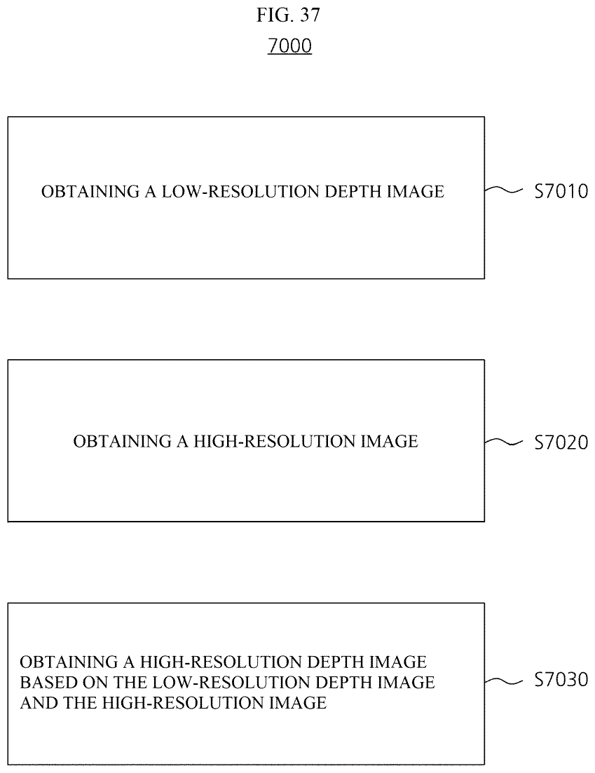

FIG. 37 is a diagram illustrating a method of generating LiDAR data according to an embodiment.

Before describing FIG. 37, an exemplary configuration of a LiDAR device for implementing the method of FIG. 37 is described.

However, this is merely an exemplary configuration for ease of understanding, and the configuration of the LiDAR device for implementing the method of FIG. 37 is not limited to the exemplary configuration.

A LiDAR device according to an embodiment may include a transmission module including a laser emitting array and a transmission optic, a reception module including a laser detecting array and a reception optic, and a controller configured to control operations of the laser emitting array and the laser detecting array and to process detection signals generated from the laser detecting array.

Further, the laser emitting array included in the LiDAR device according to an embodiment may include a plurality of laser emitting units, and each of the plurality of laser emitting units may include at least one laser emitting element.

Further, the laser detecting array included in the LiDAR device according to an embodiment may include a plurality of laser detecting units, and each of the plurality of laser detecting units may include a plurality of sub-detecting units.

Referring to FIG. 37, a method 7000 of generating LiDAR data according to an embodiment may include a step of obtaining a low-resolution depth image (S7010), a step of obtaining a high-resolution image (S7020), and a step of obtaining a high-resolution depth image on the basis of the low-resolution depth image and the high-resolution image (S7030).

In the step of obtaining a low-resolution depth image (S7010) according to an embodiment, since the above descriptions related to LiDAR data such as a depth map can be applied the low-resolution depth image, redundant descriptions are omitted.

Further, in the step of obtaining a low-resolution depth image (S7010) according to an embodiment, the low-resolution depth image may include a first number of pixels.

For example, in the step of obtaining a low-resolution depth image (S7010) according to an embodiment, the low-resolution depth image may include 10,752 pixels, but is not limited thereto.

Further, in the step of obtaining a low-resolution depth image (S7010) according to an embodiment, each pixel of the low-resolution depth image may include a position coordinate value and a depth value.

That is, in the step of obtaining a low-resolution depth image (S7010) according to an embodiment, the low-resolution depth image may refer to LiDAR data composed of a pixel coordinate value and a pixel value corresponding to each pixel, but is not limited thereto.

In this case, according to an embodiment, the depth value of each pixel of the low-resolution depth image may be obtained on the basis of a detection signal generated from at least one sub-detecting unit included in each laser detecting unit.

For example, a first depth value for a first pixel included in the low-resolution depth image may be obtained on the basis of signals generated from first to third sub-detecting units included in a first laser detecting unit, but the present disclosure is not limited thereto.

In more detail, the first depth value for the first pixel included in the low-resolution depth image may be obtained on the basis of first histogram data generated by accumulating the number of signals generated per first unit time on the basis of signals generated from the first to third sub-detecting units included in the first laser detecting unit during a plurality of cycles, but the present disclosure is not limited thereto.

Further, since the above descriptions related to determining a detection time point of a laser on the basis of the first histogram data can be applied to the determination of the first depth value based on the first histogram data, redundant descriptions are omitted.

Further, in the step of obtaining a high-resolution image (S7020) according to an embodiment, the above descriptions regarding LiDAR data such as the light capture map described above can be applied to the high-resolution image, so redundant descriptions are omitted.

Further, in the step of obtaining a high-resolution image (S7020) according to an embodiment, the high-resolution image may include a second number of pixels. For example, in the step of obtaining a high-resolution image (S7020) according to an embodiment, the high-resolution image may include 32,256 pixels, but the present disclosure is not limited thereto.

In this case, the second number may be greater than the first number described above.

Further, in the step of obtaining a high-resolution image (S7020) according to an embodiment, each pixel of the high-resolution image may include a position coordinate value and a light capture value.

That is, in the step of obtaining a high-resolution image (S7020) according to an embodiment, the high-resolution image may refer to LiDAR data composed of pixel coordinates and pixel values corresponding to respective pixels, but the present disclosure is not limited thereto.

In this case, according to an embodiment, the pixel value of each pixel of the high-resolution image may be obtained on the basis of a detection signal generated from each of sub-detecting units.

For example, the first pixel value for a first pixel included in the high-resolution image may be obtained on the basis of a signal generated from a first sub-detecting unit, the second pixel value for a second pixel may be obtained on the basis of a signal generated from a second sub-detecting unit, and the third pixel value for a third pixel may be obtained on the basis of a signal generated from a third sub-detecting unit, but the present disclosure is not limited thereto.

More specifically, the first pixel value for the first pixel included in the high-resolution image may be obtained on the basis of a first counting value obtained by accumulating the number of signals generated during a second unit time on the basis of a signal generated from a first sub-detecting unit included in a first detecting unit, the second pixel value for the second pixel may be obtained on the basis of a second counting value obtained by accumulating the number of signals generated during the second unit time on the basis of a signal generated from a second sub-detecting unit included in the first detecting unit, and the third pixel value for the third pixel may be obtained on the basis of a third counting value obtained by accumulating the number of signals generated during the second unit time on the basis of a signal generated from a third sub-detecting unit included in the first detecting unit, but the present disclosure is not limited thereto.

Further, in this case, the second unit time may be longer than the first unit time described above.

Further, in this case, the operation interval of the LiDAR device for generating the high-resolution image may be different from the operation interval of the LiDAR device for generating the low-resolution depth image.

Further, since, in the step of obtaining a high-resolution depth image on the basis of the low-resolution depth image and the high-resolution image (S7030) according to an embodiment, the descriptions relating to the step of generating enhanced LiDAR data described above can be applied and the above descriptions regarding the enhanced LiDAR data described above can be applied to the high-resolution depth image, redundant descriptions are omitted.

Further, in the step of obtaining a high-resolution depth image on the basis of the low-resolution depth image and the high-resolution image (S7030) according to an embodiment, the high-resolution depth image may include a third number of pixels.

For example, in the step of obtaining a high-resolution depth image on the basis of the low-resolution depth image and the high-resolution image (S7030) according to an embodiment, the high-resolution depth image may include 32,256 pixels, but the present disclosure is not limited thereto.

In this case, the third number may be greater than the first number described above.

Further, in this case, the third number may be equal to the second number described above, but the present disclosure is not limited thereto.

Further, in the step of obtaining a high-resolution depth image on the basis of the low-resolution depth image and the high-resolution image (S7030) according to an embodiment, each pixel of the high-resolution depth image may include a position coordinate value and a depth value.

That is, in the step of obtaining a high-resolution depth image on the basis of the low-resolution depth image and the high-resolution image (S7030) according to an embodiment, the high-resolution depth image may refer to LiDAR data composed of pixel coordinates and pixel values corresponding to respective pixels, the present disclosure is not limited thereto.

In this case, according to an embodiment, the depth value of each pixel of the high-resolution depth image may be obtained on the basis of the depth value of the low-resolution depth image and the pixel value of the high-resolution image.

For example, a first depth value for a first pixel included in the high-resolution depth image may be obtained on the basis of a second depth value for a second pixel included in the low-resolution depth image, a third pixel value for a third pixel included in the high-resolution image, and a fourth pixel value for a fourth pixel included in the high-resolution image, but the present disclosure is not limited thereto.

In this case, the second pixel included in the low-resolution depth image may be a pixel corresponding to a first laser detecting unit, the first pixel included in the high-resolution depth image may be a pixel corresponding to a first sub-detecting unit included in the first laser detecting unit, the third pixel included in the high-resolution image may be a pixel corresponding to the first sub-detecting unit, and the fourth pixel included in the high-resolution image may be a pixel corresponding to a second sub-detecting unit, which is included in a second laser detecting unit adjacent to the first laser detecting and is adjacent to the first sub-detecting unit, but the present disclosure is not limited thereto.

Further, for example, the depth value of a first pixel having a pixel coordinate of (1, 1) in the high-resolution depth image may be generated on the basis of the depth value of a second pixel having a pixel coordinate of (1, 1) in the low-resolution depth image, the pixel value of a third pixel having a pixel coordinate of (1, 1) in the high-resolution image, and the pixel value of a fourth pixel having a pixel coordinate around (1, 1) in the high-resolution image, but the present disclosure is not limited thereto.

Further, in the step of obtaining a high-resolution depth image on the basis of the low-resolution depth image and the high-resolution image (S7030) according to an embodiment, the pixel coordinates included in the high-resolution depth image may be the same as the pixel coordinates included in the high-resolution image, but the present disclosure is not limited thereto.

Further, in the step of obtaining a high-resolution depth image on the basis of the low-resolution depth image and the high-resolution image (S7030) according to an embodiment, the pixel coordinates included in the high-resolution depth image may correspond to sub-detecting units, respectively, but the present disclosure is not limited thereto.

Further, according to an embodiment, the number of the pixels included in the high-resolution depth image may be a multiple of the number of the pixels included in the low-resolution depth image.

For example, according to an embodiment, the number of the pixels included in the high-resolution depth image may be three times the number of the pixels included in the low-resolution depth image, but the present disclosure is not limited thereto.

Further, according to an embodiment, the resolution of the high-resolution depth image and the resolution of the low-resolution depth image may be different from each other.

For example, according to an embodiment, the resolution of the high-resolution depth image may be 576×56 and the resolution of the low-resolution depth image may be 192×56, but the present disclosure is not limited thereto.

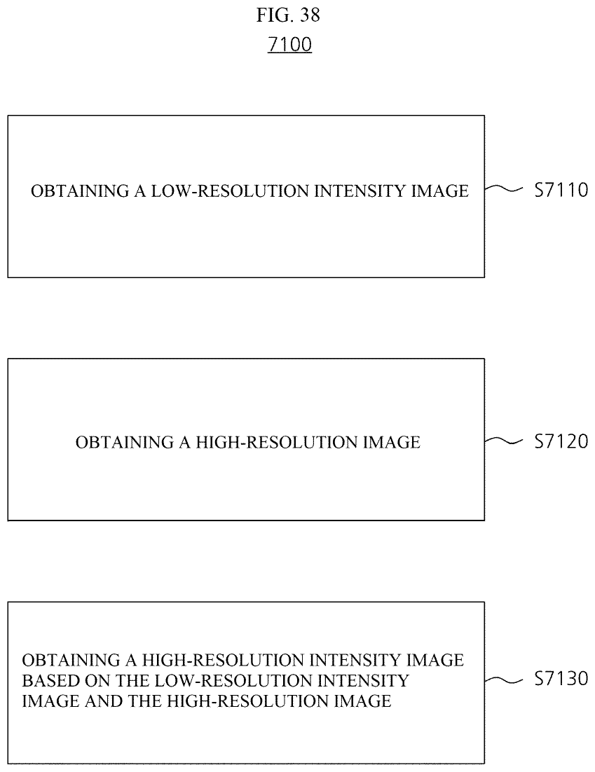

FIG. 38 is a diagram illustrating a method of generating LiDAR data according to an embodiment.

Before describing FIG. 38, an exemplary configuration of a LiDAR device for implementing the method of FIG. 38 is described.

However, this is merely an exemplary configuration for ease of understanding, and the configuration of the LiDAR device for implementing the method of FIG. 38 is not limited to the exemplary configuration.

A LiDAR device according to an embodiment may include a transmission module including a laser emitting array and a transmission optic, a reception module including a laser detecting array and a reception optic, and a controller configured to control operations of the laser emitting array and the laser detecting array and to process detection signals generated from the laser detecting array.

Further, the laser emitting array included in the LiDAR device according to an embodiment may include a plurality of laser emitting units, and each of the plurality of laser emitting units may include at least one laser emitting element.

Further, the laser detecting array included in the LiDAR device according to an embodiment may include a plurality of laser detecting units, and each of the plurality of laser detecting units may include a plurality of sub-detecting units.

Referring to FIG. 38, a method 7100 of generating LiDAR data according to an embodiment may include a step of obtaining a low-resolution intensity image (S7110), a step of obtaining a high-resolution image (S7120), and a step of obtaining a high-resolution intensity image on the basis of the low-resolution intensity image and the high-resolution image (S7130).

In the step of obtaining a low-resolution intensity image (S7110) according to an embodiment, since the above descriptions related to LiDAR data such as an intensity map can be applied to the low-resolution intensity image, redundant descriptions are omitted.

Further, in the step of obtaining a low-resolution intensity image (S7110) according to an embodiment, the low-resolution intensity image may include a first number of pixels.

For example, in the step of obtaining a low-resolution intensity image (S7110) according to an embodiment, the low-resolution intensity image may include 10,752 pixels, but is not limited thereto.

Further, in the step of obtaining a low-resolution intensity image (S7110) according to an embodiment, each pixel of the low-resolution intensity image may include a position coordinate value and an intensity value.

That is, in the step of obtaining a low-resolution intensity image (S7110) according to an embodiment, the low-resolution intensity image may refer to LiDAR data composed of pixel coordinate values and pixel values corresponding to respectively pixels, but is not limited thereto.

In this case, according to an embodiment, the intensity value of each pixel of the low-resolution intensity image may be obtained on the basis of a detection signal generated from at least one sub-detecting unit included in each of laser detecting units.

For example, a first intensity value for a first pixel included in the low-resolution intensity image may be obtained on the basis of signals generated from first to third sub-detecting units included in a first laser detecting unit, but the present disclosure is not limited thereto.

In more detail, the first intensity value for the first pixel included in the low-resolution intensity image may be obtained on the basis of first histogram data generated by accumulating the number of signals generated per first unit time on the basis of signals generated from the first to third sub-detecting units included in the first laser detecting unit during a plurality of cycles, but the present disclosure is not limited thereto.

Further, since the above descriptions related to determining an intensity value on the basis of the first histogram data can be applied to the determination of the first intensity value based on the first histogram data, redundant descriptions are omitted.

Further, in the step of obtaining a high-resolution image (S7120) according to an embodiment, the above descriptions regarding LiDAR data such as the light capture map described above can be applied to the high-resolution image, so redundant descriptions are omitted.

Further, in the step of obtaining a high-resolution image (S7120) according to an embodiment, the high-resolution image may include a second number of pixels. For example, in the step of obtaining a high-resolution image (S7120) according to an embodiment, the high-resolution image may include 32,256 pixels, but the present disclosure is not limited thereto.

In this case, the second number may be greater than the first number described above.

Further, in the step of obtaining a high-resolution image (S7120) according to an embodiment, each pixel of the high-resolution image may include a position coordinate value and a light capture value.

That is, in the step of obtaining a high-resolution image (S7120) according to an embodiment, the high-resolution image may refer to LiDAR data composed of pixel coordinates and pixel values corresponding to respective pixels, but the present disclosure is not limited thereto.

In this case, according to an embodiment, the pixel value of each pixel of the high-resolution image may be obtained on the basis of a detection signal generated from each of sub-detecting units.

For example, the first pixel value for a first pixel included in the high-resolution image may be obtained on the basis of a signal generated from a first sub-detecting unit, the second pixel value for a second pixel may be obtained on the basis of a signal generated from a second sub-detecting unit, and the third pixel value for a third pixel may be obtained on the basis of a signal generated from a third sub-detecting unit, but the present disclosure is not limited thereto.

More specifically, the first pixel value for the first pixel included in the high-resolution image may be obtained on the basis of a first counting value obtained by accumulating the number of signals generated during a second unit time on the basis of a signal generated from a first sub-detecting unit included in a first detecting unit, the second pixel value for the second pixel may be obtained on the basis of a second counting value obtained by accumulating the number of signals generated during the second unit time on the basis of a signal generated from a second sub-detecting unit included in the first detecting unit, and the third pixel value for the third pixel may be obtained on the basis of a third counting value obtained by accumulating the number of signals generated during the second unit time on the basis of a signal generated from a third sub-detecting unit included in the first detecting unit, but the present disclosure is not limited thereto.

Further, in this case, the second unit time may be longer than the first unit time described above.

Further, in this case, the operation interval of the LiDAR device for generating the high-resolution image may be different from the operation interval of the LiDAR device for generating the low-resolution intensity image.

Further, since, in the step of obtaining a high-resolution intensity image on the basis of the low-resolution intensity image and the high-resolution image (S7130) according to an embodiment, the descriptions relating to the step of generating enhanced LiDAR data described above can be applied and the descriptions regarding the enhanced LiDAR data described above can be applied to the high-resolution intensity image, redundant descriptions are omitted.

Further, in the step of obtaining a high-resolution intensity image on the basis of the low-resolution intensity image and the high-resolution image (S7130) according to an embodiment, the high-resolution intensity image may include a third number of pixels.

For example, in the step of obtaining a high-resolution intensity image on the basis of the low-resolution intensity image and the high-resolution image (S7130) according to an embodiment, the high-resolution intensity image may include 32,256 pixels, but the present disclosure is not limited thereto.

In this case, the third number may be greater than the first number described above.

Further, in this case, the third number may be equal to the second number described above, but the present disclosure is not limited thereto.

Further, in the step of obtaining a high-resolution intensity image on the basis of the low-resolution intensity image and the high-resolution image (S7130) according to an embodiment, each pixel of the high-resolution intensity image may include a position coordinate value and an intensity value.

That is, in the step of obtaining a high-resolution intensity image on the basis of the low-resolution intensity image and the high-resolution image (S7130) according to an embodiment, the high-resolution intensity image may refer to LiDAR data composed of pixel coordinates and pixel values corresponding to respective pixels, the present disclosure is not limited thereto.

In this case, according to an embodiment, the pixel value of each pixel of the high-resolution intensity image may be obtained on the basis of the intensity value of the low-resolution intensity image and the pixel value of the high-resolution image.

For example, a first intensity value for a first pixel included in the high-resolution intensity image may be obtained on the basis of a second intensity value for a second pixel included in the low-resolution intensity image, a third pixel value for a third pixel included in the high-resolution image, and a fourth pixel value for a fourth pixel included in the high-resolution image, but the present disclosure is not limited thereto.

In this case, the second pixel included in the low-resolution intensity image may be a pixel corresponding to a first laser detecting unit, the first pixel included in the high-resolution intensity image may be a pixel corresponding to a first sub-detecting unit included in the first laser detecting unit, the third pixel included in the high-resolution image may be a pixel corresponding to the first sub-detecting unit, and the fourth pixel included in the high-resolution image may be a pixel corresponding to a second sub-detecting unit, which is included in a second laser detecting unit adjacent to the first laser detecting and is adjacent to the first sub-detecting unit, but the present disclosure is not limited thereto.

Further, for example, the intensity value of a first pixel having a pixel coordinate of (1, 1) in the high-resolution intensity image may be generated on the basis of the intensity value of a second pixel having a pixel coordinate of (1, 1) in the low-resolution intensity image, the pixel value of a third pixel having a pixel coordinate of (1, 1) in the high-resolution image, and the pixel value of a fourth pixel having a pixel coordinate around (1, 1) in the high-resolution image, but the present disclosure is not limited thereto.

Further, in the step of obtaining a high-resolution intensity image on the basis of the low-resolution intensity image and the high-resolution image (S7130) according to an embodiment, the pixel coordinates included in the high-resolution intensity image may be the same as the pixel coordinates included in the high-resolution image, but the present disclosure is not limited thereto.

Further, in the step of obtaining a high-resolution intensity image on the basis of the low-resolution intensity image and the high-resolution image (S7130) according to an embodiment, the pixel coordinates included in the high-resolution intensity image may correspond to sub-detecting units, respectively, but the present disclosure is not limited thereto.

Further, according to an embodiment, the number of the pixels included in the high-resolution intensity image may be a multiple of the number of the pixels included in the low-resolution intensity image.

For example, according to an embodiment, the number of the pixels included in the high-resolution intensity image may be three times the number of the pixels included in the low-resolution intensity image, but the present disclosure is not limited thereto.

Further, according to an embodiment, the resolution of the high-resolution intensity image and the resolution of the low-resolution intensity image may be different from each other.

For example, according to an embodiment, the resolution of the high-resolution intensity image may be 576×56 and the resolution of the low-resolution intensity image may be 192×56, but the present disclosure is not limited thereto.

Enhanced LiDAR data described in the specification may have a higher resolution than the initially generated LiDAR data. Accordingly, the method for generating enhanced LiDAR data described in the specification may be referred to as a LiDAR data upsampling method, a LiDAR data upscaling method, or a LiDAR data super-resolution method, in that it upsamples the resolution of LiDAR data.

The method according to an embodiment may be implemented in a program that can be executed by various computers and may be recorded on computer-readable media. The computer-readable media may include program commands, data files, and data structures individually or in combinations thereof. The program commands that are recorded on the media may be those specifically designed and configured for the present invention or may be those available and known to those engaged in computer software in the art. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter etc. The hardware device may be configured to operate as one or more software modules to perform the operation of the present invention, and vice versa.

Embodiments were described above with reference to the limited examples and drawings, but they may be changed and modified in various ways by those skilled in the art. For example, the described technologies may be performed in order different from the described method, and/or even if components such as the described system, structure, device, and circuit are combined or associated in different ways from the description or replaced by other components or equivalents, appropriate results can be accomplished.

Therefore, other implements, other embodiments, and equivalents to the claims are included in the following claims.

What is claimed is:

1. A LiDAR (Light Detection And Ranging) device, comprising:
a transmission module comprising a laser emitting array and a transmission optic, wherein the laser emitting array comprises a first laser emitting unit and a second laser emitting unit, wherein the second laser emitting unit is positioned adjacent to the first laser emitting unit; and
a reception module comprising a laser detecting array and a reception optic, wherein the laser detecting array comprises a first laser detecting unit and a second laser detecting unit;
wherein the transmission module and the reception module are configured to be aligned such that the first laser emitting unit is optically coupled to the first laser detecting unit,
wherein a distance between the first laser detecting unit and the second laser detecting unit is determined such that the second laser detecting unit is optically coupled to the second laser emitting unit,
wherein the laser detecting array further comprises a first ambient detecting unit disposed between the first laser detecting unit and the second laser detecting unit.

2. The LiDAR device of claim 1, wherein a distance between a center of the first laser emitting unit and a center of the second laser emitting unit is equal to a distance between a center of the first laser detecting unit and a center of the second laser detecting unit.

3. The LiDAR device of claim 2, wherein an optical characteristic of the transmission optic and an optical characteristic of the reception optic are identical to each other.

4. The LiDAR device of claim 1, wherein a distance between a center of the first laser detecting unit and a center of the first ambient detecting unit is less than a distance between a center of the first laser emitting unit and a center of the second laser emitting unit.

5. The LiDAR device of claim 1, wherein the LiDAR device further comprises a processor configured to determine a depth value for at least one pixel coordinate,
wherein the processor is configured to:
determine a first depth value for a first pixel coordinate at least based on a detection signal generated from the first laser detecting unit, when a first laser emitted from the first laser emitting unit is reflected by an object and detected by the first laser detecting unit, and
determine a second depth value for a second pixel coordinate at least based on a detection signal generated from the second laser detecting unit, when a second laser emitted from the second laser emitting unit is reflected by an object and detected by the second laser detecting unit.

6. The LiDAR device of claim 5, wherein the processor is configured to determine the first depth value for the first pixel coordinate at least based on detection signals generated from the first laser detecting unit and the first ambient detecting unit, when the first laser emitted from the first laser emitting unit is reflected by an object and detected by the first laser detecting unit.

7. The LiDAR device of claim 1, wherein the LiDAR device further comprises a processor configured to determine a light capture value of at least one pixel coordinate,
wherein the processor is configured to determine a first light capture value for a first pixel coordinate based on a detection signal generated from the first ambient detecting unit during a first unit time.

8. The LiDAR device of claim 7, wherein the processor is configured to:
determine a second light capture value for a second pixel coordinate based on a detection signal generated from the first laser detecting unit during the first unit time, and
determine a third light capture value for a third pixel coordinate based on a detection signal generated from the second laser detecting unit during the first unit time.

9. The LiDAR device of claim 1, wherein the first and second laser detecting units and the first ambient detecting unit are implemented using the same detecting element.

10. The LiDAR device of claim 9, wherein the first and second laser detecting units and the first ambient detecting unit are implemented as SPADs (Single Photon Avalanche Diodes).

11. The LiDAR device of claim 9, wherein a number of detecting elements included in the laser detecting array is greater than a number of laser emitting elements included in the laser emitting array.

12. The LiDAR device of claim 1, wherein the LiDAR device further comprises a processor configured to generate at least one LiDAR data,
wherein the processor is configured to generate a depth map data comprising a depth value for each of a plurality of pixels, and a light capture map data comprising a light capture value for each of a plurality of pixels.

13. The LiDAR device of claim 12, a number of pixels included in the light capture map data is greater than a number of pixels included in the depth map data.
